(19) United States
(12) Patent Application Publication
(10) Pub. No.: US 2017/0355823 A1
(43) Pub. Date: Dec. 14, 2017

(54) METHODS OF PRODUCING ORGANOSILICA MATERIALS AND USES THEREOF

(71) Applicant: ExxonMobil Research and Engineering Company, Annandale, NJ (US)

(72) Inventors: Brian K. Peterson, Fogelsville, PA (US); David C. Calabro, Bridgewater, NJ (US); Quanchang Li, Dayton, NJ (US); Simon C. Weston, Annandale, NJ (US); Mobae Afeworki, Phillipsburg, NJ (US)

(21) Appl. No.: 15/179,309

(22) Filed: Jun. 10, 2016

(51) Int. Cl. C08G 77/06; B01J 31/06; B01J 20/26; B01J 13/00

(52) U.S. Cl. CPC C08G 77/06; B01J 13/0065; B01J 31/06; B01J 20/262

(57) ABSTRACT

Methods of identifying precursors for producing high porosity and high surface area organosilica materials are providing herein. Methods of producing organosilica materials and uses thereof are also provided herein.

### FIELD OF THE INVENTION

The present invention relates to methods of identifying precursors for producing organosilica materials, methods of producing organosilica materials and uses thereof.

### BACKGROUND OF THE INVENTION

Porous inorganic solids have found great utility as catalysts and separation media for industrial application. In particular, mesoporous materials, such as silicas and aluminas, having a periodic arrangement of mesopores are attractive materials for use in catalysis processes due to their uniform and tunable pores, high surface areas and large pore volumes. Such mesoporous materials are known to have large specific surface areas (e.g., 1000 m²/g) and large pore volumes (e.g., 1 cm³/g). For these reasons, such mesoporous materials enable reactive catalysts.

When these organosilica materials (e.g., including aluminosilicas) are made via sol-gel synthesis processes, high surface area is difficult to retain during a drying and solvent removal step. Thus, mesoporous organosilicas are conventionally formed by the self-assembly of the silsequioxane precursor in the presence of a structure directing agent, a porogen and/or a framework element. The precursor is hydrolyzable and condenses around the structure directing agent. These materials have been referred to as Periodic Mesoporous Organosilicates (PMOs), due to the presence of periodic arrays of parallel aligned mesoscale channels. For example, Landskron, K., et al. [Science, 302:266-269 (2003)] report the self-assembly of 1,3,5-tris[diethoxysila]cylcohexane [(EtO)₂SiCH₂]₃ in the presence of a base and the structure directing agent, cetyltrimethylammonium bromide, to form PMOs that are bridged organosilicas with a periodic mesoporous framework, which consist of SiO₃R or SiO₂R₂ building blocks, where R is a bridging organic group. In PMOs, the organic groups can be homogenously distributed in the pore walls. U.S. Pat. Pub. No. 2012/0059181 reports the preparation of a crystalline hybrid organic-inorganic silicate formed from 1,1,3,3,5,5 hexaethoxy-1,3,5 trisilyl cyclohexane in the presence of NaAlO₂ and base. U.S. Patent Application Publication No. 2007/003492 reports preparation of a composition formed from 1,1,3,3,5,5 hexaethoxy-1,3,5 trisilyl cyclohexane in the presence of propylene glycol monomethyl ether. Other solutions for retaining surface area in addition to use of surface directing agents or templating agents include slow drying of the material and use of supercritical fluids, which require removal. However, all of these solutions require additional costs and complexity.

Thus, there is a need for methods of preparing organosilica materials that do not require use of surface directing agents or templating agents, extended drying and use of supercritical fluids. Furthermore, there is a need for the ability to be able to identify precursors that will produce high porosity and high surface area organosilica materials in such methods.

### SUMMARY OF THE INVENTION

It has been found that an organosilica material can be successfully prepared with desirable pore diameter, pore volume, and surface area without the need for a structure directing agent, a porogen or surfactant. Furthermore, it has been found that precursors suitable for preparing such organosilica materials with desirable pore diameter, pore volume and surface area may be identified based on the precursors' properties and the precursors'ability to quickly form a rigid network and maintain a rigid network under equilibrium conditions of hydrolysis and condensation.

Thus, in one aspect, embodiments of the invention provide a method for preparing an organosilica material. The method may comprise: (a) adding at least one silicon-containing compound into an aqueous mixture that contains essentially no structure directing agent and/or porogen to form a solution, wherein the at least one silicon-containing compound has a solvent index (W) of greater than about 1.0 and the at least one silicon-containing compound is not 1,1,3,3,5,5-hexaethoxy-1,3,5-trisilacyclohexane, bis(triethoxysilyl)methane or 1,2-bis(triethoxysilyl)ethylene; (b) aging the solution to produce a pre-product; and (c) drying the pre-product to obtain an organosilica material which is a polymer comprising independent siloxane units.

In still another aspect, embodiments of the invention provide an organosilica material produced the methods described herein.

In still another aspect, embodiments of the invention provide a catalyst material comprising the organosilica material described herein and optionally, a binder.

In still another aspect, embodiments of the invention provide an adsorbent material comprising the organosilica material described herein.

In still another aspect, embodiments of the invention provide a method for preparing an organosilica material. The method may comprise: (a) using the following solvent index (W) equation (I):

$$W = \frac{3}{2} ( \frac{{τ}_{c}^{* 2}}{{β}_{h}^{*}} ) \qquad ( I )$$

wherein τ*_{c} represents the number of hydrolyzable terminal groups remaining per silicon atom at a rigidity transition; and β*ₕ represents the number of hydrolyzable bridging groups per silicon atom at the rigidity transition; and the following kinetic index (T) equation (II):

$$T = \frac{4}{3} ( \frac{1}{{τ}_{c}^{*}} - \frac{1}{{τ}_{c 0}} ) \qquad ( II )$$

wherein τ_{c0} represents the initial number of hydrolyzable terminal groups per silicon atom; to determine at least one silicon-containing compound that satisfies the condition that W is greater than 1.0 and T is greater than zero and less than 1.0, wherein the at least one silicon-containing compound is not 1,1,3,3,5,5-hexaethoxy-1,3,5-trisilacyclohexane, bis(triethoxysilyl)methane or 1,2-bis(triethoxysilyl)ethylene; (b) adding the at least one silicon containing compound to an aqueous mixture that contains essentially no structure directing agent and/or porogen, to form a solution; (c) aging the solution to produce a pre-product; and (d) drying the pre-product to obtain an organosilica material which is a polymer comprising independent siloxane units.

In still another aspect, embodiments of the invention provide a method for identifying precursors for producing an organosilica material. The method may comprise the method comprising (a) using the following solvent index (W) equation (I):

$$W = \frac{3}{2} ( \frac{{τ}_{c}^{* 2}}{{β}_{h}^{ *}} ) \qquad ( I )$$

wherein τ*_{c} represents the number of hydrolyzable terminal groups remaining per silicon atom at a rigidity transition; and β*ₕ represents the number of hydrolyzable bridging groups per silicon atom at the rigidity transition; and the following kinetic index (T) equation (II):

$$T = \frac{4}{3} ( \frac{1}{{τ}_{c}^{*}} - \frac{1}{{τ}_{c 0}} ) \qquad ( II )$$

wherein τ_{c0} represents the initial number of hydrolyzable terminal groups per silicon atom; to determine a result where at least one silicon-containing compound satisfies the condition that W is greater than 1.0 and T is greater than zero and less than 1.0, wherein the at least one silicon-containing compound is not 1,1,3,3,5,5-hexaethoxy-1,3,5-trisilacyclohexane, bis(triethoxysilyl)methane or 1,2-bis(triethoxysilyl)ethylene; and (b) transmitting the result to another party.

In still another aspect, embodiments of the invention provide a sol-gel system comprising: an aqueous solution comprising at least one silicon-containing compound having a solvent index (W) of greater than about 1.0, wherein the aqueous solution contains essentially no structure directing agent and/or porogen and the at least one silicon-containing compound is not 1,1,3,3,5,5-hexaethoxy-1,3,5-trisilacyclohexane, bis(triethoxysilyl)methane or 1,2-bis(triethoxysilyl)ethylene.

In still another aspect, embodiments of the invention provide a silicon-containing compound having a solvent index (W) of greater than about 1.0 and a kinetic index (T) of greater than zero and less than about 1.0, wherein the at least one silicon-containing compound is not a compound selected from the group consisting of 1,1,3,3,5,5-hexaethoxy-1,3,5-trisilacyclohexane, 1,3,5-trimethyl-1,3,5-triethoxy-1,3,5-trisilacyclohexane, methyltriethoxysilane, (3-aminopropyl)triethoxysilane, (N,N-dimethylaminopropyl)trimethoxysilane, (N-(2-aminoethyl)-3-aminopropyltriethoxysilane ((H₂N(CH₂)₂NH(CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, bis(triethoxysilyl)methane, 1,2-bis(triethoxysilyl)ethylene, N,N′-bis[(3-trimethoxysilyl)propyl]ethylenediamine, bis[(methyldiethoxysilyl)propyl]amine, bis[(methyldimethoxysilyl)propyl]-N-methylamine, and tris(3-trimethoxysilylpropyl)isocyanurate.

Other embodiments, including particular aspects of the embodiments summarized above, will be evident from the detailed description that follows.

### BRIEF DESCRIPTION OF THE DRAWINGS

FIG. 1 illustrates a wall made out of 2×4 lumber that is unstable.

FIG. 2 illustrates another wall made out of 2×4 lumber that is stable.

FIG. 3 illustrates an individual 2×4 or rigid rod in two dimensions (2D).

FIG. 4 illustrates another wall made out of 2×4 lumber with an added 2×4 parallel to the top and bottom 2×4s.

FIG. 5 illustrates graph of solvent index (W) v. BET surface area for silicon-containing precursors A-C.

FIG. 6 illustrate a graph of kinetic index (T) v. solvent index (W) for silicon-containing precursors A-C.

FIG. 7 illustrate a graph of kinetic index (T) v. solvent index (W) for silicon-containing precursors A-U.

### DETAILED DESCRIPTION OF THE INVENTION

In various aspects of the invention, catalysts and methods for preparing catalysts are provided.

### I. Definitions

For purposes of this invention and the claims hereto, the numbering scheme for the Periodic Table Groups is according to the IUPAC Periodic Table of Elements.

The term “and/or” as used in a phrase such as “A and/or B” herein is intended to include “A and B”, “A or B”, “A”, and “B”.

The terms “substituent”, “radical”, “group”, and “moiety” may be used interchangeably.

As used herein, and unless otherwise specified, the term “Cₙ” means hydrocarbon(s) having n carbon atom(s) per molecule, wherein n is a positive integer.

As used herein, and unless otherwise specified, the term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and/or unsaturated), including mixtures of hydrocarbon compounds having different values of n.

As used herein, and unless otherwise specified, the term “alkyl” refers to a saturated hydrocarbon radical having from 1 to 12 carbon atoms (i.e. C₁-C₁₂ alkyl), particularly from 1 to 8 carbon atoms (i.e. C₁-C₈ alkyl), particularly from 1 to 6 carbon atoms (i.e. C₁-C₆ alkyl), and particularly from 1 to 4 carbon atoms (i.e. C₁-C₄ alkyl). Examples of alkyl groups include, but are not limited to, methyl, ethyl, propyl, butyl, pentyl, hexyl, heptyl, octyl, decyl, and so forth. The alkyl group may be linear, branched or cyclic. “Alkyl” is intended to embrace all structural isomeric forms of an alkyl group. For example, as used herein, propyl encompasses both n-propyl and isopropyl; butyl encompasses n-butyl, sec-butyl, isobutyl and tert-butyl and so forth. As used herein, “C₁ alkyl” refers to methyl (—CH₃), “C₂ alkyl” refers to ethyl (—CH₂CH₃), “C₃ alkyl” refers to propyl (—CH₂CH₂CH₃) and “C₄ alkyl” refers to butyl (e.g. —CH₂CH₂CH₂CH₃, —(CH₃)CHCH₂CH₃, —CH₂CH(CH₃)₂, etc.). Further, as used herein, “Me” refers to methyl, and “Et” refers to ethyl, “i-Pr” refers to isopropyl, “t-Bu” refers to tert-butyl, and “Np” refers to neopentyl.

As used herein, and unless otherwise specified, the term “alkylene” refers to a divalent alkyl moiety containing 1 to 12 carbon atoms (i.e. C₁-C₁₂ alkylene) in length and meaning the alkylene moiety is attached to the rest of the molecule at both ends of the alkyl unit. For example, alkylenes include, but are not limited to, —CH₂—, —CH₂CH₂—, —CH(CH₃)CH₂—, —CH₂CH₂CH₂—, etc. The alkylene group may be linear or branched. The alkylene group may be optionally substituted with a halogen atom, such as, but not limited to flourine (F), chlorine (Cl), bromine (Br) or iodine (I), wherein one or more hydrogen atoms in the alkylene group may be substituted with a halogen atom. For example, alkylenes substituted with a halogen atom include, but are not limited to, —CZ₂—, —(CH₂)ₘ(CZ₂)ₚ—, wherein m is 1 to 20, p is 1 to 20 and each Z is independently F, Cl, Br or I, etc.

As used herein, and unless otherwise specified, the term “nitrogen-containing alkylene” refers to an alkylene group as defined herein wherein one or more carbon atoms in the alkyl group is substituted with a nitrogen atom. The nitrogen atom(s) may optionally be substituted with one or two C₁-C₆ alkyl groups. The nitrogen-containing alkylene can have from 1 to 20 carbon atoms (i.e. C₁-C₂₀ nitrogen-containing alkylene), particularly from 1 to 12 carbon atoms (i.e. C₁-C₁₂ nitrogen-containing alkylene), particularly from 1 to 10 carbon atoms (i.e. C₁-C₁₀ nitrogen-containing alkylene), particularly from 2 to 10 carbon atoms (i.e. C₂-C₁₀ nitrogen-containing alkylene), particularly from 3 to 10 carbon atoms (i.e. C₃-C₁₀ nitrogen-containing alkylene), particularly from 4 to 10 carbon atoms (i.e. C₄-C₁₀ nitrogen-containing alkylene), and particularly from 3 to 8 carbon atoms (i.e. C₃-C₈ nitrogen-containing alkyl). Examples of nitrogen-containing alkylenes include, but are not limited to,

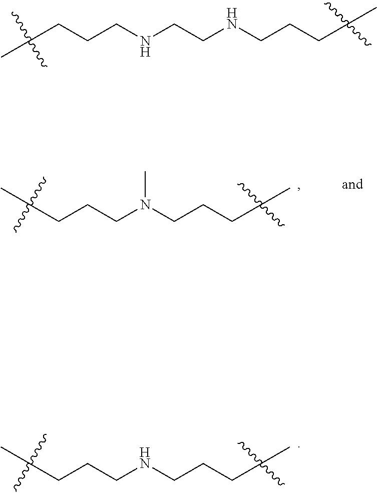

As used herein, and unless otherwise specified, the term “alkenyl” refers to an unsaturated hydrocarbon radical having from 2 to 12 carbon atoms (i.e., C₂-C₁₂ alkenyl), particularly from 2 to 8 carbon atoms (i.e., C₂-C₈ alkenyl), particularly from 2 to 6 carbon atoms (i.e., C₂-C₆ alkenyl), and having one or more (e.g., 2, 3, etc.) carbon-carbon double bonds. The alkenyl group may be linear, branched or cyclic. Examples of alkenyls include, but are not limited to ethenyl (vinyl), 2-propenyl, 3-propenyl, 1,4-pentadienyl, 1,4-butadienyl, 1-butenyl, 2-butenyl and 3-butenyl. “Alkenyl” is intended to embrace all structural isomeric forms of an alkenyl. For example, butenyl encompasses 1,4-butadienyl, 1-butenyl, 2-butenyl and 3-butenyl, etc.

As used herein, and unless otherwise specified, the term “alkenylene” refers to a divalent alkenyl moiety containing 2 to about 12 carbon atoms (i.e. C₂-C₁₂ alkenylene) in length and meaning that the alkylene moiety is attached to the rest of the molecule at both ends of the alkyl unit. For example, alkenylenes include, but are not limited to, —CH═CH—, —CH═CHCH₂—, —CH═CH═CH—, —CH₂CH₂CH═CHCH₂—, etc. —CH₂CH₂—, —CH(CH₃)CH₂—, —CH₂CH₂CH₂—, etc. The alkenylene group may be linear or branched.

As used herein, and unless otherwise specified, the term “alkynyl” refers to an unsaturated hydrocarbon radical having from 2 to 12 carbon atoms (i.e., C₂-C₁₂ alkynyl), particularly from 2 to 8 carbon atoms (i.e., C₂-C₈ alkynyl), particularly from 2 to 6 carbon atoms (i.e., C₂-C₆ alkynyl), and having one or more (e.g., 2, 3, etc.) carbon-carbon triple bonds. The alkynyl group may be linear, branched or cyclic. Examples of alkynyls include, but are not limited to ethynyl, 1-propynyl, 2-butynyl, and 1,3-butadiynyl. “Alkynyl” is intended to embrace all structural isomeric forms of an alkynyl. For example, butynyl encompasses 2-butynyl, and 1,3-butadiynyl and propynyl encompasses 1-propynyl and 2-propynyl (propargyl).

As used herein, and unless otherwise specified, the term “alkynylene” refers to a divalent alkynyl moiety containing 2 to about 12 carbon atoms (i.e. C₂-C₁₂ alkenylene) in length and meaning that the alkylene moiety is attached to the rest of the molecule at both ends of the alkyl unit. For example, alkenylenes include, but are not limited to, —C≡C—, —C≡CCH₂—, —CH₂CH₂C≡CCH₂—, etc. —CH₂CH₂—, —CH(CH₃)CH₂—, —CH₂CH₂CH₂—, etc. The alkynylene group may be linear or branched.

As used herein, and unless otherwise specified, the term “alkoxy” refers to —O-alkyl containing from 1 to about20 carbon atoms. The alkoxy may be straight-chain or branched-chain. Non-limiting examples include methoxy, ethoxy, propoxy, butoxy, isobutoxy, tert-butoxy, pentoxy, and hexoxy. “C₁ alkoxy” refers to methoxy, “C₂ alkoxy” refers to ethoxy, “C₃ alkoxy” refers to propoxy and “C₄ alkoxy” refers to butoxy. Further, as used herein, “OMe” refers to methoxy and “OEt” refers to ethoxy.

As used herein, and unless otherwise specified, the term “aromatic” refers to unsaturated cyclic hydrocarbons having a delocalized conjugated 7C system and having from 5 to 20 carbon atoms (aromatic C₅-C₂₀ hydrocarbon), particularly from 5 to 12 carbon atoms (aromatic C₅-C₁₂ hydrocarbon), and particularly from 5 to 10 carbon atoms (aromatic C₅-C₁₂ hydrocarbon). Exemplary aromatics include, but are not limited to benzene, toluene, xylenes, mesitylene, ethylbenzenes, cumene, naphthalene, methylnaphthalene, dimethylnaphthalenes, ethylnaphthalenes, acenaphthalene, anthracene, phenanthrene, tetraphene, naphthacene, benzanthracenes, fluoranthrene, pyrene, chrysene, triphenylene, and the like, and combinations thereof. Additionally, the aromatic may comprise one or more heteroatoms. Examples of heteroatoms include, but are not limited to, nitrogen, oxygen, and/or sulfur. Aromatics with one or more heteroatom include, but are not limited to furan, benzofuran, thiophene, benzothiophene, oxazole, thiazole and the like, and combinations thereof. The aromatic may comprise monocyclic, bicyclic, tricyclic, and/or polycyclic rings (in some embodiments, at least monocyclic rings, only monocyclic and bicyclic rings, or only monocyclic rings) and may be fused rings.

As used herein, and unless otherwise specified, the term “aryl” refers to any monocyclic or polycyclic cyclized carbon radical containing 4 to 14 carbon ring atoms, wherein at least one ring is an aromatic hydrocarbon. An aryl may comprise one or more heteroatoms. Examples of heteroatoms include, but are not limited to, nitrogen, oxygen, and/or sulfur. Examples of aryls include, but are not limited to phenyl, naphthyl, pyridinyl, and indolyl.

As used herein, and unless otherwise specified, the term “arylene” refers to a diradical derived from an aryl (including substituted aryl) as defined above.

Examples of arylenes include, but are not limited to 1,2-phenylene, 1,3-phenylene, 1,4-phenylene, 1,2-naphthylene and the like.

As used herein, and unless otherwise specified, the term “aralkyl” refers to an alkyl group substituted with an aryl group. The alkyl group may be a C₁-C₁₀ alkyl group, particularly a C₁-C₆, particularly a C₁-C₄ alkyl group, and particularly a C₁-C₃ alkyl group. Examples of aralkyl groups include, but are not limited to phenylmethyl, phenylethyl, and naphthylmethyl. The aralkyl may comprise one or more heteroatoms and be referred to as a “heteroaralkyl.” Examples of heteroatoms include, but are not limited to, nitrogen (i.e., nitrogen-containing heteroaralkyl), oxygen (i.e., oxygen-containing heteroaralkyl), and/or sulfur (i.e., sulfur-containing heteroaralkyl). Examples of heteroaralkyl groups include, but are not limited to, pyridinylethyl, indolylmethyl, furylethyl, and quinolinylpropyl.

As used herein, and unless otherwise specified, the term “heterocyclo” refers to fully saturated, partially saturated or unsaturated or polycyclic cyclized carbon radical containing from 4 to 20 carbon ring atoms and containing one or more heteroatoms atoms. Examples of heteroatoms include, but are not limited to, nitrogen (i.e., nitrogen-containing heterocyclo), oxygen (i.e., oxygen-containing heterocyclo), and/or sulfur (i.e., sulfur-containing heterocyclo). Examples of heterocyclo groups include, but are not limited to, thienyl, furyl, pyrrolyl, piperazinyl, pyridyl, benzoxazolyl, quinolinyl, imidazolyl, pyrrolidinyl, and piperidinyl.

As used herein, and unless otherwise specified, the term “heterocycloalkyl” refers to an alkyl group substituted with heterocyclo group. The alkyl group may be a C₁-C₁₀ alkyl group, particularly a C₁-C₆, particularly a C₁-C₄ alkyl group, and particularly a C₁-C₃ alkyl group. Examples of heterocycloalkyl groups include, but are not limited to thienylmethyl, furylethyl, pyrrolylmethyl, piperazinylethyl, pyridylmethyl, benzoxazolylethyl, quinolinylpropyl, and imidazolylpropyl.

As used herein, and unless otherwise specified, the term “acyloxy” refers to an ester group —O—C(O)R⁴, where R⁴ may be hydrogen, alkyl, alkenyl, alkynyl, aryl, aralkyl, or a combination thereof.

As used herein, and unless otherwise specified, the term “amino” refers to —N(R⁵)(R⁶) wherein R⁵ and R⁶ are each independently selected from hydrogen, alkyl as defined herein, alkenyl as defined herein, alkynyl as defined herein, aryl as defined herein, and heterocyclylo as defined herein.

As used herein, and unless otherwise specified, the term “aminoalkyl” refers to to at least one amino group (e.g., primary amino, secondary amino) bonded to any carbon atom of an alkyl group, where the alkyl group is as defined herein.

As used herein, and unless otherwise specified, the term “arylalkoxy” refers to an aryl group as defined herein attached to an alkoxy group as defined herein. Examples of arylalkoxy groups include, but are not limited to, 2-phenylethoxy, 3-naphth-2-ylpropoxy, and 5-phenylpentyloxy.

As used herein, and unless otherwise specified, the term “halogen” or “halide” refers to flourine (F), chlorine (Cl), bromine (Br) and iodine (I). As used herein, and unless otherwise specified, the term “haloalkyl” refers to an alkyl moiety as described herein in which one or more of the hydrogen atoms has been replaced by a halogen atom. For example, halolkyls include, but are not limited to, —CZₘ, —(CH₂)ₚ(CZ₂)_{q}CZ₃, wherein m is 1 to 3, p is zero to 20, q is zero to 20 and each Z is independently F, Cl, Br or I, etc. Examples of haloalkyls include, but are not limited to, chloromethyl, fluoromethyl, bromomethyl, trifluoromethyl, dichloromethyl, 2-chloro-2-fluoroethyl, 6,6,6-trichlorohexyl and the like.

As used herein, and unless otherwise specified, the term “hydroxyl” refers to an —OH group.

As used herein, and unless otherwise specified, the term “hydrolyzable” refers to a group which is capable of hydrolyzing under appropriate conditions, to yield a compound that is capable of undergoing condensation reactions. Additionally or alternatively, hydrolyzable encompasses a group directly capable of undergoing condensation reactions under appropriate conditions. The hydrolyzable groups upon hydrolysis may yield groups capable of undergoing condensation reactions, such as silanol groups. Non-limiting examples of hydrolyzable groups include, an oxygen atom, an alkoxy group, an acyloxy group, an aryloxy group, a halide, a halogen substituted alkylene, a —O—R¹— group, and a —R²—O—R³— group, wherein R¹, R² and R³ are independently selected from the group consisting of a alkylene group or an arylene group. The hydrolyzable groups may be present as a bridging group, for example, bonded between two silicon atoms (e.g., an oxygen atom, a halogen substituted alkylene, a nitrogen-containing alkylene group, and —R²—O—R³—, wherein R¹, R² and R³ are each independently an alkylene group or an arylene group) or present as a terminal group bonded to a silicon atom (e.g., alkoxy group, an acyloxy group, an arylalkoxy group, a hydroxyl group, a haloalkyl group, a halide, an aminoalkyl group).

As used herein, and unless otherwise specified, the term “non-hydrolyzable” refers to a group which is generally not capable of hydrolyzing under conditions for hydrolyzing and condensation reactions, (e.g., acidic or basic aqueous conditions where the hydrolyzable groups are hydrolyzed). Non-limiting examples of non-hydrolyzable groups include, an alkyl group an alkylene group, an alkenyl group, an alkenylene group, an alkynyl group, an alkynylene group, an aryl group, and an arylene group.

The non-hydrolyzable group may be present as a bridging group, for example, bonded between two silicon atoms (e.g. an alkylene group, an alkenylene group, an alkynylene group, and an arylene group) or present as a terminal group bonded to a silicon atom (e.g., an alkyl group, an alkenyl group, an alkynyl group, and an aryl group).

As used herein, and unless otherwise specified, the term “mesoporous” refers to solid materials having pores that have a diameter within the range of from about 2 nm to about 50 nm.

As used herein, and unless otherwise specified, the term “organosilica” refers to an organosiloxane compound that comprises one or more organic groups bound to two or more Si atoms.

As used herein, and unless otherwise specified, the term “silanol” refers to a Si—OH group.

As used herein, and unless otherwise specified, the terms “structure directing agent,” “SDA,” and/or “porogen” refer to one or more compounds added to the synthesis media to aid in and/or guide the polymerization and/or polycondensing and/or organization of the building blocks that form the organosilica material framework. Further, a “porogen” is understood to be a compound capable of forming voids or pores in the resultant organosilica material framework. As used herein, the term “structure directing agent” encompasses and is synonymous and interchangeable with the terms “templating agent” and “template.”

As used herein, and unless otherwise specified, the term “adsorption” includes physisorption, chemisorption, and condensation onto a solid material and combinations thereof.

### II. Rigidity Theory

As discussed above, porous inorganic solids are important materials for adsorptive and catalytic applications, especially in chemical and petroleum processing. In particular, high porosity and high surface area organosilica materials (e.g., aluminosilicas) are very desirable for use in adsorbents, catalysts and supports. However, when these organosilica materials (e.g., including organoaluminosilicas) are made via sol-gel synthesis processes, high surface area can be difficult to retain during a drying and solvent removal step. Some solutions for retaining surface area can include use of surface directing agents or templating agents, as well as slow drying of the material and use of supercritical fluids, which can require removal. However, all of these solutions can come with additional costs and/or complexity. Thus, there is a need for methods of preparing organosilica materials that do not require use of surface directing agents or templating agents, extended drying and use of supercritical fluids. Furthermore, there is a need for the ability to be able to identify precursors to produce high porosity and high surface area organosilica materials in such methods.

It was discovered that, in organosilica material preparations (e.g., sol-gel synthesis processes), porosity and surface area of the resultant organosilica material can be related to certain properties or features of the precursors used for making the organosilica material, and particularly, how those certain properties and features affect formation of a rigid network during preparation (e.g., sol-gel synthesis processes) of the organosilica material. Examples of relevant features of the precursors can include, but are not limited to hydrolyzable terminal groups, hydrolyzable bridging groups and non-hydrolyzable bridging groups present in the precursor. Specifically, the drying and gelling step of the organosilica material preparation (e.g., sol-gel synthesis processes) was examined. During drying, there can be strong capillary forces present which can push the system to collapse. At some point the network can be at a rigidity transition, i.e., the network can be at least minimally rigid, and it can then withstand the capillary forces present which otherwise could cause it to collapse. At that point, the volume, and hence the pore volume and the surface area, of the resulting organosilica material solid can be considered essentially fixed. The remainder of the solvent can be removed without further collapse. Conversely, a non-rigid network can collapse as solvent is removed. For the solid to maintain high void space and surface area during drying without any other supports, such as surfactants, it should ideally obtain rigidity before the solvent is removed. Thus, it was discovered that two indices can be defined based on rigidity theory relating to: (i) the amount of solvent present at the rigidity transition; and (ii) the time for initially hydrolyzed precursor molecules to form a minimally rigid network. Further, these two indices, separate or together, may be used to identify suitable precursors for preparing high porosity and high surface area organosilica materials. Discussion regarding the development of these indices is provided below.

II.A. Rigidity Theory: Introduction

Constraint Counting balances the degrees of freedom of movement for a collection of macroscopic rigid objects with the constraints on their movement effected by connections between them. See Maxwell, J. C. (1864) Phil. Mag., 27: 294-299. This theory, termed “rigidity theory”, can explain why some physical structures are rigid and others not, by counting the degrees of freedom and constraints.

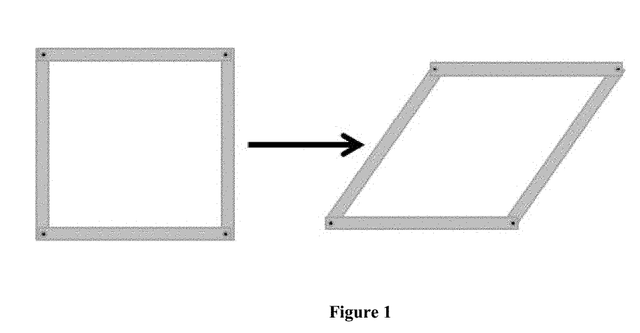

Consider a simple wall built of 2×4 (inch) pieces of lumber, as shown in FIG. 1. See Thorpe, M. F., Rigidity Theory and Applications, Kluwer Academic/Plenum Publishers, 1999.

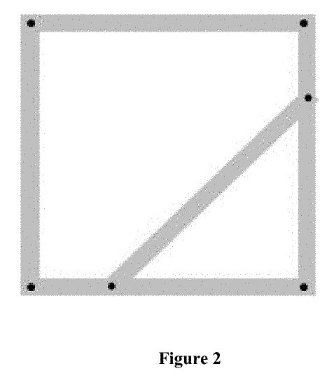

The wall as shown in FIG. 1 is unstable to shearing motions as indicated; any slight force in the direction shown will cause it to collapse. A 2×4 piece of lumber may be added, as shown in FIG. 2, and the wall is stable; it now may require a very large force (in the plane of the wall) to cause any motion.

1. Degrees of Freedom

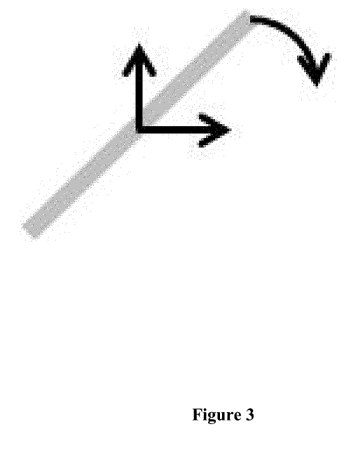

As shown in FIG. 3, each component 2×4 in the wall is a rigid object in two dimensions (2D) with 2 translational degrees of freedom and one rotational degree of freedom for a total of 3 degrees of freedom or independent ways that it can move. It requires 3 independent numbers to specify the position of each piece of lumber; these can be taken as the horizontal and vertical positions of some part of it, and an angle to specify its rotation around an axis perpendicular to the plane.

A collection of M 2×4's has 3M degrees of freedom; a complete specification requires coordinates and an angle for each one. The wall in FIG. 1 has 12 total degrees of freedom (4×3=12), and the wall in FIG. 2 has 15 total degrees of freedom (5×3=15).

Similarly, the entire wall, considered as a compound object, has 3 degrees of freedom in the plane—two translational and one rotational. The internal or structural motions of the wall are of interest, not its position or orientation. Therefore, subtracted from the total degrees of freedom are those of the collection itself to get the number of structural degrees of freedom for the collection: 12−3=9 for the wall in FIG. 1 and 15−3=12 for the wall in FIG. 2.

2. Constraints

Whenever two 2×4s (in a 2D problem) are connected via a nail, two constraints are added: the horizontal (x direction) and vertical (y direction) positions of some part of each 2×4 are now equal: x₁=x₂ and y₁=y₂. This is true for each such connection or nail. Therefore, the wall in FIG. 1 has 8 constraints (4×2=8) and the wall in FIG. 2 has 12 constraints (6×2=12).

3. Net Degrees of Freedom

The net degrees of freedom (Net d.o.f.) are defined as the structural degrees of freedom (structural d.o.f.) minus the constraints:

[Net d.o.f.]=[structural d.o.f.]−constraints 1.

When the Net d.o.f.=0, there are just as many constraints as degrees of freedom and the collective object should be (minimally) rigid; any internal parameters cannot be changed without violating at least one of the constraints. This is true for the wall shown in FIG. 2 (5×3−3−6×2=0), but not for the wall shown in FIG. 1 (4×3−3−4×2=1). The remaining one degree of freedom corresponds to the shearing motion.

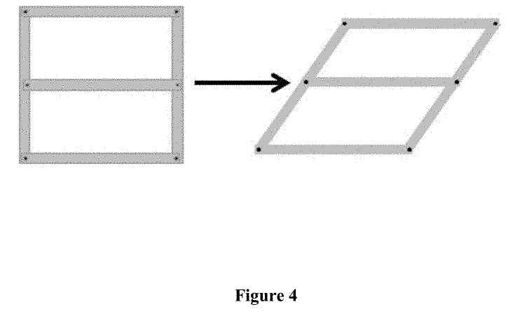

There is one complication. There can be constraints which are not effective for establishing rigidity: they can be redundant. Consider the wall shown in FIG. 4. One of the constraints in this wall is redundant and the shearing motion (see FIG. 1) still exists as a low-energy motion. The added 2×4 is parallel to the top and bottom 2×4s. This symmetry means that it can participate in the shearing motion without changing its length and without providing any resistance. In general, redundant constraints are typically not counted when attempting to establish rigidity. For amorphous networks or materials, the fraction of redundant constraints tends to be small, as they are associated with symmetry, and may be neglected.

Also note that adding constraints in addition to the number required for minimal rigidity does not change the fact that it is rigid, in the sense it has no low-energy motions available to it, but it might change other physical properties. If the 2×4s were not quite absolutely rigid, but were instead very stiff springs, the energy required to compress the wall would depend on the number of 2×4s present.

II.B. Rigidity Theory and Glasses: Atom Based Approach

Since about 1980, the same theory has been applied to explain and predict the chemistry and properties of dense glasses—amorphous networks of molecules that avoid transforming into lower energy crystalline materials. In an initial example, J. C. Phillips showed that SiO₂ is, in a sense, perfectly balanced between a soft and rigid system and hence easily forms a glass. See J. C. Phillips (1979), J. Non-Cryst. Sol., 34: 153.

Following the succinct argument in Thorpe, consider any system of M atoms where each atom is bonded to at least two others. Each atom (in three dimensionals (3D)) has 3 degrees of freedom, so the total is 3M. See M. F. Thorpe, “Surface and Bulk Floppy Modes in Network Glasses”; 8^{th} Int. School Cond. Matt. Phys., 1994. Each bond between atoms introduces a single constraint of the form: distance(1,2)=d where d is the bond distance. If the coordination (number of bonded neighbors) of an atom is r (r is not the bond distance and is chosen to be consistent with the literature), then r/2 bond-distance constraints can be assign to the atom. The other r/2 constraints are assigned to its bonded neighbors.

Any constraints imposed by restrictions on the bond angles should be accounted for. For covalently-bonded atoms bonded to at least 2 neighbors, there are 2r−3 independent (non-redundant) bond-angle constraints for each r-coordinated atom (a single angle constraint for an atom bonded to 2 neighbors, 3 for 3 neighbors, 5 for 4 neighbors . . . ). See M. F. Thorpe, “Surface and Bulk Floppy Modes in Network Glasses”; 8^{th} Int. School Cond. Matt. Phys., 1994.

The net degrees of freedom is then,

F=3M−Σᵣ₌₂nᵣ[r/2+(2r−3)], 2

where nᵣ is the number of atoms with coordination r. Defining f=F/3M provides,

f=2−5/6 [symbol] r [symbol] 3

where the mean coordination is

[symbol]

r [symbol] =Σᵣ₌₂r*nᵣ/Σᵣ₌₂nᵣ 4.

Setting f to zero, the mean coordination where the constraints balance the degrees of freedom is

[symbol]

r [symbol] =2*6/5=2.4 5.

This was Phillips' prediction for the mean coordination at the transition from a floppy to a minimally rigid system. See J. C. Phillips, J. Non-Cryst. Sol., 34, 153, 1979.

Fully connected SiO₂ has a mean coordination:

[symbol]

r [symbol] =(4+2*2)/3=8/3˜2.67,

which is just above the predicted “rigidity transition”. Dense silica glasses are usually produced from a melt and the solidification happens at elevated temperature (fused quartz m.p.˜1700° C.) where the Si—O—Si bond-bending constraints may not be effective. If the angle-bending constraints are subtracted from the sum over nᵣ in equation 2, in place of equation 3,

$$f = 2 - \frac{5}{6} 〈 r 〉 + \frac{{n}_{2}}{3 M} = 2 - \frac{5}{6} 〈 r 〉 + \frac{{x}_{2}}{3} , \qquad 6$$

where x₂ is the fraction of atoms with r=2. Since x₂=2/3 for SiO₂,

$$f = 2 - \frac{5}{6} 〈 r 〉 + \frac{2}{9} = \frac{20}{9} - \frac{5}{6} 〈 r 〉 \text{..} \qquad 7$$

Again setting the structural degrees of freedom to zero provides:

$$〈 r 〉 = \frac{20}{9} * \frac{6}{5} = \frac{8}{3} \sim 2.67 \text{..} \qquad 8$$

The connectivity in SiO₂, taking into account that the bond-angle bending constraint is ineffective for the melt, is exactly that required by the theory for a system at the rigidity transition. It is this that has been claimed to explain the glass-forming tendency of silica. It may be useful to note that the theory is flexible and relatively easy to implement for different physical situations.

II.C. Rigidity Theory: General Derivation

The above discussion of SiO₂ focuses on atoms and the constraints associated with each one according to its covalent coordination number within a fully connected solid network. For the purposes of understanding and predicting the behavior of a wide range of both precursors and network solids, it is useful to instead formulate the theory based on arbitrary rigid sub-units rather than atoms. For example, the silicates are formed from rigid corner-sharing SiO₄ tetrahedra and the final structure can be analyzed in terms of these rather than in terms of Si and O atoms.

Following the presentation of Gupta, but modifying the nomenclature, new results were derived. See P. K. Gupta, “Topologically Disordered Networks of Rigid Polytopes: Applications to Non-crystalline Solids and Constrained Viscous Sintering”; pp. 173-190 in Thorpe, M. F., Rigidity Theory and Applications, Kluwer Academic/Plenum Publishers, 1999.

For convenience, symbols and abbreviations are introduced when first used, but they are also collected in Table 1 following this discussion. When considering a collection of M 3-dimensional rigid objects in a space of 3 dimensions, each object has a number of vertexes, V, some of which may be merged with a vertex of another object to form a “joint”. A free vertex is considered a joint with connectivity, C, equal to 1 and a joint merging two objects has a connectivity C=2. Note that the connectivity is not quite the same as the coordination number used above. In the silica case, Si(OH)₄ is a rigid tetrahedron with 4 vertexes and 4 joints all of which consist of the OH groups. If two of them condense together to form (OH)₃Si—O—Si(OH)₃, the combined object has only 7 joints as one is lost upon condensation. The bridging oxygen atom is a joint with C=2. The average connectivity of the collection is a sum over all the joints:

$$C = \frac{1}{N} {\sum }_{1}^{{C}_{max}} {C}_{i} ,$$

where N is the total number of joints. The average number of vertexes per object is

$$V = \frac{1}{M} {\sum }_{1}^{{V}_{max}} {V}_{i} .$$

The fundamental sum-rule provides that the sum over all objects of the vertexes on each object is equal to the sum over all the joints of the number of objects connected by the joint:

MV=CN 9.

The number of structural degrees of freedom, F, of the collection of objects is the total number of degrees of freedom minus the constraints imposed by merging the joints and minus the degrees of freedom of the collection as a whole. Each object has nₜ (=3) translational and nᵣ (=3) rotational degrees of freedom and v_{T} (=6) is the number of degrees of freedom of the collection as a whole. Each joint introduces, on average, nₜ(C−1) translational constraints and n_{θ} angle constraints.

$$\begin{matrix}F = M ( {n}_{t} + {n}_{r} ) - {v}_{T} - [ {n}_{t} ( C - 1 ) N + {n}_{θ} N ] , \\ = M [ {n}_{t} + {n}_{r} - {n}_{t} V + ( {n}_{t} - {n}_{θ} ) \frac{V}{C} - \frac{{v}_{T}}{M} ] ,\end{matrix} \qquad 10$$

where equation 9 was used to produce the 2^{nd} line. Again using equation 9 and writing in terms of N instead of M provides:

$$F = N [ C ( \frac{{n}_{t} + {n}_{r}}{V} - {n}_{t} ) + {n}_{t} - {n}_{θ} - \frac{{v}_{T}}{N} ] \text{..} \qquad 11$$

The 2r−3 formula (2C−3 in the current context) used above for the number of independent bond-angle constraints around each atom is not correct for terminal joints that are connected to only one rigid object (C=1, but n_{θ}=0, not −1 as would be produced by 2C-3). Instead, it can be shown that n_{θ}=2C+x₁−3 where x₁ is the number of terminal groups divided by the number of joints in the combined collection of objects. See J. C. Angus and F. Jansen, Jour. Vac. Soc. Am., A6, 1778, 1988; P. Boolchand and M. F. Thorpe, Physical Review B 50, 10366, 1994.

The critical average connectivity, C*, can be defined as the average connectivity of a collection of objects at which the object becomes rigid—it has a net zero structural degrees of freedom. By setting F/M=0, C* is

$${C}^{*} = \frac{V ( {n}_{t} - {n}_{θ} )}{{Vn}_{t} - ( {n}_{t} + {n}_{r} ) + \frac{{v}_{T}}{M}} . \qquad 12$$

Using nₜ=nᵣ=3, v_{T}=6, the above expression for n_{θ}, and C=1*x₁+2x₂=2−x₁ (assuming only one or two objects connected by each joint), this can be reduced to

$${C}^{*} = \frac{1}{1 - \frac{3}{2 V} ( 1 - \frac{1}{M} )} . \qquad 13$$

Note that if the angle constraints around the joints are ignored for a large system (M approaching ∞) of tetrahedra (V=4) in 3D (nₜ=nᵣ=3), then

$${C}^{*} = \frac{{Vn}_{t}}{{Vn}_{t} - ( {n}_{t} + {n}_{r} )} = 2 ,$$

which is the situation for SiO₂ when considered as tetrahedra bridged by two-fold coordinates joints with no bond-angle constraints at the joints. The counting rigid-objects approach gives an equivalent rigidity transition to the counting atoms approach.

A hardness index as h=C−C* was defined. When h=0, the system is incipiently rigid. For h<0, the system is soft or floppy and for h>0 the system is rigid (and either strained or contains some redundant constraints). For h>0, if the constraints are spring-like instead of perfectly rigid, the system has a finite elastic modulus that increases with increasing h. See P. Boolchand, M. Zhang, and B. Goodman, Phys. Rev. B, 53, 11488-11494, 1996.

It can be shown that

$$h = 1 - {x}_{1} - \frac{3 ( 1 - \frac{1}{M} )}{2 V - 3 ( 1 - \frac{1}{M} )} . \qquad 14$$

Setting h=0 provides:

$${x}_{1}^{*} = \frac{V - 3 ( 1 - \frac{1}{M} )}{V - \frac{3}{2} ( 1 - \frac{1}{M} )} . \qquad 15$$

The above equation provides the number of terminal groups per joint that are present at the rigidity transition.

The above formulae are written in terms of the average values of V, C, n, etc., meaning that the theory is essentially a mean-field theory. Nonetheless, there could exist realizations of networks that are rigid, and even over-constrained, in some regions and floppy in others. However, in this non-limiting aspect, the assumption was that such networks do not occur, which is consistent with the assumption that there are no (or a negligibly small number of) redundant constraints.

II.D. Bridging Groups, Terminal Groups, and Condensation Reactions

From equation 14, it is shown that increasing the fraction of joints that are terminal groups decreases the hardness index, e.g., making the system more floppy. This is important in understanding, for example, the differences between the materials made from precursors, 1,1,3,3,5,5-hexaethoxy-1,3,5-trisilacyclohexane ([(EtO)₂SiCH₂]₃) and 1,3,5-trimethyl-1,3,5-triethoxy-1,3,5-trisilacyclohexane ([CH₃EtO₂SiCH₂]₃). For the following discussion, it is useful to consider the ratios of the numbers of terminal groups and bridging groups to the numbers of objects or to atoms associated with each object.

For example, (OH)₃—Si—CH₂—Si—(OH)₃ can be considered to be an object that consists of two central groups (the Si atoms), one bridging group, the —CH₂—, and 6 terminal groups, the —OH's. Terminal groups are coordinated to only 1 central group and are also called one-fold-coordinated joints. The number of terminal groups are defines relative to the central atoms as τ=terminal groups/central groups=OH/Si. Similarly, the relative number of bridging groups is β=bridging groups/central groups=½ in this specific case. The ratios of the bridging and terminal groups to the central groups is important. In this context, the central group could comprise any moiety capable of forming connections with itself or other moieties to form a rigid network. Although we describe moieties based on a central connecting Si site, the method disclosed here need not be limited to Si or sol-gel chemistry.

Condensation reactions in sol-gel syntheses convert condensable terminal groups to bridging groups. For example,

2R—OH [symbol] R—O—R+H₂O 16.

An extent of reaction for condensation may be defined. If ti is the average number of terminal groups per central group, β is the average number of bridging groups per central group, S (=τ+β) is the average number of joints per central group, and the number of condensation reactions per central group is n:

Two terminal groups are lost for every condensation: □=□₀−2n.

One bridging group is formed for every condensation: □=□₀+n.

A net of one joint is lost for every condensation: S=S₀−n. 17.

When n=0, □=□₀, □=□₀, and S=S₀. At the rigidity transition, n=n*, □=□* and □=□*:

□□=□₀−2n*

□□=□₀+n*

S*=S₀−n* 18.

From the definitions of □, x₁, and S; □=x₁S. Substituting this into the equations above for □*, and S*, it can be shown that:

$${n}^{*} = \frac{{τ}_{0} - {x}_{1}^{*} {s}_{0}}{2 - {x}_{1}^{*}} \qquad 19$$

From this expression, the extent of reaction necessary to form a rigid network from some initial, floppy, state such as a solution of unconnected monomers can be determined. The equation 18 can then be used to determine the numbers of terminal and bridging groups per central group at the transition in terms of the initial values:

$${τ}^{*} = ( {τ}_{0} + 2 {β}_{0} ) \frac{( V - 3 )}{V} \\ {β}^{*} = \frac{3}{2} \frac{1}{V} ( {τ}_{0} + 2 {β}_{0} ) . \qquad 20$$

Using the above equations provides a means to predict some aspects of the structure of the network at the rigidity transition, using only properties of the initial precursors.

II.D. Gelation and Drying

Certain factors that control the final porosity of the solid. These factors may be used to define two indexes, as discussed above, to distinguish the abilities of different precursors to form high-porosity materials.

During drying, there are strong capillary forces present which push the system to collapse. From an energetic point of view, an exemplary silica system is drawn to become quartz and air rather than porous amorphous silica. In other words, minimizing the surface area minimizes the free energy and is therefore stabilizing. The drying process and the stresses involved are summarized by C. J. Brinker and G. W. Scherer. See C. J. Brinker and G. W. Scherer, Sol-Gel Science; The Physics and Chemistry of Sol-Gel Processing, Academic Press, 1990, see Chapter 4 on Drying.

For a sol-gel synthesis to produce highly mesoporous materials without any structure supporting agents other than solvents, a key property of the precursor is the ability to form a network with the property of rigidity as defined above. During the drying step of the synthesis, solvent is driven off, leaving behind a solid. Any porosity remaining in the solid will typically have been filled by solvent (or some other species present in the synthesis) and the still-swollen solid will typically have had enough mechanical and chemical integrity to survive loss of solvent without collapse. As discussed above, in some syntheses, void spaces are maintained by the presence of template molecules such as surfactants as used in previously synthesized mesoporous silicas, such as MCM-41 and periodic mesoporous organosilicas (PMO). See Van Der Voort, P. et al. (2013) Chem. Soc. Rev., 42: 3913-3955; Fujita, S. and Inagaki S. (2008), Chem. Mater., 20: 891-908.

However, if the nascent solid is to survive drying with high void space and high surface area, but without any of these other supports, it should obtain rigidity before the solvent is removed. At some point during the drying step, especially if it occurs at a temperature above the gelation temperature, the growing network may be in near-equilibrium with the solvent with respect to solvolysis and condensation reactions. When large amounts of solvent are present, the equilibrium can be shifted towards solvolysis and the network can be relatively un-connected and less rigid. As solvent is removed, the equilibrium can shift towards condensation and a more-connected, more-rigid, solid phase. At some stage of drying, if the network cannot withstand the loss of solvent, it will collapse. Features of the precursors that can lead to more rigid networks while the amount of solvent is still relatively high can tend to produce higher porosity and surface area materials. Thus, solvent index (W) may be defined, which is related to the amount of solvent present at equilibrium when a transition to a rigid network is first achieved relative to tetraethylorthosilicate (TEOS) ((EtO)₄Si) as a reference material. W can be calculated for many precursors from their structural and chemical properties.

Larger values of W will lead to higher porosity and surface area.

Further, during the gelation stage of synthesis, it can be advantageous for the forming network of bonded precursor molecules to either reach a rigidity transition or be near it. This means that features of the precursor molecules that lend to rapid condensation kinetics can be favorable. Thus, a kinetic index (T) may be defined, which is related to the time for the initially hydrolyzed precursor molecules to form a minimally rigid network—relative to the time required by a TEOS reference system. This index can also be calculated for many precursors from structural and chemical features of the molecules. Because it is relative to a reference material and all rate constants for condensation are assumed to be independent of the precursor, T is assumed to be independent of process conditions. Small values of T can lead to more porous and higher surface area materials.

1. Solvent Index (W)

During the drying step, it may be expected that near-equilibrium may be achieved between hydrolyzable terminal groups and hydrolyzable bridging groups as in equation 16. As the amount of solvent (here represented as purely water) decreases, the equilibrium can shift to the right. When there is still a large amount of water present, the system, at equilibrium, could be in a floppy state. It is desirable not only that the system quickly forms a minimally rigid network, but that it do so and remain so when there is still a large amount of solvent remaining. This is desirable for the solvent to swell the network leading to a large bulk volume and (if the network remains rigid preventing collapse) to a solid with high porosity. If a system A forms and keeps a rigid network at a solvent level higher than a different system B, the A system should yield the higher porosity solid after complete drying.

Equilibrium in the reversible condensation reaction (eqn. 16) can be expressed via the equilibrium constant, K, as follows:

$$K = \frac{[ ROR ] [ {H}_{2} O ]}{{[ ROH ]}^{2}} . \qquad 21$$

Dividing the numerator and denominator by the square of the number of central groups (M²), using w=[H₂O]/M, and using the definitions of τ_{c} and βₕ=number of hydrolyzable bridging groups per central group, results in:

$$w = \frac{K {τ}_{c}^{2}}{{β}_{h}} . \qquad 22$$

An index comparing the system of interest to that of a reference (i.e., TEOS) can be formed. Assuming that rates are uniform in the system such that the equilibrium constants are the same for all levels of condensation in both the system and the reference provides:

$$W = \frac{{w}^{*}}{{w}_{TEOS}^{*}} = ( \frac{{τ}_{c}^{* 2} / {β}_{h}^{*}}{{τ}_{cT}^{* 2} / {β}_{hT}^{*}} ) . \qquad 23$$

For TEOS, the number of bridging groups per central group at the transition is 3/2 as calculated via equation 20. Combining this with τ_{cT}* from the above discussion, provides a solvent index (W):

$$W = \frac{{w}^{*}}{{w}_{TEOS}^{*}} = \frac{3}{2} ( {τ}_{c}^{* 2} / {β}_{h}^{*} ) . \qquad I$$

Where τ_{c}* represents the number of hydrolyzable terminal groups remaining per silicon atom at a rigidity transition; and β*ₕ represents the number of hydrolyzable bridging groups per silicon atom at the rigidity transition. The above solvent index is a measure of the relative amount of solvent (e.g., water) which can be present and have the system at the rigidity transition while also being at equilibrium. For TEOS, W=1. Systems with W>˜1 can have more solvent present and still be rigid, leading to higher porosity and surface area.

2. Kinetic Index (T)

In the sol-gel synthesis of porous materials from precursors, the precursor molecules can be hydrolyzed (e.g., Si—OEt—Si→OH) before the silanols begin to condense via equation 16. The hydrolysis reaction can occur over some time and can often be catalyzed by acid or base. Under some conditions, the reaction can proceed primarily in the forward direction, and under other conditions it can largely be reversible. Often at a later stage, the solvent can be driven off via evaporation and/or the application of elevated temperature and/or vacuum. In order for a mesoporous solid to form in this process, a network of the precursor molecules can advantageously first form (here we ignore particle formation and agglomeration) and the network can advantageously be able to maintain porosity under the stresses imposed by solvent removal.

If the network forms slowly so that it never reaches a minimally rigid state before the solvent is removed, the network can typically collapse and a porous solid will not be obtained. For making a porous material then, it is useful for the network to form relatively quickly. Consider the condensation reaction at early stages proceeding only in the forward direction:

2Si—OH→Si—O—Si+H₂O 24.

The condensation of silanol groups is important in many applications, but other reactions which form bridging groups from terminal groups can be contemplated in the same way, and —OH can alternatively represent any group that is hydrolyzable under the conditions of the synthesis. The number of such groups per central group is denoted τ_{c}. If any non-hydrolyzable terminal groups are present (e.g., —CH₃), they may be denoted τ_{c} so that the total number of terminal groups is τ=τ_{c}+τ_{nc}.

According to the mass-action law applied to the above reaction, the terminal groups can condense at some rate d(OH)/dt=−k(OH)²; dividing by the number of central groups, we have dτ_{c}/d(Mkt)=−τ₀² for which the solution is (Mkt)=1/τ_{c}−1/τ_{0c}, where τ₀ is the initial τ. The rigidity transition is reached when enough condensation has occurred: (Mkt)*=1/τ_{c}*−1/τ_{0c}.

Thus, an index related to the time to the rigidity transformation may be defined by dividing Mkt for a material of interest by the same factor for a known material, TEOS, which, when completely hydrolyzed, forms Si(OH)₄ in solution. They can be compared at the same overall number of central groups (e.g., Si atoms or other entities within rigid sub-units), M=M_{TEOS}. Assuming for the purpose of devising a useful descriptor, the reactions proceed at the same rate, independent of species or the number of silanols on a particular group so that the same rate constant applies to every condensation reaction for every species:

$$\frac{{( Mkt )}^{*}}{{( Mkt )}_{Si ( OH ) 4}^{*}} = \frac{{t}^{*}}{{t}_{Si ( OH ) 4}^{*}} = \frac{\frac{1}{{τ}_{c}^{*}} - \frac{1}{{τ}_{c 0}}}{\frac{1}{{τ}_{cT}^{*}} - \frac{1}{{τ}_{c 0 T}}} . \qquad 25$$

Using the analysis for the rigidity transition, it can be shown that a system of connected SiO₄ tetrahedra, starting from hydrolyzed Si(OH)₄ units, can have τ_{cT}*=1 (one free OH at the rigidity transition) and τ_{0cT}=4 (4 free OH after the initial hydrolysis of the precursor). The above expression can become

$$T = \frac{{t}^{*}}{{t}_{Si ( OH ) 4}^{*}} = \frac{4}{3} ( \frac{1}{{τ}_{c}^{*}} - \frac{1}{{τ}_{c 0}} ) . \qquad II$$

thereby defining a kinetic index (T) where τ*_{c} represents the number of hydrolyzable terminal groups remaining per silicon atom at a rigidity transition; and τ_{c0} represents the initial number of hydrolyzable terminal groups per silicon atom. When the hydrolyzable terminal group remaining per silicon atom at a rigidity transition comprises three or more linear carbon atoms, the middle carbon atom may be treated as a silicon atom for purposes of calculating τ*_{c}. Additionally or alternately, for the purposes of calculating T and W, terminal groups can be assumed to all behave the same and may be treated as methyl groups, each having one connection to a central group or silicon atom; for bridging groups, if they themselves are rigid according to the rigidity index (h>=0), they can be treated the same as a bridging methylene, whereas, if they are non rigid (h<0), they can be treated as two terminal groups, one belonging to each central or silicon atom.

The above ratio can provide an index which can be used as a guide in selecting precursors that can form mesoporous solids; they can typically have small values of the ratio. For TEOS, T=1, as it is the reference material.

TABLE 1

| Symbol/Word/ | |
|---|---|
| Abbreviation | Definition |
| Vertex | A place on an object where it may connect to other objects. In this work, vertexes |
| | represent either bridging oxygen, bridging methylene, or terminal hydroxyl or methyl |
| Joint | A connection between 2 or more objects, created by merging 2 or more vertexes |
| Network | A collection of objects |
| V | The number of vertexes on an object or the average number in a collection of objects |
| M | The number of objects in a collection |
| N | The number of joints in a collection |
| C | The connectivity of a joint (the average number of objects connected by a joint) or the |
| | average connectivity of the joints in a collection |
| d.o.f. | The number of degrees of freedom (of movement) for an object or collection of |
| | objects; usually d translational and d rotational degrees of freedom in a d dimensional space |
| structural | The internal degrees of freedom of a collection of objects; the total d.o.f. minus the |
| d.o.f. | d.o.f. of the collection taken as a rigid object itself |
| F = Net d.o.f. | The structural d.o.f. minus the constraints present in the system |
| nₜ | The number of translational degrees of freedom of an object (usually = 3) |
| nᵣ | The number of rotational degrees of freedom of an object (usually = 3) |
| n_{□} | The number of angle constraints imposed at a vertex |
| □_{T} | The total degrees of freedom of a collection or network when considered as a rigid |
| | object itself; usually □_{T} = 6 in 3 dimensions. |
| superscript □□ | Used to denote the properties of a network at the rigidity transition; e.g. C* is the |
| | average connectivity at the transition |
| h | Hardness index; h = C − C* |
| x₁ | The fraction of joints that are one-fold coordinated or are connected to only one |
| | object-they are unconnected vertexes |
| central group | In this work, each central group is associated with a silicon atom. Central groups are |
| | either rigid objects themselves or are rigid subunits within a collective object that |
| | might represent a precursor molecule. Part of their function is to render the ratios |
| | defined below “per silicon atom” which is approximately “per volume” |
| □ | The number of terminal groups per central group for an object or collection |
| □ | The number of bridging groups per central group for a compound object or collection |
| S | The total number of joints per central group |
| n | An index of reaction for condensation from hydrolyzed precursors |
| subscript 0 | Used to denote the initial condition; a collection of unconnected objects |
| subscript c | used to refer to hydrolyzable terminal groups (—OH, not —CH₃) that (after hydrolysis) |
| | can undergo condensation reactions |
| subscript h | Hydrolyzable-used to refer to bridging groups that can be hydrolyzed |
| | (—O—, not —CH₂—) |
| T | The time or kinetic index; defined in equation 23. T indicates the amount of time that a |
| | system requires to reach rigidity-relative to a TEOS system |
| W | The “water” or solvent index; defined in equation 27. W indicates the amount of |
| | solvent remaining in the system during drying at which the network can be rigid under |
| | equilibrium conditions-relative to a TEOS system |
| subscript T | Stands for TEOS, the reference system for the T & W indexes |

### III. Methods of Identifying Precursors for Producing Organosilica Materials

Thus, in one embodiment, this invention relates to methods for identifying precursors for producing an organosilica material, the method comprising: using the following solvent index (W) equation (I):

W=3/2(τ*_{c}²/β*ₕ) (I)

wherein τ*_{c} represents the number of hydrolyzable terminal groups remaining per silicon atom at a rigidity transition; and β*ₕ represents the number of hydrolyzable bridging groups per silicon atom at the rigidity transition; and the following kinetic index (T) equation (II):

$$T = \frac{4}{3} ( \frac{1}{{τ}_{c}^{*}} - \frac{1}{{τ}_{c 0}} ) \qquad ( II )$$

wherein τ_{c0} represents the initial number of hydrolyzable terminal groups per silicon atom; to determine a result. In particular, at least one silicon-containing compound, as further described below, may be selected and the number of hydrolyzable terminal groups remaining per silicon atom at a rigidity transition (τ*_{c}), the number of hydrolyzable bridging (β*ₕ), and the initial number of hydrolyzable terminal groups per silicon atom (τ_{c0}) may be determined for the selected silicon-containing compound and inputted into equation to (I) and equation (II) to determine a result.

In various aspects, the result determined may be that the selected silicon-containing compound satisfies the condition that W can be greater than 1.0 and/or T is greater than zero and less than 1.0. Such a silicon-containing compound that satisfies the aforementioned conditions for W and/or T may then be used to prepare an organosilica material as further described below by the same or different party. For example, the determined result may be transmitted to another party and, optionally, the another party may use the determined at least one silicon-containing compound that satisfies the condition that W can be greater than 1.0 and/or T is greater than zero and less than 1.0 in a method to prepare an organosilica material.

Additionally or alternatively, the at least one silicon-containing compound may have a W of greater than or equal to about 2.0, greater than or equal to about 5.0, greater than or equal to about 7.0, greater than or equal to about 10, greater than or equal to about 12, greater than or equal to about 15, greater than or equal to about 17, greater than or equal to about 20, greater than or equal to about 22, greater than or equal to about 25, greater than or equal to about 27, or greater than or equal to about 30.

Additionally or alternatively, the at least one silicon-containing compound may have a W of less than or equal to about 32, less than or equal to about 30, less than or equal to about 27, less than or equal to about 25, less than or equal to about 22, less than or equal to about 20, less than or equal to about 17, less than or equal to about 15, less than or equal to about 12, less than or equal to about 10, less than or equal to about 7.0, or less than or equal to about 5.0.

Additionally or alternatively, the at least one silicon-containing compound may have a W of about 1.0 to about 32, about 1.0 to about 30, about 1.0 to about 27, about 1.0 to about 25, about 1.0 to about 22, about 1.0 to about 20, about 1.0 to about 17, about 1.0 to about 15, about 1.0 to about 12, about 1.0 to about 10, about 1.0 to about 7.0, about 1.0 to about 5.0, about 1.0 to about 3.0, about 3.0 to about 32, about 3.0 to about 30, about 3.0 to about 27, about 3.0 to about 25, about 3.0 to about 22, about 3.0 to about 20, about 3.0 to about 17, about 3.0 to about 15, about 3.0 to about 12, about 3.0 to about 10, about 3.0 to about 7.0, about 3.0 to about 5.0, about 5.0 to about 32, about 5.0 to about 30, about 5.0 to about 27, about 5.0 to about 25, about 5.0 to about 22, about 5.0 to about 20, about 5.0 to about 17, about 5.0 to about 15, about 5.0 to about 12, about 5.0 to about 10, about 5.0 to about 7.0, about 10 to about 32, about 10 to about 30, about 10 to about 27, about 10 to about 25, about 10 to about 22, about 10 to about 20, about 10 to about 17, about 10 to about 15, about 10 to about 12, about 15 to about 32, about 15 to about 30, about 15 to about 27, about 15 to about 25, about 15 to about 22, about 15 to about 20, about 15 to about 17, about 17 to about 32, about 17 to about 30, about 17 to about 27, about 17 to about 25, about 17 to about 22, about 17 to about 20, or about 20 to about 32. In particular, the at least one silicon-containing compound may have a W of about 1.0 to about 32, about 1.0 to about 25, about 1.0 to about 20 or about 1.0 to about 15.

Additionally or alternatively, the at least one silicon-containing compound may have a T of greater than zero, greater than or equal to about 0.10, greater than or equal to about 0.20, greater than or equal to about 0.30, greater than or equal to about 0.40, greater than or equal to about 0.50, greater than or equal to about 0.60, greater than or equal to about 0.70, greater than or equal to about 0.80, or greater than or equal to about 0.90 or about 1.0.

Additionally or alternatively, the at least one silicon-containing compound may have a T of less than about 1.0, less than or equal to about 0.90, less than or equal to about 0.80, less than or equal to about 0.70, less than or equal to about 0.60, less than or equal to about 0.50, less than or equal to about 0.40, less than or equal to about 0.30, less than or equal to about 0.20 or less than or equal to about 0.10.

Additionally or alternatively, the at least one silicon-containing compound may have a T of greater than zero to about 0.90, greater than zero to about 0.80, greater than zero to about 0.70, greater than zero to about 0.60, greater than zero to about 0.50, greater than zero to about 0.40, greater than zero to about 0.30, greater than zero to about 0.20, greater than zero to about 0.10, about 0.10 to less than about 1.0, about 0.10 to about 0.9, about 0.10 to about 0.8, about 0.10 to about 0.7, about 0.10 to about 0.6, about 0.10 to about 0.5, about 0.10 to about 0.4, about 0.10 to about 0.30, about 0.10 to about 0.20, about 0.20 to less than about 1.0, about 0.20 to about 0.90, about 0.20 to about 0.8, about 0.20 to about 0.70, about 0.20 to about 0.6, about 0.20 to about 0.50, about 0.20 to about 0.40, about 0.20 to about 0.30, about 0.30 to less than about 1.0, about 0.30 to about 0.9, about 0.30 to about 0.8, about 0.30 to about 0.70, about 0.30 to about 0.60, about 0.30 to about 0.50, about 0.30 to about 0.40, about 0.40 to less than about 1.0, about 0.40 to about 0.90, about 0.40 to about 0.80, about 0.40 to about 0.70, about 0.40 to about 0.60, about 0.40 to about 0.50, about 0.50 to less than about 1.0, about 0.50 to about 0.90, about 0.50 to about 0.80, about 0.50 to about 0.70, about 0.50 to about 0.60, about 0.60 to less than about 1.0, about 0.60 to about 0.90, about 0.60 to about 0.80, about 0.60 to about 0.70, about 0.70 to less than about 1.0, about 0.70 to about 0.90, about 0.70 to about 0.80, about 0.80 to less than about 1.0, about 0.80 to about 0.90 or about 0.90 to less than about 1.0. In particular, the at least one silicon-containing compound may have a T of greater than zero to less than about 1.0, greater than zero to about 0.90 or about 0.10 to less than 1.0.

III.A. Silicon-Containing Compound Precursors

In various aspects, the at least one silicon-containing compound may comprise independent [SiX₄]ₙ units, wherein each X may be independently selected from the group consisting of a hydrolyzable group bonded to a silicon atom of another SiX₄ unit, a non-hydrolyzable group bonded to a silicon atom of another SiX₄ unit, a non-hydrolyzable terminal group, and a hydrolyzable terminal group; with the proviso that at least one X is a hydrolyzable terminal group; and n is 1.0 to 1000.

As used herein, and unless otherwise specified, “a hydrolyzable group bonded to a silicon atom of another SiX₄ unit” and “a non-hydrolyzable group bonded to a silicon atom of another SiX₄ unit,” means that the hydrolyzable group and the non-hydrolyzable group can advantageously displace a moiety (particularly an oxygen-containing moiety such as a hydroxyl, an alkoxy or the like), if present, on a silicon atom of another SiX₄ unit so the hydrolyzable group and the non-hydrolyzable group may be bonded directly to the silicon atom of another SiX₄ thereby connecting the two SiX₄ units, e.g., via a Si—O—Si linkage. For clarity, in this bonding scenario, the “another SiX₄ unit” can be a SiX₄ unit of the same type or a SiX₄ unit of a different type.

Additionally or alternatively, n can be from 1.0 to 1500, 1.0 to 1200, 1.0 to 1000, 1.0 to 900, 1.0 to 800, 1.0 to 700, 1.0 to 600, 1.0 to 500, 1.0 to 400, 1.0 to 300, 1.0 to 200, 1.0 to 100, 1.0 to 50, 1.0 to 25, 1.0 to 20, 1.0 to 10, 10 to 1500, 10 to 1200, 10 to 1000, 10 to 900, 10 to 800, 10 to 700, 10 to 600, 10 to 500, 10 to 400, 10 to 300, 10 to 200, 10 to 100, 10 to 50, 10 to 25, 10 to 20, 50 to 1500, 50 to 1200, 50 to 1000, 50 to 900, 50 to 800, 50 to 500, 50 to 600, 50 to 500, 50 to 400, 50 to 300, 50 to 200, 50 to 100, 100 to 1500, 100 to 1200, 100 to 1000, 100 to 900, 100 to 800, 100 to 700, 100 to 600, 100 to 500, 100 to 400, 100 to 300, 100 to 200, 500 to 1500, 500 to 1200, 500 to 1000, 500 to 900, 500 to 800, 500 to 700 or 500 to 600. In particular, n can be from 1.0 to 1500, 1.0 to 1000, 1.0 to 500 or 1.0 to 300.

Additionally or alternatively, the hydrolyzable group bonded to a silicon atom of another SiX₄ unit may be selected from the group consisting of an oxygen atom, a halogen substituted alkylene, a nitrogen-containing alkylene group, —O—R¹—, and —R²—O—R³—, wherein R¹, R² and R³ may each independently be an alkylene group or an arylene group.

Additionally or alternatively, the hydrolyzable group bonded to a silicon atom of another SiX₄ unit may be an oxygen atom.

Additionally or alternatively, the hydrolyzable group bonded to a silicon atom of another SiX₄ unit may be a halogen substituted C₁-C₂₀ alkylene group, a halogen substituted C₁-C₁₀ alkylene group, a halogen substituted C₁-C₈ alkylene group, a halogen substituted C₁-C₇ alkylene group, a halogen substituted C₁-C₆ alkylene group, a halogen substituted C₁-C₅ alkylene group, a halogen substituted C₁-C₄ alkylene group, a halogen substituted C₁-C₃ alkylene group, a halogen substituted C C₂ alkylene group, or a halogen substituted C₁ alkylene group. The halogen may be F, Cl, Br and/or I. The hydrogen atoms of the alkylene group may be substituted with one or more halogen atoms, which may be the same or different. Examples of suitable alkylenes substituted with a halogen atom can include, but are not limited to, —CZ₂—, —(CH₂)ₘ(CZ₂)ₚ—, wherein m is 1 to 20, p is 1 to 20 and Z is F, Cl, Br or I.

Additionally or alternatively, the hydrolyzable group bonded to a silicon atom of another SiX₄ unit may be a nitrogen-containing C₁-C₂₀ alkylene group, a nitrogen-containing C₂-C₂₀ alkylene group, nitrogen-containing C₁-C₁₀ alkylene group, a nitrogen-containing C₂-C₁₀ alkylene group, a nitrogen-containing C₃-C₁₀ alkylene group, a nitrogen-containing C₄-C₁₀ alkylene group, a nitrogen-containing C₄-C₉ alkylene group, a nitrogen-containing C₄-C₈ alkylene group, or nitrogen-containing C₃-C₈ alkylene group.

Additionally or alternatively, the hydrolyzable group bonded to a silicon atom of another SiX₄ unit may be —O—R¹—, wherein R¹ may be an alkylene group or an arylene group.

R¹ may be a C₁-C₂₀ alkylene group, a C₁-C₁₀ alkylene group, a C₁-C₈ alkylene group, a C₁-C₇ alkylene group, a C₁-C₆ alkylene group, a C₁-C₅ alkylene group, a C₁-C₄ alkylene group, a C₁-C₃ alkylene group, a C₁-C₂ alkylene group, or —CH²—.

Additionally or alternatively, R¹ may be a C₄-C₁₄ arylene, a C₆-C₁₄ arylene, or a C₆-C₁₀ arylene. Examples of suitable arylenes include, but are not limited to 1,2-phenylene, 1,3-phenylene, 1,4-phenylene, and 1,2-naphthylene.

Additionally or alternatively, the hydrolyzable group bonded to a silicon atom of another SiX₄ unit may be —R²—O—R³—, wherein R² and R³ may each independently be an alkylene group or an arylene group. R² and R³ may each independently be C₁-C₂₀ alkylene group, a C₁-C₁₀ alkylene group, a C₁-C₈ alkylene group, a C₁-C₇ alkylene group, a C₁-C₆ alkylene group, a C₁-C₅ alkylene group, a C₁-C₄ alkylene group, a C₁-C₃ alkylene group, a C₁-C₂ alkylene group, or —CH²—.

Additionally or alternatively, R² and R³ may each independently be a C₄-C₁₄ arylene, a C₆-C₁₄ arylene, or a C₆-C₁₀ arylene, Examples of suitable arylenes include, but are not limited to 1,2-phenylene, 1,3-phenylene, 1,4-phenylene, and 1,2-naphthylene.

In one particular embodiment, the hydrolyzable group bonded to a silicon atom of another SiX₄ unit may be selected from the group consisting of an oxygen atom, a halogen substituted C₁-C₂₀ alkylene, a nitrogen-containing C₁-C₂₀ alkylene group, and —R²—O—R³—, wherein R¹, R² and R³ may each independently be a C₁-C₂₀ alkylene group or C₄-C₁₄ arylene group.

In another particular embodiment, the hydrolyzable group bonded to a silicon atom of another SiX₄ unit may be selected from the group consisting of an oxygen atom, a halogen substituted C₁-C₁₀ alkylene, a nitrogen-containing C₁-C₁₀ alkylene group, and —R²—O—R³—, wherein R¹, R² and R³ may each independently be a C₁-C₁₀ alkylene group or C₆-C₁₄ arylene group.

Additionally or alternative, the non-hydrolyzable group bonded to a silicon atom of another SiX₄ unit may be selected from the group consisting of an alkylene group, an alkenylene group, an alkynylene group, and an arylene group.

Additionally or alternatively, the non-hydrolyzable group bonded to a silicon atom of another SiX₄ unit may be C₁-C₂₀ alkylene group, a C₁-C₁₀ alkylene group, a C₁-C₈ alkylene group, a C₁-C₇ alkylene group, a C₁-C₆ alkylene group, a C₁-C₅ alkylene group, a C₁-C₄ alkylene group, a C₁-C₃ alkylene group, a C₁-C₂ alkylene group, or —CH²—.

Additionally or alternatively, the non-hydrolyzable group bonded to a silicon atom of another SiX₄ unit may be a C₂-C₂₀ alkenylene group, a C₂-C₁₀ alkenylene group, a C₂-C₈ alkenylene group, a C₂-C₇ alkenylene group, a C₂-C₆ alkenylene group, a C₂-C₅ alkenylene group, a C₂-C₄ alkenylene group, a C₂-C₃ alkenylene group, or —H—C═CH—.

Additionally or alternatively, the non-hydrolyzable group bonded to a silicon atom of another SiX₄ unit may be a C₂-C₂₀ alkynylene group, a C₂-C₁₀ alkynylene group, a C₂-C₈ alkynylene group, a C₂-C₇ alkynylene group, a C₂-C₆ alkynylene group, a C₂-C₅ alkynylene group, a C₂-C₄ alkynylene group, a C₂-C₃ alkynylene group, or

Additionally or alternatively, the non-hydrolyzable group bonded to a silicon atom of another SiX₄ unit may be a C₄-C₁₄ arylene group, a C₆-C₁₄ arylene group, or a C₆-C₁₀ arylene group. Examples of suitable arylenes include, but are not limited to 1,2-phenylene, 1,3-phenylene, 1,4-phenylene, and 1,2-naphthylene.

In one particular embodiment, the non-hydrolyzable group bonded to a silicon atom of another SiX₄ unit may be selected from the group consisting of a C₁-C₂₀ alkylene group, a C₂-C₂₀ alkenylene group, a C₂-C₂₀ alkynylene group, and a C₄-C₁₄ arylene group.

In another particular embodiment, the non-hydrolyzable group bonded to a silicon atom of another SiX₄ unit may be selected from the group consisting of a C₁-C₁₀ alkylene group, a C₂-C₁₀ alkenylene group, a C₂-C₁₀ alkynylene group, and a C₆-C₁₄ arylene group.

Additionally or alternatively, the non-hydrolyzable terminal group may be selected from the group consisting of an alkyl group, an alkenyl group, an alkynyl group, and an aryl group. Additionally or alternatively, under certain conditions, the non-hydrolyzable terminal group may be a halide, e.g., F, Cl, Br, or I.

Additionally or alternatively, the non-hydrolyzable terminal group may be a C₁-C₂₀ alkyl group, a C₁-C₁₀ alkyl group, a C₁-C₈ alkyl group, a C₁-C₇ alkyl group, a

C₁-C₆ alkyl group, a C₁-C₅ alkyl group, a C₁-C₄ alkyl group, a C₁-C₃ alkyl group, a C C₂ alkyl group, or methyl.

Additionally or alternatively, the non-hydrolyzable terminal group may be a C₂-C₂₀ alkenyl group, a C₂-C₁₀ alkenyl group, a C₂-C₈ alkenyl group, a C₂-C₇ alkenyl group, a C₂-C₆ alkenyl group, a C₂-C₅ alkenyl group, a C₂-C₄ alkenyl group, a C₂-C₃ alkenyl group, or ethenyl.

Additionally or alternatively, the non-hydrolyzable terminal group may be a C₂-C₂₀ alkynyl group, a C₂-C₁₀ alkynyl group, a C₂-C₈ alkynyl group, a C₂-C₇ alkynyl group, a C₂-C₆ alkynyl group, a C₂-C₅ alkynyl group, a C₂-C₄ alkynyl group, a C₂-C₃ alkynyl group, or ethynyl.

Additionally or alternatively, the non-hydrolyzable terminal group may be a C₄-C₁₄ aryl group, a C₆-C₁₄ aryl group, or a C₆-C₁₀ aryl group.

In one particular embodiment, the non-hydrolyzable terminal group may be selected from the group consisting of a C₁-C₂₀ alkyl group, a C₂-C₂₀ alkenyl group, a C₂-C₂₀ alkynyl group, and a C₄-C₁₄ aryl group.

In another particular embodiment, the non-hydrolyzable terminal group may be selected from the group consisting of a C₁-C₁₀ alkyl group, a C₂-C₁₀ alkenyl group, a C₂-C₁₀ alkynyl group, and a C₆-C₁₄ aryl group.

Additionally or alternatively, the hydrolyzable terminal group may be selected from the group consisting of an alkoxy group, an acyloxy group, an arylalkoxy group, a hydroxyl group, a haloalkyl group, a halide, an amino group, and an aminoalkyl group.

Additionally or alternatively, the hydrolyzable terminal group may be C₁-C₂₀ alkoxy group, a C₁-C₁₀ alkoxy group, a C₁-C₈ alkoxy group, a C₁-C₇ alkoxy group, a C₁-C₆ alkoxy group, a C₁-C₅ alkoxy group, a C₁-C₄ alkoxy group, a C₁-C₃ alkoxy group, a C₁-C₂ alkoxy group, or methoxy.

Additionally or alternatively, the hydrolyzable terminal group may be an acyloxy group represented by the formula, —O—C(O)R⁴, wherein R⁴ may be hydrogen, alkyl, alkenyl, alkynyl, aryl, aralkyl, or a combination thereof.

Additionally or alternatively, R⁴ may be hydrogen.

Additionally or alternatively, R⁴ may be a C₁-C₂₀ alkyl group, a C₁-C₁₀ alkyl group, a C₁-C₈ alkyl group, a C₁-C₇ alkyl group, a C₁-C₆ alkyl group, a C₁-C₅ alkyl group, a C₁-C₄ alkyl group, a C₁-C₃ alkyl group, a C₁-C₂ alkyl group, or methyl.

Additionally or alternatively, R⁴ may be a C₂-C₂₀ alkenyl group, a C₂-C₁₀ alkenyl group, a C₂-C₈ alkenyl group, a C₂-C₇ alkenyl group, a C₂-C₆ alkenyl group, a C₂-C₅ alkenyl group, a C₂-C₄ alkenyl group, a C₂-C₃ alkenyl group, or ethenyl.

Additionally or alternatively, R⁴ may be a C₂-C₂₀ alkynyl group, a C₂-C₁₀ alkynyl group, a C₂-C₈ alkynyl group, a C₂-C₇ alkynyl group, a C₂-C₆ alkynyl group, a C₂-C₅ alkynyl group, a C₂-C₄ alkynyl group, a C₂-C₃ alkynyl group, or ethynyl.

Additionally or alternatively, R⁴ may be a C₄-C₁₄ aryl group, a C₆-C₁₄ aryl group, or a C₆-C₁₀ aryl group.

Additionally or alternatively, R⁴ may be an aralkyl comprising a C₁-C₂₀ alkyl group substituted with a C₄-C₁₄ aryl group, particularly a C₁-C₁₀ alkyl group substituted with a C₆-C₁₄ aryl group. Examples of suitable aralkyl groups include, but are not limited to phenylmethyl, phenylethyl, and naphthylmethyl.

Additionally or alternatively, R⁴ may be may be selected from the group consisting of a C₁-C₂₀ alkyl group, a C₂-C₂₀ alkenyl group, a C₂-C₂₀ alkynyl group, a C₄-C₁₄ aryl group and a C₁-C₂₀ alkyl group substituted with a C₄-C₁₄ aryl group.

Additionally or alternatively, the hydrolyzable terminal group may be an arylalkoxy group comprising a C₄-C₁₄ aryl group attached to a C₁-C₂₀ alkoxy, particularly a C₆-C₁₄ aryl group attached to a C₁-C₁₀ alkoxy. Examples of suitable arylalkoxy groups include, but are not limited to, 2-phenylethoxy, 3-naphth-2-ylpropoxy, and 5-phenylpentyloxy.

Additionally or alternatively, the hydrolyzable terminal group may be a hydroxyl group.

Additionally or alternatively, the hydrolyzable terminal group may be a C₁-C₂₀ haloalkyl group, a C₁-C₁₀ haloalkyl group, a C₁-C₈ haloalkyl group, a C₁-C₇ haloalkyl group, a C₁-C₆ haloalkyl group, a C₁-C₅ haloalkyl group, a C₁-C₄ haloalkyl group, a C₁-C₃ haloalkyl group, a C₁-C₂ haloalkyl group, or halomethyl group. Additionally or alternatively, the haloalkyl may be represented by the formula, —CZₘ, wherein m is 1 to 3 each Z is independently F, Cl, Br or I; or by the formula, —(CH₂)ₚ(CZ₂)_{q}CZ₃, wherein p is zero to 20, q is zero to 20 and each Z is independently F, Cl, Br or I.

Additionally or alternatively, the hydrolyzable terminal group may be a halide selected from the group consisting of F, Cl, Br and I.

Additionally or alternatively, the hydrolyzable terminal group may be an amino group (e.g., NH₂).

Additionally or alternatively, the hydrolyzable terminal group may be an aminoalkyl. Examples of suitable aminoalkyls include, but are not limited to aminomethyl, aminoethyl, aminopropyl, aminoisopropyl, aminobutyl, aminopentyl, aminohexyl, and aminooctyl.

In one particular embodiment, the hydrolyzable terminal group may be selected from the group consisting of a C₁-C₂₀ alkoxy group; an acyloxy group represented by the formula, —O—C(O)R⁴, wherein R⁴ may be hydrogen, alkyl, alkenyl, alkynyl, aryl, aralkyl, or a combination thereof; an arylalkoxy group comprising a C₄-C₁₄ aryl group attached to a C₁-C₂₀ alkoxy; a hydroxyl group; a C₁-C₂₀ haloalkyl group, a halide (e.g. F, Cl, Br, I), an amino group (e.g., NH₂), and aminoalkyl (e.g., aminomethyl, aminoethyl, aminopropyl, aminoisopropyl, aminobutyl, aminopentyl, aminohexyl, aminooctyl).

In another particular embodiment, the hydrolyzable terminal group may be selected from the group consisting of a C₁-C₁₀ alkoxy group; an acyloxy group represented by the formula, —O—C(O)R⁴, wherein R⁴ may be hydrogen, a C₁-C₁₀ alkyl, a C₂-C₁₀ alkenyl, a C₂-C₁₀ alkynyl, a C₆-C₁₄ aryl, aralkyl comprising a C₁-C₁₀ alkyl group substituted with a C₆-C₁₄ aryl group, or a combination thereof; an arylalkoxy group comprising a C₆-C₁₄ aryl group attached to a C₁-C₁₀ alkoxy; a hydroxyl group; a C₁-C₁₀ haloalkyl group, a halide (e.g. F, Cl, Br, I), an amino group (e.g., NH₂), and aminoalkyl (e.g., aminomethyl, aminoethyl, aminopropyl, aminoisopropyl, aminobutyl, aminopentyl, aminohexyl, aminooctyl).

Additionally or alternatively, the at least one silicon-containing compound is not 1,1,3,3,5,5-hexaethoxy-1,3,5-trisilacyclohexane, bis(triethoxysilyl)methane and 1,2-bis(triethoxysilyl)ethylene.

Additionally or alternatively, the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxysilane, (N,N-dimethylaminopropyl)trimethoxysilane, (N-(2-aminoethyl)-3-aminopropyltriethoxysilane ((H₂N(CH₂)₂NH(CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, and bis[(methyldimethoxysilyl)propyl]-N-methylamine, tris(3-trimethoxysilylpropyl)isocyanurate.

### IV. Methods of Making Organosilica Materials

In another embodiment, a method for preparing an organosilica material is provided. The method may comprise:

(a) using the following solvent index (W) equation (I):

W=3/2(τ*_{c}²/β*ₕ) (I)

wherein
τ*_{c} represents the number of hydrolyzable terminal groups remaining per silicon atom at a rigidity transition; and
β*ₕ represents the number of hydrolyzable bridging groups per silicon atom at the rigidity transition; and
the following kinetic index (T) equation (II):

$$T = \frac{4}{3} ( \frac{1}{{τ}_{c}^{*}} - \frac{1}{{τ}_{c 0}} ) \qquad ( II )$$

wherein
   τ_{c0} represents the initial number of hydrolyzable terminal groups per silicon atom;

to determine at least one silicon-containing compound as described herein that satisfies the condition that W is greater than 1.0 as described herein;

(b) adding the at least one silicon containing compound as described herein to an aqueous mixture that contains essentially no structure directing agent and/or porogen, to form a solution;

(c) aging the solution to produce a pre-product; and

(d) drying the pre-product to obtain an organosilica material which is a polymer comprising independent siloxane units.

In another embodiment, a further method for preparing an organosilica material is provided. The method may comprise:

(a) adding at least one silicon-containing compound as described herein into an aqueous mixture that contains essentially no structure directing agent and/or porogen to form a solution, wherein the at least one silicon-containing compound has a solvent index (W) of greater than about 1.0 as described herein;

(b) aging the solution to produce a pre-product; and

(c) drying the pre-product to obtain an organosilica material which is a polymer comprising independent siloxane units.

Additionally or alternatively, the at least one silicon containing compound may have a kinetic index (T) as described herein, particularly a kinetic index (T) of greater than zero and less than about 1.0.

Additionally or alternatively, the at least one silicon containing compound may have a solvent index (W) as described herein, particularly a solvent index (W) of between about 1.0 and about 20.

Additionally or alternatively, the at least one silicon containing compound may comprise independent [SiX₄]ₙ units as described herein. In particular, each X may be independently selected from the group consisting of a hydrolyzable group bonded to a silicon atom of another SiX₄ unit as described herein, a non-hydrolyzable group bonded to a silicon atom of another SiX₄ unit as described herein, a non-hydrolyzable terminal group as described herein, and a hydrolyzable terminal group as described herein; with the proviso that at least one X is a hydrolyzable terminal group; and n is 1 to 1000 as described herein.

In a particular embodiment, the hydrolyzable group bonded to a silicon atom of another SiX₄ unit may be selected from the group consisting of an oxygen atom, a halogen substituted alkylene as described herein, a nitrogen-containing alkylene group as described herein, —O—R¹—, and —R²—O—R³—, wherein R² and R³ are each independently an alkylene group as described herein or an arylene group as described herein.

In another particular embodiment, the non-hydrolyzable group bonded to a silicon atom of another SiX₄ unit may be selected from the group consisting of an alkylene group as described herein, an alkenylene group as described herein, an alkynylene group as described herein, and an arylene group as described herein.

In another particular embodiment, the non-hydrolyzable terminal group may be selected from the group consisting of an alkyl group as described herein, an alkenyl group as described herein, an alkynyl group as described herein, and an aryl group as described herein.

In another particular embodiment, the hydrolyzable terminal group may be selected from the group consisting of an alkoxy group as described herein, an acyloxy group as described herein, an arylalkoxy group as described herein, a hydroxyl group as described herein, a haloalkyl group as described herein, a halide as described herein, an amino group as described herein, and an aminoalkyl group as described herein.

Additionally or alternatively, the at least one silicon-containing compound is not 1,1,3,3,5,5-hexaethoxy-1,3,5-trisilacyclohexane, bis(triethoxysilyl)methane or 1,2-bis(triethoxysilyl)ethylene.

Additionally or alternatively, the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxy silane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, and bis[(methyldimethoxysilyl)propyl]-N-methylamine, tris(3-trimethoxysilylpropyl)isocyanurate.

IV.A. Aqueous Mixture

The organosilica materials described herein may be made using essentially no structure directing agent or porogen. Thus, the aqueous mixture contains essentially no added structure directing agent and/or no added porogen.

As used herein, “no added structure directing agent,” and “no added porogen” means either (i) there is no component present in the synthesis of the organosilica material that aids in and/or guides the polymerization and/or polycondensing and/or organization of the building blocks that form the framework of the organosilica material; or (ii) such component is present in the synthesis of the organosilica material in a minor, or a non-substantial, or a negligible amount such that the component cannot be said to aid in and/or guide the polymerization and/or polycondensing and/or organization of the building blocks that form the framework of the organosilica material. Further, “no added structure directing agent” is synonymous with “no added template” and “no added templating agent.”

1. Structure Directing Agent

Examples of a structure directing agent can include, but are not limited to, non-ionic surfactants, ionic surfactants, cationic surfactants, silicon surfactants, amphoteric surfactants, polyalkylene oxide surfactants, fluorosurfactants, colloidal crystals, polymers, hyper branched molecules, star-shaped molecules, macromolecules, dendrimers, and combinations thereof. Additionally or alternatively, the surface directing agent can comprise or be a poloxamer, a triblock polymer, a tetraalkylammonium salt, a nonionic polyoxyethylene alkyl, a Gemini surfactant, or a mixture thereof. Examples of a tetraalkylammonium salt can include, but are not limited to, cetyltrimethylammonium halides, such as cetyltrimethylammonium chloride (CTAC), cetyltrimethylammonium bromide (CTAB), and octadecyltrimethylammonium chloride. Other exemplary surface directing agents can additionally or alternatively include hexadecyltrimethylammonium chloride and/or cetylpyridinium bromide.

Poloxamers are block copolymers of ethylene oxide and propylene oxide, more particularly nonionic triblock copolymers composed of a central hydrophobic chain of polyoxypropylene (poly(propylene oxide)) flanked by two hydrophilic chains of polyoxyethylene (poly(ethylene oxide)). Specifically, the term “poloxamer” refers to a polymer having the formula HO(C₂H₄))a(C₃H₆O)_{b}(C₂H₄O)ₐH in which “a” and “b” denote the number of polyoxyethylene and polyoxypropylene units, respectively. Poloxamers are also known by the trade name Pluronic®, for example Pluronic® 123 and Pluronic® F127. An additional triblock polymer is B50-6600.

Nonionic polyoxyethylene alkyl ethers are known by the trade name Brij®, for example Brij® 56, Brij® 58, Brij® 76, Brij® 78. Gemini surfactants are compounds having at least two hydrophobic groups and at least one or optionally two hydrophilic groups per molecule have been introduced.

2. Porogen

A porogen material is capable of forming domains, discrete regions, voids and/or pores in the organosilica material. An example of a porogen is a block copolymer (e.g., a di-block polymer). As used herein, porogen does not include water. Examples of polymer porogens can include, but are not limited to, polyvinyl aromatics, such as polystyrenes, polyvinylpyridines, hydrogenated polyvinyl aromatics, polyacrylonitriles, polyalkylene oxides, such as polyethylene oxides and polypropylene oxides, polyethylenes, polylactic acids, polysiloxanes, polycaprolactones, polycaprolactams, polyurethanes, polymethacrylates, such as polymethylmethacrylate or polymethacrylic acid, polyacrylates, such as polymethylacrylate and polyacrylic acid, polydienes such as polybutadienes and polyisoprenes, polyvinyl chlorides, polyacetals, and amine-capped alkylene oxides, as well as combinations thereof.

Additionally or alternatively, porogens can be thermoplastic homopolymers and random (as opposed to block) copolymers. As used herein, “homopolymer” means compounds comprising repeating units from a single monomer. Suitable thermoplastic materials can include, but are not limited to, homopolymers or copolymers of polystyrenes, polyacrylates, polymethacrylates, polybutadienes, polyisoprenes, polyphenylene oxides, polypropylene oxides, polyethylene oxides, poly(dimethylsiloxanes), polytetrahydrofurans, polyethylenes, polycyclohexylethylenes, polyethyloxazolines, polyvinylpyridines, polycaprolactones, polylactic acids, copolymers of these materials and mixtures of these materials. Examples of polystyrene include, but are not limited to anionic polymerized polystyrene, syndiotactic polystyrene, unsubstituted and substituted polystyrenes (for example, poly(a-methyl styrene)). The thermoplastic materials may be linear, branched, hyperbranched, dendritic, or star like in nature.

Additionally or alternatively, the porogen can be a solvent. Examples of solvents can include, but are not limited to, ketones (e.g., cyclohexanone, cyclopentanone, 2-heptanone, cycloheptanone, cyclooctanone, cyclohexylpyrrolidinone, methyl isobutyl ketone, methyl ethyl ketone, acetone), carbonate compounds (e.g., ethylene carbonate, propylene carbonate), heterocyclic compounds (e.g., 3-methyl-2-oxazolidinone, dimethylimidazolidinone, N-methylpyrrolidone, pyridine), cyclic ethers (e.g., dioxane, tetrahydrofuran), chain ethers (e.g., diethyl ether, ethylene glycol dimethyl ether, propylene glycol dimethyl ether, tetraethylene glycol dimethyl ether, polyethylene glycol dimethyl ether, ethylene glycol monomethyl ether, ethylene glycol monoethyl ether, propylene glycol monomethyl ether (PGME), triethylene glycol monobutyl ether, propylene glycol monopropyl ether, triethylene glycol monomethyl ether, diethylene glycol ethyl ether, diethylene glycol methyl ether, dipropylene glycol methyl ether, dipropylene glycol dimethyl ether, propylene glycol phenyl ether, tripropylene glycol methyl ether), alcohols (e.g., methanol, ethanol), polyhydric alcohols (e.g., ethylene glycol, propylene glycol, polyethylene glycol, polypropylene glycol, glycerin, dipropylene glycol), nitrile compounds (e.g., acetonitrile, glutarodinitrile, methoxyacetonitrile, propionitrile, benzonitrile), esters (e.g., ethyl acetate, butyl acetate, methyl lactate, ethyl lactate, methyl methoxypropionate, ethyl ethoxypropionate, methyl pyruvate, ethyl pyruvate, propyl pyruvate, 2-methoxyethyl acetate, ethylene glycol monoethyl ether acetate, propylene glycol monomethyl ether acetate (PGMEA), butyrolactone, phosphoric acid ester, phosphonic acid ester), aprotic polar substances (e.g., dimethyl sulfoxide, sulfolane, dimethylformamide, dimethylacetamide), nonpolar solvents (e.g., toluene, xylene, mesitylene), chlorine-based solvents (e.g., methylene dichloride, ethylene dichloride), benzene, dichlorobenzene, naphthalene, diphenyl ether, diisopropylbenzene, triethylamine, methyl benzoate, ethyl benzoate, butyl benzoate, monomethyl ether acetate hydroxy ethers such as dibenzylethers, diglyme, triglyme, and mixtures thereof.

3. Base/Acid

In various embodiments, the aqueous mixture used in the methods provided herein can comprise a base and/or an acid. It is understood that pH of the aqueous mixture may change over time. For example, the aqueous mixture may have a basic pH at an initial measurement and then the aqueous mixture may have an acidic pH at measurement taken later in time and vice versa.

In certain embodiments where the aqueous mixture comprises a base, the aqueous mixture can have a pH from about 8 to about 15, from about 8 to about 14.5, from about 8 to about 14, from about 8 to about 13.5, from about 8 to about 13, from about 8 to about 12.5, from about 8 to about 12, from about 8 to about 11.5, from about 8 to about 11, from about 8 to about 10.5, from about 8 to about 10, from about 8 to about 9.5, from about 8 to about 9, from about 8 to about 8.5, from about 8.5 to about 15, from about 8.5 to about 14.5, from about 8.5 to about 14, from about 8.5 to about 13.5, from about 8.5 to about 13, from about 8.5 to about 12.5, from about 8.5 to about 12, from about 8.5 to about 11.5, from about 8.5 to about 11, from about 8.5 to about 10.5, from about 8.5 to about 10, from about 8.5 to about 9.5, from about 8.5 to about 9, from about 9 to about 15, from about 9 to about 14.5, from about 9 to about 14, from about 9 to about 13.5, from about 9 to about 13, from about 9 to about 12.5, from about 9 to about 12, from about 9 to about 11.5, from about 9 to about 11, from about 9 to about 10.5, from about 9 to about 10, from about 9 to about 9.5, from about 9.5 to about 15, from about 9.5 to about 14.5, from about 9.5 to about 14, from about 9.5 to about 13.5, from about 9.5 to about 13, from about 9.5 to about 12.5, from about 9.5 to about 12, from about 9.5 to about 11.5, from about 9.5 to about 11, from about 9.5 to about 10.5, from about 9.5 to about 10, from about 10 to about 15, from about 10 to about 14.5, from about 10 to about 14, from about 10 to about 13.5, from about 10 to about 13, from about 10 to about 12.5, from about 10 to about 12, from about 10 to about 11.5, from about 10 to about 11, from about 10 to about 10.5, from about 10.5 to about 15, from about 10.5 to about 14.5, from about 10.5 to about 14, from about 10.5 to about 13.5, from about 10.5 to about 13, from about 10.5 to about 12.5, from about 10.5 to about 12, from about 10.5 to about 11.5, from about 10.5 to about 11, from about 11 to about 15, from about 11 to about 14.5, from about 11 to about 14, from about 11 to about 13.5, from about 11 to about 13, from about 11 to about 12.5, from about 11 to about 12, from about 11 to about 11.5, from about 11.5 to about 15, from about 11.5 to about 14.5, from about 11.5 to about 14, from about 11.5 to about 13.5, from about 11.5 to about 13, from about 11.5 to about 12.5, from about 11.5 to about 12, from about 12 to about 15, from about 12 to about 14.5, from about 12 to about 14, from about 12 to about 13.5, from about 12 to about 13, from about 12 to about 12.5, from about 12.5 to about 15, from about 12.5 to about 14.5, from about 12.5 to about 14, from about 12.5 to about 13.5, from about 12.5 to about 13, from about 12.5 to about 15, from about 12.5 to about 14.5, from about 12.5 to about 14, from about 12.5 to about 13.5, from about 12.5 to about 13, from about 13 to about 15, from about 13 to about 14.5, from about 13 to about 14, from about 13 to about 13.5, from about 13.5 to about 15, from about 13.5 to about 14.5, from about 13.5 to about 14, from about 14 to about 15, from about 14 to about 14.5, and from about 14.5 to about 15.

In a particular embodiment comprising a base, the pH can be from about 9 to about 15, from about 9 to about 14 or about 8 to about 14.

Exemplary bases can include, but are not limited to, a metal hydroxide, a basic salt, pyridine, pyrrole, piperazine, pyrrolidine, piperidine, picoline, monoethanolamine, diethanolamine, dimethylmonoethanolamine, monomethyldiethanolamine, triethanolamine, diazabicyclooctane, diazabicyclononane, diazabicycloundecene, tetramethylammonium hydroxide, tetraethylammonium hydroxide, tetrapropylammonium hydroxide, tetrabutylammonium hydroxide, ammonia, ammonium hydroxide, methylamine, ethylamine, propylamine, butylamine, pentylamine, hexylamine, octylamine, nonylamine, decylamine, N,N-dimethylamine, N,N-diethylamine, N,N-dipropylamine, N,N-dibutylamine, trimethylamine, triethylamine, tripropylamine, tributylamine, cyclohexylamine, trimethylimidine, 1-amino-3-methylbutane, dimethylglycine, 3-amino-3-methylamine, and the like. Examples of metal hydroxides include, but are not limited to sodium hydroxide, potassium hydroxide and lithium hydroxide. Examples of basic salts include, but are not limited to sodium carbonate, sodium bicarbonate, sodium acetate, sodium sulfide, sodium hydrosulfide, sodium bisulfate, monosodium phosphate, and disodium phosphate. These bases may be used either singly or in combination. In a particular embodiment, the base can comprise or be sodium hydroxide and/or ammonium hydroxide.

In certain embodiments where the aqueous mixture comprises an acid, the aqueous mixture can have a pH from about 0.01 to about 6.0, from about 0.01 to about 5, from about 0.01 to about 4, from about 0.01 to about 3, from about 0.01 to about 2, from about 0.01 to about 1, 0.1 to about 6.0, about 0.1 to about 5.5, about 0.1 to about 5.0, from about 0.1 to about 4.8, from about 0.1 to about 4.5, from about 0.1 to about 4.2, from about 0.1 to about 4.0, from about 0.1 to about 3.8, from about 0.1 to about 3.5, from about 0.1 to about 3.2, from about 0.1 to about 3.0, from about 0.1 to about 2.8, from about 0.1 to about 2.5, from about 0.1 to about 2.2, from about 0.1 to about 2.0, from about 0.1 to about 1.8, from about 0.1 to about 1.5, from about 0.1 to about 1.2, from about 0.1 to about 1.0, from about 0.1 to about 0.8, from about 0.1 to about 0.5, from about 0.1 to about 0.2, about 0.2 to about 6.0, about 0.2 to about 5.5, from about 0.2 to about 5, from about 0.2 to about 4.8, from about 0.2 to about 4.5, from about 0.2 to about 4.2, from about 0.2 to about 4.0, from about 0.2 to about 3.8, from about 0.2 to about 3.5, from about 0.2 to about 3.2, from about 0.2 to about 3.0, from about 0.2 to about 2.8, from about 0.2 to about 2.5, from about 0.2 to about 2.2, from about 0.2 to about 2.0, from about 0.2 to about 1.8, from about 0.2 to about 1.5, from about 0.2 to about 1.2, from about 0.2 to about 1.0, from about 0.2 to about 0.8, from about 0.2 to about 0.5, about 0.5 to about 6.0, about 0.5 to about 5.5, from about 0.5 to about 5, from about 0.5 to about 4.8, from about 0.5 to about 4.5, from about 0.5 to about 4.2, from about 0.5 to about 4.0, from about 0.5 to about 3.8, from about 0.5 to about 3.5, from about 0.5 to about 3.2, from about 0.5 to about 3.0, from about 0.5 to about 2.8, from about 0.5 to about 2.5, from about 0.5 to about 2.2, from about 0.5 to about 2.0, from about 0.5 to about 1.8, from about 0.5 to about 1.5, from about 0.5 to about 1.2, from about 0.5 to about 1.0, from about 0.5 to about 0.8, about 0.8 to about 6.0, about 0.8 to about 5.5, from about 0.8 to about 5, from about 0.8 to about 4.8, from about 0.8 to about 4.5, from about 0.8 to about 4.2, from about 0.8 to about 4.0, from about 0.8 to about 3.8, from about 0.8 to about 3.5, from about 0.8 to about 3.2, from about 0.8 to about 3.0, from about 0.8 to about 2.8, from about 0.8 to about 2.5, from about 0.8 to about 2.2, from about 0.8 to about 2.0, from about 0.8 to about 1.8, from about 0.8 to about 1.5, from about 0.8 to about 1.2, from about 0.8 to about 1.0, about 1.0 to about 6.0, about 1.0 to about 5.5, from about 1.0 to about 5.0, from about 1.0 to about 4.8, from about 1.0 to about 4.5, from about 1.0 to about 4.2, from about 1.0 to about 4.0, from about 1.0 to about 3.8, from about 1.0 to about 3.5, from about 1.0 to about 3.2, from about 1.0 to about 3.0, from about 1.0 to about 2.8, from about 1.0 to about 2.5, from about 1.0 to about 2.2, from about 1.0 to about 2.0, from about 1.0 to about 1.8, from about 1.0 to about 1.5, from about 1.0 to about 1.2, about 1.2 to about 6.0, about 1.2 to about 5.5, from about 1.2 to about 5.0, from about 1.2 to about 4.8, from about 1.2 to about 4.5, from about 1.2 to about 4.2, from about 1.2 to about 4.0, from about 1.2 to about 3.8, from about 1.2 to about 3.5, from about 1.2 to about 3.2, from about 1.2 to about 3.0, from about 1.2 to about 2.8, from about 1.2 to about 2.5, from about 1.2 to about 2.2, from about 1.2 to about 2.0, from about 1.2 to about 1.8, from about 1.2 to about 1.5, about 1.5 to about 6.0, about 1.5 to about 5.5, from about 1.5 to about 5.0, from about 1.5 to about 4.8, from about 1.5 to about 4.5, from about 1.5 to about 4.2, from about 1.5 to about 4.0, from about 1.5 to about 3.8, from about 1.5 to about 3.5, from about 1.5 to about 3.2, from about 1.5 to about 3.0, from about 1.5 to about 2.8, from about 1.5 to about 2.5, from about 1.5 to about 2.2, from about 1.5 to about 2.0, from about 1.5 to about 1.8, about 1.8 to about 6.0, about 1.8 to about 5.5, from about 1.8 to about 5.0, from about 1.8 to about 4.8, from about 1.8 to about 4.5, from about 1.8 to about 4.2, from about 1.8 to about 4.0, from about 1.8 to about 3.8, from about 1.8 to about 3.5, from about 1.8 to about 3.2, from about 1.8 to about 3.0, from about 1.8 to about 2.8, from about 1.8 to about 2.5, from about 1.8 to about 2.2, from about 1.8 to about 2.0, about 2.0 to about 6.0, about 2.0 to about 5.5, from about 2.0 to about 5.0, from about 2.0 to about 4.8, from about 2.0 to about 4.5, from about 2.0 to about 4.2, from about 2.0 to about 4.0, from about 2.0 to about 3.8, from about 2.0 to about 3.5, from about 2.0 to about 3.2, from about 2.0 to about 3.0, from about 2.0 to about 2.8, from about 2.0 to about 2.5, from about 2.0 to about 2.2, about 2.2 to about 6.0, about 2.2 to about 5.5, from about 2.2 to about 5.0, from about 2.2 to about 4.8, from about 2.2 to about 4.5, from about 2.2 to about 4.2, from about 2.2 to about 4.0, from about 2.2 to about 3.8, from about 2.2 to about 3.5, from about 2.2 to about 3.2, from about 2.2 to about 3.0, from about 2.2 to about 2.8, from about 2.2 to about 2.5, about 2.5 to about 6.0, about 2.5 to about 5.5, from about 2.5 to about 5.0, from about 2.5 to about 4.8, from about 2.5 to about 4.5, from about 2.5 to about 4.2, from about 2.5 to about 4.0, from about 2.5 to about 3.8, from about 2.5 to about 3.5, from about 2.5 to about 3.2, from about 2.5 to about 3.0, from about 2.5 to about 2.8, from about 2.8 to about 6.0, about 2.8 to about 5.5, from about 2.8 to about 5.0, from about 2.8 to about 4.8, from about 2.8 to about 4.5, from about 2.8 to about 4.2, from about 2.8 to about 4.0, from about 2.8 to about 3.8, from about 2.8 to about 3.5, from about 2.8 to about 3.2, from about 2.8 to about 3.0, from about 3.0 to about 6.0, from about 3.5 to about 5.5, from about 3.0 to about 5.0, from about 3.0 to about 4.8, from about 3.0 to about 4.5, from about 3.0 to about 4.2, from about 3.0 to about 4.0, from about 3.0 to about 3.8, from about 3.0 to about 3.5, from about 3.0 to about 3.2, from about 3.2 to about 6.0, from about 3.2 to about 5.5, from about 3.2 to about 5, from about 3.2 to about 4.8, from about 3.2 to about 4.5, from about 3.2 to about 4.2, from about 3.2 to about 4.0, from about 3.2 to about 3.8, from about 3.2 to about 3.5, from about 3.5 to about 6.0, from about 3.5 to about 5.5, from about 3.5 to about 5, from about 3.5 to about 4.8, from about 3.5 to about 4.5, from about 3.5 to about 4.2, from about 3.5 to about 4.0, from about 3.5 to about 3.8, from about 3.8 to about 5, from about 3.8 to about 4.8, from about 3.8 to about 4.5, from about 3.8 to about 4.2, from about 3.8 to about 4.0, from about 4.0 to about 6.0, from about 4.0 to about 5.5, from about 4.0 to about 5, from about 4.0 to about 4.8, from about 4.0 to about 4.5, from about 4.0 to about 4.2, from about 4.2 to about 5, from about 4.2 to about 4.8, from about 4.2 to about 4.5, from about 4.5 to about 5, from about 4.5 to about 4.8, or from about 4.8 to about 5.

In a particular embodiment comprising an acid, the pH can be from about 0.01 to about 6.0, 0.2 to about 6.0, about 0.2 to about 5.0 or about 0.2 to about 4.5.

Exemplary acids can include, but are not limited to, an inorganic acid and an acid salt. Examples of inorganic acids, include but are not limited to, hydrochloric acid, nitric acid, sulfuric acid, hydrofluoric acid, phosphoric acid, boric acid and oxalic acid; and organic acids such as acetic acid, propionic acid, butanoic acid, pentanoic acid, hexanoic acid, heptanoic acid, octanoic acid, nonanoic acid, decanoic acid, oxalic acid, maleic acid, methylmalonic acid, adipic acid, sebacic acid, gallic acid, butyric acid, mellitic acid, arachidonic acid, shikimic acid, 2-ethylhexanoic acid, oleic acid, stearic acid, linoleic acid, linolenic acid, salicylic acid, benzoic acid, p-amino-benzoic acid, p-toluenesulfonic acid, benzenesulfonic acid, monochloroacetic acid, dichloroacetic acid, trichloroacetic acid, trifluoroacetic acid, formic acid, malonic acid, sulfonic acid, phthalic acid, fumaric acid, citric acid, tartaric acid, succinic acid, itaconic acid, mesaconic acid, citraconic acid, malic acid, a hydrolysate of glutaric acid, a hydrolysate of maleic anhydride, a hydrolysate of phthalic anhydride, and the like.

Examples of acid salts, include but are not limited to ammonium chloride, aluminum chloride, zinc chloride, titanium tetrachloride, ferrous chloride, ferric chloride, ferric nitrate sodium carbonate, sodium bicarbonate, sodium hydrosulfide, sodium bisulfate, monosodium phosphate, and disodium phosphate. These acids may be used either singly or in combination. In a particular embodiment, the acid can comprise or be hydrochloric acid.

The above described pHs may correspond to the pH of the aqueous mixture before, during and/or after addition of the at least one silicone-containing compound.

Additionally or alternatively, the aqueous mixture may further comprise an alcohol.

Additionally or alternatively, the at least one silicon-containing compound may be added to a polar mixture that is not water.

IV.B. Metal Chelate Sources

In additional embodiments, the methods provided herein can further comprise adding to the aqueous solution a source of metal chelate compounds.

Examples of metal chelate compounds, when present, can include titanium chelate compounds such as triethoxy.mono(acetylacetonato) titanium, tri-n-propoxy.mono(acetylacetonato)titanium, tri-i-propoxy.mono(acetylacetonato)titanium, tri-n-butoxy.mono(acetylacetonato)titanium, tri-sec-butoxy.mono(acetylacetonato)titanium, tri-t-butoxy.mono(acetylacetonato)titanium, diethoxy.bis(acetylacetonato)titanium, di-n-propoxy.bis(acetylacetonato)titanium, di-i-propoxy.bis(acetylacetonato)titanium, di-n-butoxy.bis(acetylacetonato)titanium, di-sec-butoxy.bis(acetylacetonato)titanium, di-t-butoxy.bis(acetylacetonato)titanium, monoethoxy.tris(acetylacetonato)titanium, mono-n-propoxy.tris(acetylacetonato) titanium, mono-i-propoxy.tris(acetylacetonato)titanium, mono-n-butoxy. tris(acetylacetonato)titanium, mono-sec-butoxy.tris(acetylacetonato)titanium, mono-t-butoxy-tris(acetylacetonato)titanium, tetrakis(acetylacetonato)titanium, triethoxy. mono(ethylacetoacetaato)titanium, tri-n-propoxy.mono(ethylacetoacetato)titanium, tri-i-propoxy.mono(ethylacetoacetato)titanium, tri-n-butoxy.mono(ethylacetoacetato) titanium, tri-sec-butoxy.mono(ethylacetoacetato) titanium, tri-t-butoxy-mono(ethylacetoacetato)titanium, diethoxy.bis(ethylacetoacetato)titanium, di-n-propoxy.bis(ethylacetoacetato)titanium, di-i-propoxy.bis(ethylacetoacetato)titanium, di-n-butoxy.bis(ethylacetoacetato)titanium, di-sec-butoxy.bis(ethylacetoacetato)titanium, di-t-butoxy.bis(ethylacetoacetato)titanium, monoethoxy.tris(ethylacetoacetato)titanium, mono-n-propoxy.tris(ethylacetoaetato)titanium, mono-i-propoxy.tris(ethylacetoacetato) titanium, mono-n-butoxy.tris(ethylacetoacetato)titanium, mono-sec-butoxy. tris(ethylacetoacetato)titanium, mono-t-butoxy.tris(ethylacetoacetato)titanium, tetrakis(ethylacetoacetato)titanium, mono(acetylacetonato)tris(ethylacetoacetato) titanium, bis(acetylacetonato)bis(ethylacetoacetato)titanium, and tris(acetylacetonato)mono(ethylacetoacetato)titanium; zirconium chelate compounds such as triethoxy.mono(acetylacetonato)zirconium, tri-n-propoxy.mono(acetylacetonato) zirconium, tri-i-propoxy.mono(acetylacetonato)zirconium, tri-n-butoxy. mono(acetylacetonato)zirconium, tri-sec-butoxy.mono(acetylacetonato)zirconium, tri-t-butoxy.mono(acetylacetonato)zirconium, diethoxy.bis(acetylacetonato)zirconium, di-n-propoxy.bis(acetylacetonato)zirconium, di-i-propoxy.bis(acetylacetonato)zirconium, di-n-butoxy.bis(acetylacetonato)zirconium, di-sec-butoxy.bis(acetylacetonato)zirconium, di-t-butoxy.bis(acetylacetonato)zirconium, monoethoxy.tris(acetylacetonato)zirconium, mono-n-propoxy.tris(acetylacetonato)zirconium, mono-i-propoxy.tris(acetylacetonato) zirconium, mono-n-butoxy.tris(acetylacetonato)zirconium, mono-sec-butoxy. tris(acetylacetonato)zirconium, mono-t-butoxy.tris(acetylacetonato)zirconium, tetrakis(acetylacetonato)zirconium, triethoxy.mono(ethylacetoacetato)zirconium, tri-n-propoxy.mono(ethylacetoacetato)zirconium, tri-i-propoxy.mono(ethylacetoacetato) zirconium, tri-n-butoxy.mono(ethylacetoacetato)zirconium, tri-sec-butoxy. mono(ethylacetoacetato)zirconium, tri-t-butoxy.mono(ethylacetoacetato)zirconium, diethoxy.bis(ethylacetoacetato)zirconium, di-n-propoxy.bis(ethylacetoacetato)zirconium, di-i-propoxy.bis(ethylacetoacetato)zirconium, di-n-butoxy.bis(ethylacetoacetato) zirconium, di-sec-butoxy.bis(ethylacetoacetato)zirconium, di-t-butoxy. bis(ethylacetoacetato)zirconium, monoethoxy.tris(ethylacetoacetato)zirconium, mono-n-propoxy.tris(ethylacetoacetato)zirconium, mono-i-propoxy.tris(ethylacetoacetato) zirconium, mono-n-butoxy.tris(ethylacetoacetato)zirconium, mono-sec-butoxy. tris(ethylacetoacetato)zirconium, mono-t-butoxy.tris(ethylacetoacetato)zirconium, tetrakis(ethylacetoacetato)zirconium, mono(acetylacetonato)tris(ethylacetoacetato) zirconium, bis(acetylacetonato)bis(ethylacetoacetato)zirconium, and tris(acetylacetonato)mono(ethylacetoacetato)zirconium; and aluminum chelate compounds such as tris(acetylacetonato)aluminum and tris(ethylacetoacetato)aluminum. Of these, the chelate compounds of titanium or aluminum can be of note, of which the chelate compounds of titanium can be particularly of note. These metal chelate compounds may be used either singly or in combination.

IV.C. Aging the Solution

The solution formed in the methods described herein can be aged for at least about 4 hours, at least about 6 hours, at least about 12 hours, at least about 18 hours, at least about 24 hours (1 day), at least about 30 hours, at least about 36 hours, at least about 42 hours, at least about 48 hours (2 days), at least about 54 hours, at least about 60 hours, at least about 66 hours, at least about 72 hours (3 days), at least about 96 hours (4 days), at least about 120 hours (5 days), at least about 144 hours (6 days), at least about 200 hours, at least about 300 hours, at least about 400 hours, at least about 500 hours, at least about 600 hours, at least about 700 hours, at least about 800 hours, at least about 900 hours, at least about 1000 hours or at least about 1100 hours.

Additionally or alternatively, the solution formed in the methods described herein can be aged for about 4 hours to about 1100 hours, about 4 hours to about 1000 hours, about 4 hours to about 800 hours, about 4 hours to about 600 hours, about 4 hours to about 500 hours, about 4 hours to about 200 hours, about 4 hours to about 144 hours (6 days), about 4 hours to about 120 hours (5 days), about 4 hours to about 96 hours (4 days), about 4 hours to about 72 hours (3 days), about 4 hours to about 66 hours, about 4 hours to about 60 hours, about 4 hours to about 54 hours, about 4 hours to about 48 hours (2 days), about 4 hours to about 42 hours, about 4 hours to about 36 hours, about 4 hours to about 30 hours, about 4 hours to about 24 hours (1 day), about 4 hours to about 18 hours, about 4 hours to about 12 hours, about 4 hours to about 6 hours, about 6 hours to about 1100 hours, about 6 hours to about 1000 hours, about 6 hours to about 800 hours, about 6 hours to about 600 hours, about 6 hours to about 500 hours, about 6 hours to about 200 hours, about 6 hours to about 144 hours (6 days), about 6 hours to about 120 hours (5 days), about 6 hours to about 96 hours (4 days), about 6 hours to about 72 hours (3 days), about 6 hours to about 66 hours, about 6 hours to about 60 hours, about 6 hours to about 54 hours, about 6 hours to about 48 hours (2 days), about 6 hours to about 42 hours, about 6 hours to about 36 hours, about 6 hours to about 30 hours, about 6 hours to about 24 hours (1 day), about 6 hours to about 18 hours, about 6 hours to about 12 hours, about 12 hours to about 1000 hours, about 12 hours to about 144 hours (6 days), about 12 hours to about 120 hours (5 days), about 12 hours to about 96 hours (4 days), about 12 hours to about 72 hours (3 days), about 12 hours to about 66 hours, about 12 hours to about 60 hours, about 12 hours to about 54 hours, about 12 hours to about 48 hours (2 days), about 12 hours to about 42 hours, about 12 hours to about 36 hours, about 12 hours to about 30 hours, about 12 hours to about 24 hours (1 day), about 12 hours to about 18 hours, about 18 hours to about 1000 hours, about 18 hours to about 144 hours (6 days), about 18 hours to about 120 hours (5 days), about 18 hours to about 96 hours (4 days), about 18 hours to about 72 hours (3 days), about 18 hours to about 66 hours, about 18 hours to about 60 hours, about 18 hours to about 54 hours, about 18 hours to about 48 hours (2 days), about 18 hours to about 42 hours, about 18 hours to about 36 hours, about 18 hours to about 30 hours, about 18 hours to about 24 hours (1 day), about 24 hours (1 day) to about 1000 hours, about 24 hours(1 day) to about 144 hours (6 days), about 24 (1 day) hours (1 day) to about 120 hours (5 days), about 24 hours (1 day) to about 96 hours (4 days), about 24 hours (1 day) to about 72 hours (3 days), about 24 hours (1 day) to about 66 hours, about 24 hours (1 day) to about 60 hours, about 24 hours (1 day) to about 54 hours, about 24 hours (1 day) to about 48 hours (2 days), about 24 hours (1 day) to about 42 hours, about 24 hours (1 day) to about 36 hours, about 24 hours (1 day) to about 30 hours, about 30 hours to about 1000 hours, about 30 hours to about 144 hours (6 days), about 30 hours to about 120 hours (5 days), about 30 hours to about 96 hours (4 days), about 30 hours to about 72 hours (3 days), about 30 hours to about 66 hours, about 30 hours to about 60 hours, about 30 hours to about 54 hours, about 30 hours to about 48 hours (2 days), about 30 hours to about 42 hours, about 30 hours to about 36 hours, about 36 hours to about 144 hours (6 days), about 36 hours to about 120 hours (5 days), about 36 hours to about 96 hours (4 days), about 36 hours to about 72 hours (3 days), about 36 hours to about 66 hours, about 36 hours to about 60 hours, about 36 hours to about 54 hours, about 36 hours to about 48 hours (2 days), about 36 hours to about 42 hours, about 42 hours to about 1000 hours, about 42 hours to about 144 hours (6 days), about 42 hours to about 120 hours (5 days), about 42 hours to about 96 hours (4 days), about 42 hours to about 72 hours (3 days), about 42 hours to about 66 hours, about 42 hours to about 60 hours, about 42 hours to about 54 hours, about 42 hours to about 48 hours (2 days), about 48 hours (2 days) to about 144 hours (6 days), about 48 hours (2 days) to about 120 hours (5 days), about 48 hours (2 days) to about 96 hours (4 days), about 48 hours (2 days) to about 72 hours (3 days), about 48 hours (2 days) to about 66 hours, about 48 hours (2 days) to about 60 hours, about 48 hours (2 days) to about 54 hours, about 54 hours to about 1000 hours, about 54 hours to about 144 hours (6 days), about 54 hours to about 120 hours (5 days), about 54 hours to about 96 hours (4 days), about 54 hours to about 72 hours (3 days), about 54 hours to about 66 hours, about 54 hours to about 60 hours, about 60 hours to about 1000 hours, about 60 hours to about 144 hours (6 days), about 60 hours to about 120 hours (5 days), about 60 hours to about 96 hours (4 days), about 60 hours to about 72 hours (3 days), about 60 hours to about 66 hours, about 66 hours to about 144 hours (6 days), about 66 hours to about 120 hours (5 days), about 66 hours to about 96 hours (4 days), about 66 hours to about 72 hours (3 days), about 72 hours to about 1000 hours, about 72 hours (3 days) to about 144 hours (6 days), about 72 hours (3 days) to about 120 hours (5 days), about 72 hours (3 days) to about 96 hours (4 days), about 96 hours (4 days) to about 1000 hours, about 96 hours (4 days) to about 144 hours (6 days), about 96 hours (4 days) to about 120 hours (5 days), about 120 hours (5 days) to about 1000 hours, about 120 hours (5 days) to about 144 hours (6 days), about 144 hours (6 days) to about 1000 hours, about 200 hours to about 1000 hours, about 400 hours to about 1000 hours, about 500 hours to about 1000 hours, about 600 hours to about 1000 hours, or about 800 hours to about 1000 hours.

Additionally or alternatively, the solution formed in the method can be aged at temperature of at least about 0° C., at least about 10° C., at least about 20° C., at least about 30° C., at least about 40° C., at least about 50° C., at least about 60° C., at least about 70° C., at least about 80° C., at least about 90° C., at least about 100° C., at least about 110° C., at least about 120° C. at least about 130° C., at least about 140° C., at least about 150° C., at least about 175° C., at least about 200° C., at least about 250° C., or about 300° C.

Additionally or alternatively, the solution formed in the method can be aged at temperature of about 0° C. to about 300° C., about 0° C. to about 250° C., about 0° C. to about 200° C., about 0° C. to about 175° C., about 0° C. to about 150° C., about 0° C. to about 140° C., about 0° C. to about 130° C., about 0° C. to about 120° C., about 0° C. to about 110° C., about 0° C. to about 100° C., about 0° C. to about 90° C., about 0° C. to about 80° C., about 0° C. to about 70° C., about 0° C. to about 60° C., about 0° C. to about 50° C., about 10° C. to about 300° C., about 10° C. to about 250° C., about 10° C. to about 200° C., about 10° C. to about 175° C., about 10° C. to about 150° C., about 10° C. to about 140° C., about 10° C. to about 130° C., about 10° C. to about 120° C., about 10° C. to about 110° C., about 10° C. to about 100° C., about 10° C. to about 90° C., about 10° C. to about 80° C., about 10° C. to about 70° C., about 10° C. to about 60° C., about 10° C. to about 50° C., about 20° C. to about 300° C., about 20° C. to about 250° C., about 20° C. to about 200° C., about 20° C. to about 175° C., about 20° C. to about 150° C., about 20° C. to about 140° C., about 20° C. to about 130° C., about 20° C. to about 120° C., about 20° C. to about 110° C., about 20° C. to about 100° C., about 20° C. to about 90° C., about 20° C. to about 80° C., about 20° C. to about 70° C., about 20° C. to about 60° C., about 20° C. to about 50° C., about 30° C. to about 300° C., about 30° C. to about 250° C., about 30° C. to about 200° C., about 30° C. to about 175° C., about 30° C. to about 150° C., about 30° C. to about 140° C., about 30° C. to about 130° C., about 30° C. to about 120° C., about 30° C. to about 110° C., about 30° C. to about 100° C., about 30° C. to about 90° C., about 30° C. to about 80° C., about 30° C. to about 70° C., about 30° C. to about 60° C., about 30° C. to about 50° C., about 50° C. to about 300° C., about 50° C. to about 250° C., about 50° C. to about 200° C., about 50° C. to about 175° C., about 50° C. to about 150° C., about 50° C. to about 140° C., about 50° C. to about 130° C., about 50° C. to about 120° C., about 50° C. to about 110° C., about 50° C. to about 100° C., about 50° C. to about 90° C., about 50° C. to about 80° C., about 50° C. to about 70° C., about 50° C. to about 60° C., about 70° C. to about 300° C., about 70° C. to about 250° C., about 70° C. to about 200° C., about 70° C. to about 175° C., about 70° C. to about 150° C., about 70° C. to about 140° C., about 70° C. to about 130° C., about 70° C. to about 120° C., about 70° C. to about 110° C., about 70° C. to about 100° C., about 70° C. to about 90° C., about 70° C. to about 80° C., about 80° C. to about 300° C., about 80° C. to about 250° C., about 80° C. to about 200° C., about 80° C. to about 175° C., about 80° C. to about 150° C., about 80° C. to about 140° C., about 80° C. to about 130° C., about 80° C. to about 120° C., about 80° C. to about 110° C., about 80° C. to about 100° C., about 80° C. to about 90° C., about 90° C. to about 300° C., about 90° C. to about 250° C., about 90° C. to about 200° C., about 90° C. to about 175° C., about 90° C. to about 150° C., about 90° C. to about 140° C., about 90° C. to about 130° C., about 90° C. to about 120° C., about 90° C. to about 110° C., about 90° C. to about 100° C., about 100° C. to about 300° C., about 100° C. to about 250° C., about 100° C. to about 200° C., about 100° C. to about 175° C., about 100° C. to about 150° C., about 100° C. to about 140° C., about 100° C. to about 130° C., about 100° C. to about 120° C., about 100° C. to about 110° C., about 110° C. to about 300° C., about 110° C. to about 250° C., about 110° C. to about 200° C., about 110° C. to about 175° C., about 110° C. to about 150° C., about 110° C. to about 140° C., about 110° C. to about 130° C., about 110° C. to about 120° C., about 120° C. to about 300° C., about 120° C. to about 250° C., about 120° C. to about 200° C., about 120° C. to about 175° C., about 120° C. to about 150° C., about 120° C. to about 140° C., about 120° C. to about 130° C., about 130° C. to about 300° C., about 130° C. to about 250° C., about 130° C. to about 200° C., about 130° C. to about 175° C., about 130° C. to about 150° C., or about 130° C. to about 140° C.

In particular, the solution may be aged for up to about 1000 hours at a temperature of about 0° C. to about 200° C.

In various aspects, adjusting the aging time and/or aging temperature of the solution formed in the methods described herein can affect the total surface area, microporous surface area, pore volume, pore radius and pore diameter of the organosilica material made. Thus, the porosity of the organosilica material may be adjusted by adjusting aging time and/or temperature.

IV.D. Drying the Pre-Product

The methods described herein comprise drying the pre-product (e.g., a gel) to produce an organosilica material. Drying may be performed by an suitable process or device, e.g., by spray-drying or in a vacuum.

In some embodiments, the pre-product (e.g., a gel) formed in the method can be dried at a temperature of greater than or equal to about −20° C., greater than or equal to about 0° C., greater than or equal to about 20° C., greater than or equal to about 50° C., greater than or equal to about 70° C., greater than or equal to about 80° C., greater than or equal to about 100° C., greater than or equal to about 110° C., greater than or equal to about 120° C., greater than or equal to about 150° C., greater than or equal to about 200° C., greater than or equal to about 250° C., greater than or equal to about 300° C., greater than or equal to about 350° C., greater than or equal to about 400° C., greater than or equal to about 450° C., greater than or equal to about 500° C., greater than or equal to about 550° C., or greater than or equal to about 600° C.

Additionally or alternatively, the pre-product (e.g., a gel) formed in the method can be dried at temperature of about −20° C. to about 600° C., about −20° C. to about 550° C., about −20° C. to about 500° C., about −20° C. to about 450° C., about −20° C. to about 400° C., about −20° C. to about 350° C., about −20° C. to about 300° C., about −20° C. to about 250° C., about −20° C. to about 200° C., about −20° C. to about 150° C., about −20° C. to about 120° C., about −20° C. to about 110° C., about −20° C. to about 100° C., about −20° C. to about 80° C., about −20° C. to about 70° C., about −20° C. to about 50° C., about −20° C. to about 20° C., about −20° C. to about 0° C., about 0° C. to about 600° C., about 0° C. to about 550° C., about 0° C. to about 500° C., about 0° C. to about 450° C., about 0° C. to about 400° C., about 0° C. to about 350° C., about 0° C. to about 300° C., about 0° C. to about 250° C., about 0° C. to about 200° C., about 0° C. to about 150° C., about 0° C. to about 120° C., about 0° C. to about 110° C., about 0° C. to about 100° C., about 0° C. to about 80° C., about 0° C. to about 70° C., about 0° C. to about 50° C., about 0° C. to about 20° C., about 50° C. to about 600° C., about 50° C. to about 550° C., about 50° C. to about 500° C., about 50° C. to about 450° C., about 50° C. to about 400° C., about 50° C. to about 350° C., about 50° C. to about 300° C., about 50° C. to about 250° C., about 50° C. to about 200° C., about 50° C. to about 150° C., about 50° C. to about 120° C., about 50° C. to about 110° C., about 50° C. to about 100° C., about 50° C. to about 80° C., about 50° C. to about 70° C., about 70° C. to about 600° C., about 70° C. to about 550° C., about 70° C. to about 500° C., about 70° C. to about 450° C., about 70° C. to about 400° C., about 70° C. to about 350° C., about 70° C. to about 300° C., about 70° C. to about 250° C., about 70° C. to about 200° C., about 70° C. to about 150° C., about 70° C. to about 120° C., about 70° C. to about 110° C., about 70° C. to about 100° C., about 70° C. to about 80° C., about 80° C. to about 600° C., about 70° C. to about 550° C., about 80° C. to about 500° C., about 80° C. to about 450° C., about 80° C. to about 400° C., about 80° C. to about 350° C., about 80° C. to about 300° C., about 80° C. to about 250° C., about 80° C. to about 200° C., about 80° C. to about 150° C., about 80° C. to about 120° C., about 80° C. to about 110° C., or about 80° C. to about 100° C.

In a particular embodiment, the pre-product (e.g., a gel) formed in the method can be dried at temperature from about −20° C. to about 200° C.

Additionally or alternatively, the pre-product (e.g., a gel) formed in the method can be dried in a N₂ and/or air atmosphere.

IV.E. Optional Further Steps

In some embodiments, the method can further comprise calcining the organosilica material to obtain a silica material. The calcining can be performed in air or an inert gas, such as nitrogen or air enriched in nitrogen. Calcining can take place at a temperature of at least about 300° C., at least about 350° C., at least about 400° C., at least about 450° C., at least about 500° C., at least about 550° C., at least about 600° C., or at least about 650° C., for example at least about 400° C. Additionally or alternatively, calcining can be performed at a temperature of about 300° C. to about 650° C., about 300° C. to about 600° C., about 300° C. to about 550° C., about 300° C. to about 400° C., about 300° C. to about 450° C., about 300° C. to about 400° C., about 300° C. to about 350° C., about 350° C. to about 650° C., about 350° C. to about 600° C., about 350° C. to about 550° C., about 350° C. to about 400° C., about 350° C. to about 450° C., about 350° C. to about 400° C., about 400° C. to about 650° C., about 400° C. to about 600° C., about 400° C. to about 550° C., about 400° C. to about 500° C., about 400° C. to about 450° C., about 450° C. to about 650° C., about 450° C. to about 600° C., about 450° C. to about 550° C., about 450° C. to about 500° C., about 500° C. to about 650° C., about 500° C. to about 600° C., about 500° C. to about 550° C., about 550° C. to about 650° C., about 550° C. to about 600° C. or about 600° C. to about 650° C.

In some embodiments, the method can further comprise incorporating a catalyst metal within the pores of the organosilica material. Exemplary catalyst metals can include, but are not limited to, a Group 6 element, a Group 8 element, a Group 9 element, a Group 10 element or a combination thereof. Exemplary Group 6 elements can include, but are not limited to, chromium, molybdenum, and/or tungsten, particularly including molybdenum and/or tungsten. Exemplary Group 8 elements can include, but are not limited to, iron, ruthenium, and/or osmium. Exemplary Group 9 elements can include, but are not limited to, cobalt, rhodium, and/or iridium, particularly including cobalt. Exemplary Group 10 elements can include, but are not limited to, nickel, palladium and/or platinum.

The catalyst metal can be incorporated into the organosilica material by any convenient method, such as by impregnation, by ion exchange, or by complexation to surface sites. The catalyst metal so incorporated may be employed to promote any one of a number of catalytic transformations commonly conducted in petroleum refining or petrochemicals production. Examples of such catalytic processes can include, but are not limited to, hydrogenation, dehydrogenation, aromatization, aromatic saturation, hydrodesulfurization, olefin oligomerization, polymerization, hydrodenitrogenation, hydrocracking, naphtha reforming, paraffin isomerization, aromatic transalkylation, saturation of double/triple bonds, and the like, as well as combinations thereof.

Thus, in another embodiment, a catalyst material comprising the organosilica material described herein is provided. The catalyst material may optionally comprise a binder or be self-bound. Suitable binders, include but are not limited to active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the binder may be silica-alumina, alumina and/or a zeolite, particularly alumina. Silica-alumina may be either naturally occurring or in the form of gelatinous precipitates or gels including mixtures of silica and metal oxides. It should be noted it is recognized herein that the use of a material in conjunction with a zeolite binder material, i.e., combined therewith or present during its synthesis, which itself is catalytically active may change the conversion and/or selectivity of the finished catalyst. It is also recognized herein that inactive materials can suitably serve as diluents to control the amount of conversion if the present invention is employed in alkylation processes so that alkylation products can be obtained economically and orderly without employing other means for controlling the rate of reaction. These inactive materials may be incorporated into naturally occurring clays, e.g., bentonite and kaolin, to improve the crush strength of the catalyst under commercial operating conditions and function as binders or matrices for the catalyst. The catalysts described herein typically can comprise, in a composited form, a ratio of support material to binder material of about 100 parts support material to about zero parts binder material; about 99 parts support material to about 1 parts binder material; about 95 parts support material to about 5 parts binder material. Additionally or alternatively, the catalysts described herein typically can comprise, in a composited form, a ratio of support material to binder material ranging from about 90 parts support material to about 10 parts binder material to about 10 parts support material to about 90 parts binder material; about 85 parts support material to about 15 parts binder material to about 15 parts support material to about 85 parts binder material; about 80 parts support material to 20 parts binder material to 20 parts support material to 80 parts binder material, all ratios being by weight, typically from 80:20 to 50:50 support material:binder material, preferably from 65:35 to 35:65. Compositing may be done by conventional means including mulling the materials together followed by extrusion of pelletizing into the desired finished catalyst particles.

In some embodiments, the method can further comprise incorporating cationic metal sites into the network structure by any convenient method, such as impregnation or complexation to the surface, through an organic precursor, or by some other method. This organometallic material may be employed in a number of hydrocarbon separations conducted in petroleum refining or petrochemicals production. Examples of such compounds to be desirably separated from petrochemicals/fuels can include olefins, paraffins, aromatics, and the like.

Additionally or alternatively, the method can further comprise incorporating a surface metal within the pores of the organosilica material. The surface metal can be selected from a Group 1 element, a Group 2 element, a Group 13 element, and a combination thereof. When a Group 1 element is present, it can preferably comprise or be sodium and/or potassium. When a Group 2 element is present, it can include, but may not be limited to, magnesium and/or calcium. When a Group 13 element is present, it can include, but may not be limited to, boron and/or aluminum. One or more of the Group 1,2, 6, 8-10 and/or 13 elements may be present on an exterior and/or interior surface of the organosilica material. For example, one or more of the Group 1,2 and/or 13 elements may be present in a first layer on the organosilica material and one or more of the Group 6, 8, 9 and/or 10 elements may be present in a second layer, e.g., at least partially atop the Group 1,2 and/or 13 elements. Additionally or alternatively, only one or more Group 6, 8, 9 and/or 10 elements may present on an exterior and/or interior surface of the organosilica material. The surface metal(s) can be incorporated into/onto the organosilica material by any convenient method, such as by impregnation, deposition, grafting, co-condensation, by ion exchange, and/or the like.

IV.F. Organosilica Material

The organosilica materials made by the methods described herein can be characterized as described in the following sections.

1. Pore Size

The organosilica material described herein may advantageously be in a mesoporous form. As indicated previously, the term mesoporous refers to solid materials having pores with a diameter within the range of from about 2 nm to about 50 nm. The average pore diameter of the organosilica material can be determined, for example, using nitrogen adsorption-desorption isotherm techniques within the expertise of one of skill in the art, such as the BET (Brunauer Emmet Teller) method.

The organosilica material can have an average pore diameter of about 0.2 nm, about 0.4 nm, about 0.5 nm, about 0.6 nm, about 0.8 nm, about 1.0 nm, about 1.5 nm, about 1.8 nm or less than about 2.0 nm.

Additionally or alternatively, the organosilica material can advantageously have an average pore diameter within the mesopore range of about 2.0 nm, about 2.5 nm, about 3.0 nm, about 3.1 nm, about 3.2 nm, about 3.3 nm, about 3.4 nm, about 3.5 nm, about 3.6 nm, about 3.7 nm, about 3.8 nm, about 3.9 nm about 4.0 nm, about 4.1 nm, about 4.5 nm, about 5.0 nm, about 6.0 nm, about 7.0 nm, about 7.3 nm, about 8 nm, about 8.4 nm, about 9 nm, about 10 nm, about 11 nm, about 13 nm, about 15 nm, about 18 nm, about 20 nm, about 23 nm, about 25 nm, about 30 nm, about 40 nm, about 45 nm, or about 50 nm.

Additionally or alternatively, the organosilica material can have an average pore diameter of 0.2 nm to about 50 nm, about 0.2 nm to about 40 nm, about 0.2 nm to about 30 nm, about 0.2 nm to about 25 nm, about 0.2 nm to about 23 nm, about 0.2 nm to about 20 nm, about 0.2 nm to about 18 nm, about 0.2 nm to about 15 nm, about 0.2 nm to about 13 nm, about 0.2 nm to about 11 nm, about 0.2 nm to about 10 nm, about 0.2 nm to about 9 nm, about 0.2 nm to about 8.4 nm, about 0.2 nm to about 8 nm, about 0.2 nm to about 7.3 nm, about 0.2 nm to about 7.0 nm, about 0.2 nm to about 6.0 nm, about 0.2 nm to about 5.0 nm, about 0.2 nm to about 4.5 nm, about 0.2 nm to about 4.1 nm, about 0.2 nm to about 4.0 nm, about 0.2 nm to about 3.9 nm, about 0.2 nm to about 3.8 nm, about 0.2 nm to about 3.7 nm, about 0.2 nm to about 3.6 nm, about 0.2 nm to about 3.5 nm, about 0.2 nm to about 3.4 nm, about 0.2 nm to about 3.3 nm, about 0.2 nm to about 3.2 nm, about 0.2 nm to about 3.1 nm, about 0.2 nm to about 3.0 nm, about 0.2 nm to about 2.5 nm, about 0.2 nm to about 2.0 nm, about 0.2 nm to about 1.0 nm, about 1.0 nm to about 50 nm, about 1.0 nm to about 40 nm, about 1.0 nm to about 30 nm, about 1.0 nm to about 25 nm, about 1.0 nm to about 23 nm, about 1.0 nm to about 20 nm, about 1.0 nm to about 18 nm, about 1.0 nm to about 15 nm, about 1.0 nm to about 13 nm, about 1.0 nm to about 11 nm, about 1.0 nm to about 10 nm, about 1.0 nm to about 9 nm, about 1.0 nm to about 8.4 nm, about 1.0 nm to about 8 nm, about 1.0 nm to about 7.3 nm, about 1.0 nm to about 7.0 nm, about 1.0 nm to about 6.0 nm, about 1.0 nm to about 5.0 nm, about 1.0 nm to about 4.5 nm, about 1.0 nm to about 4.1 nm, about 1.0 nm to about 4.0 nm, about 1.0 nm to about 3.9 nm, about 1.0 nm to about 3.8 nm, about 1.0 nm to about 3.7 nm, about 1.0 nm to about 3.6 nm, about 1.0 nm to about 3.5 nm, about 1.0 nm to about 3.4 nm, about 1.0 nm to about 3.3 nm, about 1.0 nm to about 3.2 nm, about 1.0 nm to about 3.1 nm, about 1.0 nm to about 3.0 nm or about 1.0 nm to about 2.5 nm.

In particular, the organosilica material can advantageously have an average pore diameter in the mesopore range of about 2.0 nm to about 50 nm, about 2.0 nm to about 40 nm, about 2.0 nm to about 30 nm, about 2.0 nm to about 25 nm, about 2.0 nm to about 23 nm, about 2.0 nm to about 20 nm, about 2.0 nm to about 18 nm, about 2.0 nm to about 15 nm, about 2.0 nm to about 13 nm, about 2.0 nm to about 11 nm, about 2.0 nm to about 10 nm, about 2.0 nm to about 9 nm, about 2.0 nm to about 8.4 nm, about 2.0 nm to about 8 nm, about 2.0 nm to about 7.3 nm, about 2.0 nm to about 7.0 nm, about 2.0 nm to about 6.0 nm, about 2.0 nm to about 5.0 nm, about 2.0 nm to about 4.5 nm, about 2.0 nm to about 4.1 nm, about 2.0 nm to about 4.0 nm, about 2.0 nm to about 3.9 nm, about 2.0 nm to about 3.8 nm, about 2.0 nm to about 3.7 nm, about 2.0 nm to about 3.6 nm, about 2.0 nm to about 3.5 nm, about 2.0 nm to about 3.4 nm, about 2.0 nm to about 3.3 nm, about 2.0 nm to about 3.2 nm, about 2.0 nm to about 3.1 nm, about 2.0 nm to about 3.0 nm, about 2.0 nm to about 2.5 nm, about 2.5 nm to about 50 nm, about 2.5 nm to about 40 nm, about 2.5 nm to about 30 nm, about 2.5 nm to about 25 nm, about 2.5 nm to about 23 nm, about 2.5 nm to about 20 nm, about 2.5 nm to about 18 nm, about 2.5 nm to about 15 nm, about 2.5 nm to about 13 nm, about 2.5 nm to about 11 nm, about 2.5 nm to about 10 nm, about 2.5 nm to about 9 nm, about 2.5 nm to about 8.4 nm, about 2.5 nm to about 8 nm, about 2.5 nm to about 7.3 nm, about 2.5 nm to about 7.0 nm, about 2.5 nm to about 6.0 nm, about 2.5 nm to about 5.0 nm, about 2.5 nm to about 4.5 nm, about 2.5 nm to about 4.1 nm, about 2.5 nm to about 4.0 nm, about 2.5 nm to about 3.9 nm, about 2.5 nm to about 3.8 nm, about 2.5 nm to about 3.7 nm, about 2.5 nm to about 3.6 nm, about 2.5 nm to about 3.5 nm, about 2.5 nm to about 3.4 nm, about 2.5 nm to about 3.3 nm, about 2.5 nm to about 3.2 nm, about 2.5 nm to about 3.1 nm, about 2.5 nm to about 3.0 nm, about 3.0 nm to about 50 nm, about 3.0 nm to about 40 nm, about 3.0 nm to about 30 nm, about 3.0 nm to about 25 nm, about 3.0 nm to about 23 nm, about 3.0 nm to about 20 nm, about 3.0 nm to about 18 nm, about 3.0 nm to about 15 nm, about 3.0 nm to about 13 nm, about 3.0 nm to about 11 nm, about 3.0 nm to about 10 nm, about 3.0 nm to about 9 nm, about 3.0 nm to about 8.4 nm, about 3.0 nm to about 8 nm, about 3.0 nm to about 7.3 nm, about 3.0 nm to about 7.0 nm, about 3.0 nm to about 6.0 nm, about 3.0 nm to about 5.0 nm, about 3.0 nm to about 4.5 nm, about 3.0 nm to about 4.1 nm, or about 3.0 nm to about 4.0 nm.

In one particular embodiment, the organosilica material described herein can have an average pore diameter of about 1.0 nm to about 30.0 nm, particularly about 1.0 nm to about 25.0 nm, particularly about 1.5 nm to about 25.0 nm, particularly about 2.0 nm to about 25.0 nm, particularly about 2.0 nm to about 20.0 nm, particularly about 2.0 nm to about 15.0 nm, or particularly about 2.0 nm to about 10.0 nm.

Using surfactant as a template to synthesize mesoporous materials can create highly ordered structure, e.g. well-defined cylindrical-like pore channels. In some circumstances, there may be no hysteresis loop observed from N₂ adsorption isotherm. In other circumstances, for instance where mesoporous materials can have less ordered pore structures, a hysteresis loop may be observed from N2 adsorption isotherm experiments. In such circumstances, without being bound by theory, the hysteresis can result from the lack of regularity in the pore shapes/sizes and/or from bottleneck constrictions in such irregular pores.

2. Surface Area

The surface area of the organosilica material can be determined, for example, using nitrogen adsorption-desorption isotherm techniques within the expertise of one of skill in the art, such as the BET (Brunauer Emmet Teller) method. This method may determine a total surface area, an external surface area, and a microporous surface area. As used herein, and unless otherwise specified, “total surface area” refers to the total surface area as determined by the BET method. As used herein, and unless otherwise specified, “microporous surface area” refers to microporous surface are as determined by the BET method.

In various embodiments, the organosilica material can have a total surface area greater than or equal to about 100 m²/g, greater than or equal to about 200 m²/g, greater than or equal to about 300 m²/g, greater than or equal to about 400 m²/g, greater than or equal to about 450 m²/g, greater than or equal to about 500 m²/g, greater than or equal to about 550 m²/g, greater than or equal to about 600 m²/g, greater than or equal to about 700 m²/g, greater than or equal to about 800 m²/g, greater than or equal to about 850 m²/g, greater than or equal to about 900 m²/g, greater than or equal to about 1,000 m²/g, greater than or equal to about 1,050 m²/g, greater than or equal to about 1,100 m²/g, greater than or equal to about 1,150 m²/g, greater than or equal to about 1,200 m²/g, greater than or equal to about 1,250 m²/g, greater than or equal to about 1,300 m²/g, greater than or equal to about 1,400 m²/g, greater than or equal to about 1,450 m²/g, greater than or equal to about 1,500 m²/g, greater than or equal to about 1,550 m²/g, greater than or equal to about 1,600 m²/g, greater than or equal to about 1,700 m²/g, greater than or equal to about 1,800 m²/g, greater than or equal to about 1,900 m²/g, greater than or equal to about 2,000 m²/g, greater than or equal to greater than or equal to about 2,100 m²/g, greater than or equal to about 2,200 m²/g, greater than or equal to about 2,300 m²/g, greater than or equal to about 2,500 m²/g, greater than or equal to about 3,000 m²/g, greater than or equal to about 4,000 m²/g greater than or equal to about 5,000 m²/g, greater than or equal to about 6,000 m²/g, greater than or equal to about 7,000 m²/g or greater than or equal to about 8,000 m²/g

Additionally or alternatively, the organosilica material may have a total surface area of about 50 m²/g to about 8,000 m²/g, about 50 m²/g to about 7,000 m²/g, about 50 m²/g to about 5,000 m²/g, about 50 m²/g to about 2,500 m²/g, about 50 m²/g to about 2,000 m²/g, about 50 m²/g to about 1,500 m²/g, about 50 m²/g to about 1,000 m²/g, about 100 m²/g to about 8,000 m²/g, about 100 m²/g to about 7,000 m²/g, about 100 m²/g to about 5,000 m²/g, about 100 m²/g to about 2,500 m²/g, about 100 m²/g to about 2,300 m²/g, about 100 m²/g to about 2,200 m²/g, about 100 m²/g to about 2,100 m²/g, about 100 m²/g to about 2,000 m²/g, about 100 m²/g to about 1,900 m²/g, about 100 m²/g to about 1,800 m²/g, about 100 m²/g to about 1,700 m²/g, about 100 m²/g to about 1,600 m²/g, about 100 m²/g to about 1,550 m²/g, about 100 m²/g to about 1,500 m²/g, about 100 m²/g to about 1,450 m²/g, about 100 m²/g to about 1,400 m²/g, about 100 m²/g to about 1,300 m²/g, about 100 m²/g to about 1,250 m²/g, about 100 m²/g to about 1,200 m²/g, about 100 m²/g to about 1,150 m²/g, about 100 m²/g to about 1,100 m²/g, about 100 m²/g to about 1,050 m²/g, about 100 m²/g to about 1,000 m²/g, about 100 m²/g to about 900 m²/g, about 100 m²/g to about 850 m²/g, about 100 m²/g to about 800 m²/g, about 100 m²/g to about 700 m²/g, about 100 m²/g to about 600 m²/g, about 100 m²/g to about 550 m²/g, about 100 m²/g to about 500 m²/g, about 100 m²/g to about 450 m²/g, about 100 m²/g to about 400 m²/g, about 100 m²/g to about 300 m²/g, about 100 m²/g to about 200 m²/g, about 200 m²/g to about 8,000 m²/g, about 200 m²/g to about 7,000 m²/g, about 200 m²/g to about 5,000 m²/g, about 200 m²/g to about 2,500 m²/g, about 200 m²/g to about 2,300 m²/g, about 200 m²/g to about 2,200 m²/g, about 200 m²/g to about 2,100 m²/g, about 200 m²/g to about 2,000 m²/g, about 200 m²/g to about 1,900 m²/g, about 200 m²/g to about 1,800 m²/g, about 200 m²/g to about 1,700 m²/g, about 200 m²/g to about 1,600 m²/g, about 200 m²/g to about 1,550 m²/g, about 200 m²/g to about 1,500 m²/g, about 200 m²/g to about 1,450 m²/g, about 200 m²/g to about 1,400 m²/g, about 200 m²/g to about 1,300 m²/g, about 200 m²/g to about 1,250 m²/g, about 200 m²/g to about 1,200 m²/g, about 200 m²/g to about 1,150 m²/g, about 200 m²/g to about 1,100 m²/g, about 200 m²/g to about 1,050 m²/g, about 200 m²/g to about 1,000 m²/g, about 200 m²/g to about 900 m²/g, about 200 m²/g to about 850 m²/g, about 200 m²/g to about 800 m²/g, about 200 m²/g to about 700 m²/g, about 200 m²/g to about 600 m²/g, about 200 m²/g to about 550 m²/g, about 200 m²/g to about 500 m²/g, about 200 m²/g to about 450 m²/g, about 200 m²/g to about 400 m²/g, about 200 m²/g to about 300 m²/g, about 500 m²/g to about 8,000 m²/g, about 500 m²/g to about 7,000 m²/g, about 500 m²/g to about 5,000 m²/g, about 500 m²/g to about 2,500 m²/g, about 500 m²/g to about 2,300 m²/g, about 500 m²/g to about 2,200 m²/g, about 500 m²/g to about 2,100 m²/g, about 500 m²/g to about 2,000 m²/g, about 500 m²/g to about 1,900 m²/g, about 500 m²/g to about 1,800 m²/g, about 500 m²/g to about 1,700 m²/g, about 500 m²/g to about 1,600 m²/g, about 500 m²/g to about 1,550 m²/g, about 500 m²/g to about 1,500 m²/g, about 500 m²/g to about 1,450 m²/g, about 500 m²/g to about 1,400 m²/g, about 500 m²/g to about 1,300 m²/g, about 500 m²/g to about 1,250 m²/g, about 500 m²/g to about 1,200 m²/g, about 500 m²/g to about 1,150 m²/g, about 500 m²/g to about 1,100 m²/g, about 500 m²/g to about 1,050 m²/g, about 500 m²/g to about 1,000 m²/g, about 500 m²/g to about 900 m²/g, about 500 m²/g to about 850 m²/g, about 500 m²/g to about 800 m²/g, about 500 m²/g to about 700 m²/g, about 500 m²/g to about 600 m²/g, about 500 m²/g to about 550 m²/g, about 1000 m²/g to about 8,000 m²/g, about 1000 m²/g to about 7,000 m²/g, about 1000 m²/g to about 5,000 m²/g, about 1,000 m²/g to about 2,500 m²/g, about 1,000 m²/g to about 2,300 m²/g, about 1,000 m²/g to about 2,200 m²/g, about 1,000 m²/g to about 2,100 m²/g, about 1,000 m²/g to about 2,000 m²/g, about 1,000 m²/g to about 1,900 m²/g, about 1,000 m²/g to about 1,800 m²/g, about 1,000 m²/g to about 1,700 m²/g, about 1,000 m²/g to about 1,600 m²/g, about 1,000 m²/g to about 1,550 m²/g, about 1,000 m²/g to about 1,500 m²/g, about 1,000 m²/g to about 1,450 m²/g, about 1,000 m²/g to about 1,400 m²/g, about 1,000 m²/g to about 1,300 m²/g, about 1,000 m²/g to about 1,250 m²/g, about 1,000 m²/g to about 1,200 m²/g, about 1,000 m²/g to about 1,150 m²/g, about 1,000 m²/g to about 1,100 m²/g, or about 1,000 m²/g to about 1,050 m²/g.

In one particular embodiment, the organosilica material described herein may have a total surface area of about 200 m²/g to about 7,000 m²g, particularly about 400 m²/g to about 5,000 m²g, or particularly about 400 m²/g to about 2,500 m²/g.

3. Pore Volume

The pore volume of the organosilica material made by the methods described herein can be determined, for example, using nitrogen adsorption-desorption isotherm techniques within the expertise of one of skill in the art, such as the BET to (Brunauer Emmet Teller) method.

In various embodiments, the organosilica material can have a pore volume greater than or equal to about 0.1 cm³/g, greater than or equal to about 0.2 cm³/g, greater than or equal to about 0.3 cm³/g, greater than or equal to about 0.4 cm³/g, greater than or equal to about 0.5 cm³/g, greater than or equal to about 0.6 cm³/g, greater than or equal to about 0.7 cm³/g, greater than or equal to about 0.8 cm³/g, greater than or equal to about 0.9 cm³/g, greater than or equal to about 1.0 cm³/g, greater than or equal to about 1.1 cm³/g, greater than or equal to about 1.2 cm³/g, greater than or equal to about 1.3 cm³/g, greater than or equal to about 1.4 cm³/g, greater than or equal to about 1.5 cm³/g, greater than or equal to about 1.6 cm³/g, greater than or equal to about 1.7 cm³/g, greater than or equal to about 1.8 cm³/g, greater than or equal to about 1.9 cm³/g, greater than or equal to about 2.0 cm³/g, greater than or equal to about 2.5 cm³/g, greater than or equal to about 3.0 cm³/g, greater than or equal to about 3.5 cm³/g, greater than or equal to about 4.0 cm³/g, greater than or equal to about 5.0 cm³/g, greater than or equal to about 6.0 cm³/g, greater than or equal to about 7.0 cm³/g, or about 10.0 cm³/g.

Additionally or alternatively, the organosilica material can have a pore volume of about 0.1 cm³/g to about 10.0 cm³/g, about 0.1 cm³/g to about 7.0 cm³/g, about 0.1 cm³/g to about 6.0 cm³/g, about 0.1 cm³/g to about 5.0 cm³/g, about 0.1 cm³/g to about 4.0 cm³/g, about 0.1 cm³/g to about 3.5 cm³/g, about 0.1 cm³/g to about 3.0 cm³/g, about 0.1 cm³/g to about 2.5 cm³/g, about 0.1 cm³/g to about 2.0 cm³/g, about 0.1 cm³/g to about 1.9 cm³/g, about 0.1 cm³/g to about 1.8 cm³/g, about 0.1 cm³/g to about 1.7 cm³/g, about 0.1 cm³/g to about 1.6 cm³/g, about 0.1 cm³/g to about 1.5 cm³/g, about 0.1 cm³/g to about 1.4 cm³/g, about 0.1 cm³/g to about 1.3 cm³/g, about 0.1 cm³/g to about 1.2 cm³/g, about 0.1 cm³/g to about 1.1, about 0.1 cm³/g to about 1.0 cm³/g, about 0.1 cm³/g to about 0.9 cm³/g, about 0.1 cm³/g to about 0.8 cm³/g, about 0.1 cm³/g to about 0.7 cm³/g, about 0.1 cm³/g to about 0.6 cm³/g, about 0.1 cm³/g to about 0.5 cm³/g, about 0.1 cm³/g to about 0.4 cm³/g, about 0.1 cm³/g to about 0.3 cm³/g, about 0.1 cm³/g to about 0.2 cm³/g, 0.2 cm³/g to about 10.0 cm³/g, about 0.2 cm³/g to about 7.0 cm³/g, about 0.2 cm³/g to about 6.0 cm³/g, about 0.2 cm³/g to about 5.0 cm³/g, about 0.2 cm³/g to about 4.0 cm³/g, about 0.2 cm³/g to about 3.5 cm³/g, about 0.2 cm³/g to about 3.0 cm³/g, about 0.2 cm³/g to about 2.5 cm³/g, about 0.2 cm³/g to about 2.0 cm³/g, about 0.2 cm³/g to about 1.9 cm³/g, about 0.2 cm³/g to about 1.8 cm³/g, about 0.2 cm³/g to about 1.7 cm³/g, about 0.2 cm³/g to about 1.6 cm³/g, about 0.2 cm³/g to about 1.5 cm³/g, about 0.2 cm³/g to about 1.4 cm³/g, about 0.2 cm³/g to about 1.3 cm³/g, about 0.2 cm³/g to about 1.2 cm³/g, about 0.2 cm³/g to about 1.1, about 0.5 cm³/g to about 1.0 cm³/g, about 0.5 cm³/g to about 0.9 cm³/g, about 0.5 cm³/g to about 0.8 cm³/g, about 0.5 cm³/g to about 0.7 cm³/g, about 0.5 cm³/g to about 0.6 cm³/g, about 0.5 cm³/g to about 0.5 cm³/g, about 0.5 cm³/g to about 0.4 cm³/g, about 0.5 cm³/g to about 0.3 cm³/g, 0.5 cm³/g to about 10.0 cm³/g, about 0.5 cm³/g to about 7.0 cm³/g, about 0.5 cm³/g to about 6.0 cm³/g, about 0.5 cm³/g to about 5.0 cm³/g, about 0.5 cm³/g to about 4.0 cm³/g, about 0.5 cm³/g to about 3.5 cm³/g, about 0.5 cm³/g to about 3.0 cm³/g, about 0.5 cm³/g to about 2.5 cm³/g, about 0.5 cm³/g to about 2.0 cm³/g, about 0.5 cm³/g to about 1.9 cm³/g, about 0.5 cm³/g to about 1.8 cm³/g, about 0.5 cm³/g to about 1.7 cm³/g, about 0.5 cm³/g to about 1.6 cm³/g, about 0.5 cm³/g to about 1.5 cm³/g, about 0.5 cm³/g to about 1.4 cm³/g, about 0.5 cm³/g to about 1.3 cm³/g, about 0.5 cm³/g to about 1.2 cm³/g, about 0.5 cm³/g to about 1.1, about 0.5 cm³/g to about 1.0 cm³/g, about 0.5 cm³/g to about 0.9 cm³/g, about 0.5 cm³/g to about 0.8 cm³/g, about 0.5 cm³/g to about 0.7 cm³/g, or about 0.5 cm³/g to about 0.6 cm³/g.

In a particular embodiment, the organosilica material can have a pore volume of about 0.1 cm³/g to about 5.0 cm³/g, particularly about 0.1 cm³/g to about 3.0 cm³/g, particularly about 0.2 cm³/g to about 3.0 cm³/g, particularly about 0.2 cm³/g to about 2.5 cm³/g, or particularly about 0.2 cm³/g to about 1.5 cm³/g.

### V. Organosilica Materials

Organosilica materials can be made from the methods described herein. In another particular embodiment, an organosilica material can be made from: (a) adding at least one silicon-containing compound as described herein into an aqueous mixture as described herein that contains essentially no structure directing agent as described herein and/or porogen as described herein to form a solution as described herein, wherein the at least one silicon-containing compound has a solvent index (W) of greater than about 1.0 as described herein and the at least one silicon-containing compound is not 1,1,3,3,5,5-hexaethoxy-1,3,5-trisilacyclohexane, bis(triethoxysilyl)methane or 1,2-bis(triethoxysilyl)ethylene; (b) aging the solution to produce a pre-product as described herein; and (c) drying the pre-product as described herein to obtain an organosilica material which is a polymer comprising independent siloxane units.

### VI. Adsorbent Materials

Additionally or alternatively, an adsorbent material is provided herein. The adsorbent material may comprise the organosilica material described herein.

VI.A. Metals

In various embodiments, the adsorbent material can comprise a metal and/or metal ion. The organosilica material can further comprise at least one metal or metal ion incorporated within the pores of the organosilica material. Exemplary metals and/or metal ions can include, but are not limited to transition metals and basic metals, such as a Group 6 element, a Group 7 element, a Group 8 element, a Group 9 element, a Group 10 element, a Group 12 element, a Group 13 element or a combination thereof. Exemplary Group 6 elements can include, but are not limited to, chromium, molybdenum, and/or tungsten, particularly including molybdenum and/or tungsten. Exemplary Group 7 elements can include, but are not limited to, manganese, technetium, and/or rhenium, particularly including manganese. Exemplary Group 8 elements can include, but are not limited to, iron, ruthenium, and/or osmium. Exemplary Group 9 elements can include, but are not limited to, cobalt, rhodium, and/or iridium, particularly including cobalt. Exemplary Group 10 elements can include, but are not limited to, nickel, palladium and/or platinum. Exemplary Group 12 elements can include, but are not limited to, zinc, cadmium, and/or mercury, particularly including zinc. Exemplary Group 13 elements can include, but are not limited to, boron, aluminum, and/or gallium, particularly including boron. In a particular embodiment, the adsorbent material can comprise a Group 7 metal or metal ion, such as but not limited to, Mn (II) (Mn²⁺) or Mn (III) (Mn³⁺) and a combination thereof. In another particular embodiment, the adsorbent material can comprise a Group 8 metal or metal ion, such as but not limited to, ferrous iron (iron (II) or Fe²⁺), ferric iron (iron (III) or Fe³⁺) and a combination thereof. In another particular embodiment, the adsorbent material can comprise a Group 12 metal or metal ion, such as but not limited to Zn (II) (Zn²⁺). In another particular embodiment, the adsorbent material can comprise a Group 13 metal or metal ion, such as but not limited to Al (II) (Al²⁻), Al (III) (Al²⁺) and a combination thereof.

Additionally or alternatively, the metal or metal ion may be present in an amount of at least about 0.010 wt. %, at least about 0.050 wt. %, at least about 0.10 wt. %, at least about 0.50 wt. %, at least about 1.0 wt. %, at least about 5.0 wt. %, at least about 10 wt. %, at least about 15 wt. %, at least about 20 wt. %, at least about 25 wt. %, at least about 30 wt. %, at least about 35 wt. %, at least about 40 wt. %, at least about 45 wt. %, or at least about 50 wt. %. All metals/metal ion weight percents are on finished material. By “finished material” it is meant that the percents are based on the weight of the finished adsorbent, i.e., the porous material support with incorporated metal. For example, if the finished adsorbent were to weigh 100 grams, then 20 wt. % metal/metal ion would mean that 20 grams of the metal/metal ion was on 80 gm of the porous support. Additionally or alternatively, the metal or metal ion may be present in an amount of about 0.010 wt. % to about 50 wt. %, about 0.010 wt. % to about 45 wt. %, about 0.010 wt. % to about 40 wt. %, about 0.010 wt. % to about 35 wt. %, about 0.010 wt. % to about 30 wt. %, about 0.010 wt. % to about 25 wt. %, about 0.010 wt. % to about 20 wt. %, about 0.010 wt. % to about 15 wt. %, about 0.010 wt. % to about 10 wt. %, about 0.010 wt. % to about 5.0 wt. %, about 0.010 wt. % to about 1.0 wt. %, about 0.010 wt. % to about 0.50 wt. %, about 0.010 wt. % to about 0.10 wt. %, about 0.50 wt. % to about 50 wt. %, about 0.50 wt. % to about 45 wt. %, about 0.50 wt. % to about 40 wt. %, about 0.50 wt. % to about 35 wt. %, about 0.50 wt. % to about 30 wt. %, about 0.50 wt. % to about 25 wt. %, about 0.50 wt. % to about 20 wt. %, about 0.50 wt. % to about 15 wt. %, about 0.50 wt. % to about 10 wt. %, about 0.50 wt. % to about 5.0 wt. %, about 0.50 wt. % to about 1.0 wt. %, about 1.0 wt. % to about 50 wt. %, about 1.0 wt. % to about 45 wt. %, about 1.0 wt. % to about 40 wt. %, about 1.0 wt. % to about 35 wt. %, about 1.0 wt. % to about 30 wt. %, about 1.0 wt. % to about 25 wt. %, about 1.0 wt. % to about 20 wt. %, about 1.0 wt. % to about 15 wt. %, about 1.0 wt. % to about 10 wt. %, or about 1.0 wt. % to about 5.0 wt. %.

In particular, the metal/metal ion may be present in an amount of about 0.010 wt. % to about 50 wt. %, about 0.50 wt. % to about 30 wt. %, about 0.50 wt. % to about 20 wt. %, about 1.0 wt. % to about 15 wt. % or about 1.0 wt. % to about 10 wt. %.

The metal or metal ion can be incorporated into the organosilica material by any convenient method, such as by impregnation, by ion exchange, or by complexation to surface sites.

Additionally or alternatively, the organosilica material can further comprise a surface metal incorporated within the pores of the organosilica material. The surface metal can be selected from a Group 1 element, a Group 2 element, a Group 13 element, and a combination thereof. When a Group 1 element is present, it can preferably comprise or be sodium and/or potassium. When a Group 2 element is present, it can include, but may not be limited to, magnesium and/or calcium. When a Group 13 element is present, it can include, but may not be limited to, boron and/or aluminum.

One or more of the Group 1,2, 6, 8-10 and/or 13 elements may be present on an exterior and/or interior surface of the organosilica material. For example, one or more of the Group 1,2 and/or 13 elements may be present in a first layer on the organosilica material and one or more of the Group 6, 8, 9 and/or 10 elements may be present in a second layer, e.g., at least partially atop the Group 1,2 and/or 13 elements. Additionally or alternatively, only one or more Group 6, 8, 9 and/or 10 elements may present on an exterior and/or interior surface of the organosilica material. The surface metal(s) can be incorporated into/onto the organosilica material by any convenient method, such as by impregnation, deposition, grafting, co-condensation, by ion exchange, and/or the like.

VI.B. Binder

In various aspects, the adsorbent material may further comprise a binder or be self-bound. Suitable binders include, but are not limited to, active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the binder may be selected from the group consisting of active and inactive materials, inorganic materials, clays, alumina, silica, silica-alumina, titania, zirconia, or a combination thereof. Particularly, the binder may be silica-alumina, alumina and/or zirconia, particularly alumina. Silica-alumina may be either naturally occurring or in the form of gelatinous precipitates or gels including mixtures of silica and metal oxides. It should be noted it is recognized herein that the use of a material in conjunction with a zeolite binder material, i.e., combined therewith or present during its synthesis, which itself is catalytically active may change the conversion and/or selectivity of the finished catalyst. It is also recognized herein that inactive materials can suitably serve as diluents to control the amount of conversion if the present invention is employed in alkylation processes so that alkylation products can be obtained economically and orderly without employing other means for controlling the rate of reaction. These inactive materials may be incorporated into naturally occurring clays, e.g., bentonite and kaolin, to improve the crush strength of the catalyst under commercial operating conditions and function as binders or matrices for the catalyst. The adsorbent materials described herein typically can comprise, in a composited form, a ratio of support material to binder material of about 100 parts support material to about zero parts binder material; about 99 parts support material to about 1 parts binder material; about 95 parts support material to about 5 parts binder material. Additionally or alternatively, the adsorbent materials described herein typically can comprise, in a composited form, a ratio of support material to binder material ranging from about 90 parts support material to about 10 parts binder material to about 10 parts support material to about 90 parts binder material; about 85 parts support material to about 15 parts binder material to about 15 parts support material to about 85 parts binder material; about 80 parts support material to 20 parts binder material to 20 parts support material to 80 parts binder material, all ratios being by weight, typically from 80:20 to 50:50 support material:binder material, preferably from 65:35 to 35:65. Compositing may be done by conventional means including mulling the materials together followed by extrusion of pelletizing into the desired finished adsorbent material particles.

### VII. Sol-Gel System

In another embodiment, a sol-gel system is provided. The sol-gel system may comprise an aqueous solution comprising at least one silicon-containing compound as described herein having a solvent index (W) of greater than about 1.0 as described herein, wherein the aqueous solution contains essentially no structure directing agent as described herein and/or porogen as described herein.

Additionally or alternatively, the at least one silicon containing compound may have a kinetic index (T) as described herein, particularly a kinetic index (T) of greater than zero and less than about 1.0.

Additionally or alternatively, the at least one silicon containing compound may have a solvent index (W) as described herein, particularly a solvent index (W) of between about 1.0 and about 20.

Additionally or alternatively, the at least one silicon containing compound may comprise independent [SiX₄]ₙ units as described herein. In particular, each X may be independently selected from the group consisting of a hydrolyzable group bonded to a silicon atom of another SiX₄ unit as described herein, a non-hydrolyzable group bonded to a silicon atom of another SiX₄ unit as described herein, a non-hydrolyzable terminal group as described herein, and a hydrolyzable terminal group as described herein; with the proviso that at least one X is a hydrolyzable terminal group; and n is 1 to 1000 as described herein.

In a particular embodiment, the hydrolyzable group bonded to a silicon atom of another SiX₄ unit may be selected from the group consisting of an oxygen atom, a halogen substituted alkylene as described herein, a nitrogen-containing alkylene group as described herein, —O—R¹—, and —R²—O—R³—, wherein R¹, R² and R³ are each independently an alkylene group as described herein or an arylene group as described herein.

In another particular embodiment, the non-hydrolyzable group bonded to a silicon atom of another SiX₄ unit may be selected from the group consisting of an alkylene group as described herein, an alkenylene group as described herein, an alkynylene group as described herein, and an arylene group as described herein.

In another particular embodiment, the non-hydrolyzable terminal group may be selected from the group consisting of an alkyl group as described herein, an alkenyl group as described herein, an alkynyl group as described herein, and an aryl group as described herein.

In another particular embodiment, the hydrolyzable terminal group may be selected from the group consisting of an alkoxy group as described herein, an acyloxy group as described herein, an arylalkoxy group as described herein, a hydroxyl group as described herein, a haloalkyl group as described herein, a halide as described herein, an amino group as described herein, and an aminoalkyl group as described herein.

Additionally or alternatively, the at least one silicon-containing compound is not 1,1,3,3,5,5-hexaethoxy-1,3,5-trisilacyclohexane, bis(triethoxysilyl)methane or 1,2-bis(triethoxysilyl)ethylene.

Additionally or alternatively, the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxy silane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, and bis[(methyldimethoxysilyl)propyl]-N-methylamine, tris(3-trimethoxysilylpropyl)isocyanurate.

Additionally or alternatively, the aqueous solution may comprise hydroxide and may have a pH of from about 8.0 to about 14.

Additionally or alternatively, the aqueous solution may comprise hydronium and may have a pH of from about 0.01 to about 6.0.

Additionally or alternatively, the sol-gel system may comprise a device for ageing the solution, e.g., an oven.

### VIII. Silicon-Containing Compounds

In another embodiment, a silicon-containing compounds as described herein are provided. The silicon-containing compound may have a solvent index (W) of greater than about 1.0 as described herein and/or a kinetic index (T) of greater than zero and less than about 1.0 as described herein.

Additionally or alternatively, the at least one silicon-containing compound is not 1,1,3,3,5,5-hexaethoxy-1,3,5-trisilacyclohexane, bis(triethoxysilyl)methane or 1,2-bis(triethoxysilyl)ethylene.

Additionally or alternatively, the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxy silane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, and bis[(methyldimethoxysilyl)propyl]-N-methylamine, tris(3-trimethoxysilylpropyl)isocyanurate.

### IX. Further Embodiments

The invention can additionally or alternately include one or more of the following embodiments.

Embodiment 1. A method for identifying precursors for producing an organosilica material, the method comprising:

(a) using the following solvent index (W) equation (I):

W=3/2(τ*_{c}²/β*ₕ) (I)

wherein
τ*_{c} represents the number of hydrolyzable terminal groups remaining per silicon atom at a rigidity transition; and
β*ₕ represents the number of hydrolyzable bridging groups per silicon atom at the rigidity transition; and

the following kinetic index (T) equation (II):

$$T = \frac{4}{3} ( \frac{1}{{τ}_{c}^{*}} - \frac{1}{{τ}_{c 0}} ) \qquad ( II )$$

wherein
τ_{c0} represents the initial number of hydrolyzable terminal groups per silicon atom;
   to determine a result where at least one silicon-containing compound satisfies the condition that W is greater than 1.0 and/or T is greater than zero and/or less than 1.0, wherein the at least one silicon-containing compound is not 1,1,3,3,5,5-hexaethoxy-1,3,5-trisilacyclohexane, bis(triethoxysilyl)methane or 1,2-bis(triethoxysilyl)ethylene; and

(b) transmitting the result to another party.

Embodiment 2. A method for preparing an organosilica material, the method comprising:

(a) adding at least one silicon-containing compound into an aqueous mixture that contains essentially no structure directing agent and/or porogen to form a solution, wherein the at least one silicon-containing compound has a solvent index (W) of greater than about 1.0, and optionally, has a kinetic index (T) greater than zero and less than 1.0, and the at least one silicon-containing compound is not 1,1,3,3,5,5-hexaethoxy-1,3,5-trisilacyclohexane, bis(triethoxysilyl)methane or 1,2-bis(triethoxysilyl)ethylene;

(b) aging the solution to produce a pre-product; and

(c) drying the pre-product to obtain an organosilica material which is a polymer comprising independent siloxane units.

Embodiment 3. A method for preparing an organosilica material, the method comprising:

(a) using the following solvent index (W) equation (I):

W=3/2(τ*_{c}²/β*ₕ) (I)

wherein
τ*_{c} represents the number of hydrolyzable terminal groups remaining per silicon atom at a rigidity transition; and
β*ₕ represents the number of hydrolyzable bridging groups per silicon atom at the rigidity transition; and

the following kinetic index (T) equation (II):

$$T = \frac{4}{3} ( \frac{1}{{τ}_{c}^{*}} - \frac{1}{{τ}_{c 0}} ) \qquad ( II )$$

wherein
τ_{c0} represents the initial number of hydrolyzable terminal groups per silicon atom;
   to determine at least one silicon-containing compound that satisfies the condition that W is greater than 1.0 and/or T is greater than zero and less than 1.0, wherein the at least one silicon-containing compound is not 1,1,3,3,5,5-hexaethoxy-1,3,5-trisilacyclohexane, bis(triethoxysilyl)methane or 1,2-bis(triethoxysilyl)ethylene;

(b) adding the at least one silicon containing compound to an aqueous mixture that contains essentially no structure directing agent and/or porogen, to form a solution;

(c) aging the solution to produce a pre-product; and

(d) drying the pre-product to obtain an organosilica material which is a polymer comprising independent siloxane units.

Embodiment 4. The method of any of the previous embodiments, wherein the at least one silicon-containing compound has a solvent index (W) of between about 1.0 and about 20.

Embodiment 5. The method of any one of the previous embodiments, wherein the at least one silicon-containing compound comprises independent [SiX₄]ₙ units, wherein each X is independently selected from the group consisting of a hydrolyzable group bonded to a silicon atom of another SiX₄ unit, a non-hydrolyzable group bonded to a silicon atom of another SiX₄ unit, a non-hydrolyzable terminal group, and a hydrolyzable terminal group; with the proviso that at least one X is a hydrolyzable terminal group; and n is 1 to 1000.

Embodiment 6. The method of embodiment 5, wherein the hydrolyzable group bonded to a silicon atom of another SiX₄ unit is selected from the group consisting of an oxygen atom, a halogen substituted alkylene, a nitrogen-containing alkylene group, and —R²—O—R³—, wherein R¹, R² and R³ are each independently an alkylene group or an arylene group.

Embodiment 7. The method of embodiment 5 or 6, wherein the non-hydrolyzable group bonded to a silicon atom of another SiX₄ unit is selected from the group consisting of an alkylene group, an alkenylene group, an alkynylene group, and an arylene group.

Embodiment 8. The method of any one of embodiments 5-7, wherein the non-hydrolyzable terminal group is selected from the group consisting of an alkyl group, an alkenyl group, an alkynyl group, and an aryl group.

Embodiment 9. The method of any one of embodiments 5-8, wherein the hydrolyzable terminal group is selected from the group consisting an alkoxy group, an acyloxy group, an arylalkoxy group, a hydroxyl group, a haloalkyl group, a halide, an amino group, and an aminoalkyl group.

Embodiment 10. The method of any one of embodiments 2-9, wherein the aqueous mixture comprises a base and has a pH from about 8 to about 14.

Embodiment 11. The method of embodiment 10, wherein the base is ammonium hydroxide, a metal hydroxide or a basic salt.

Embodiment 12. The method of any one of embodiments 2-11, wherein the aqueous mixture comprises an acid and has a pH from about 0.01 to about 6.0.

Embodiment 13. The method of embodiment 12, wherein the acid is an inorganic acid or an acid salt.

Embodiment 14. The method of embodiment 13, wherein the inorganic acid is hydrochloric acid.

Embodiment 15. The method of any one embodiments 2-14, wherein the solution is aged in step (c) for up to about 1000 hours at a temperature of about 0° C. to about 200° C.

Embodiment 16. The method of any one of embodiments 2-15, wherein the pre-product is dried at a temperature of about −20° C. to about 200° C.

Embodiment 17. The method of any one of the previous embodiments, wherein the organosilica material has a total surface area of about 200 m²/g to about 7000 m²/g.

Embodiment 18. The method of any one of the previous embodiments, wherein the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxysilane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, bis[(methyldimethoxysilyl)propyl]-N-methylamine, and tris(3-trimethoxysilylpropyl)isocyanurate.

Embodiment 19. The method of any one of the previous embodiments further comprising incorporating at least one catalytic metal within the pores of the organosilica material.

Embodiment 20. The method of embodiment 19, wherein the catalytic metal is selected from the group consisting of a Group 6 element, a Group 8 element, a Group 9 element, a Group 10 element and a combination thereof.

Embodiment 21. An organosilica material made according to the method of any one of embodiments 2-20.

Embodiment 22. A catalyst material comprising the organosilica material of embodiment 21 and optionally, a binder.

Embodiment 23. An adsorbent material comprising the organosilica material of embodiment 21 and optionally, a Group 8 metal ion.

Embodiment 24. The method of embodiment 1, wherein the another party uses the determined at least one silicon-containing compound that satisfies the condition that W is greater than 1.0 and T is greater than zero and/or less than 1.0 in a method to prepare an organosilica material.

Embodiment 25. A sol-gel system comprising: an aqueous solution comprising at least one silicon-containing compound having a solvent index (W) of greater than about 1.0, wherein the aqueous solution contains essentially no structure directing agent and/or porogen and the at least one silicon-containing compound is not 1,1,3,3,5,5-hexaethoxy-1,3,5-trisilacyclohexane, bis(triethoxysilyl)methane or 1,2-bis(triethoxysilyl)ethylene.

Embodiment 26. The sol-gel system of embodiment 25,wherein the at least one silicon-containing compound has a kinetic index (T) of greater than zero and less than about 1.0 and/or has a solvent index (W) of between about 1.0 and about 20

Embodiment 27. The sol-gel system of embodiment 25 or 26, wherein the at least one silicon-containing compound comprises independent [SiX₄]ₙ units, wherein each X is independently selected from the group consisting of a hydrolyzable group bonded to a silicon atom of another SiX₄ unit, a non-hydrolyzable group bonded to a silicon atom of another SiX₄ unit, a non-hydrolyzable terminal group, and hydrolyzable terminal group; with the proviso that at least one X is a hydrolyzable terminal group; and n is 1 to 1000.

Embodiment 28. The sol-gel system of embodiment 27, wherein the hydrolyzable group bonded to a silicon atom of another SiX₄ unit is selected from the group consisting of an oxygen atom, a halogen substituted alkylene, a nitrogen-containing alkylene group, and —R²—O—R³—, wherein R¹, R² and R³ are each independently an alkylene group or an arylene group.

Embodiment 29. The sol-gel system of embodiment 27 or 28, wherein the non-hydrolyzable group bonded to a silicon atom of another SiX₄ unit is selected from the group consisting of an alkylene group, an alkenylene group, an alkynylene group, and an arylene group.

Embodiment 30. The sol-gel system of any one of embodiments 27-29, wherein the non-hydrolyzable terminal group is selected from the group consisting of an alkyl group, an alkenyl group, alkynyl group, and an aryl group.

Embodiment 31. The sol-gel system of any one of embodiments 27-30, wherein the hydrolyzable terminal group is selected from the group consisting an alkoxy group, an acyloxy group, an arylalkoxy group, a hydroxyl group, a haloalkyl group, a halide, an amino group, and an aminoalkyl group.

Embodiment 32. The sol-gel system of any one of embodiments 27-31, wherein the aqueous solution comprises hydroxide and has a pH from about 8 to about 14.

Embodiment 33. The sol-gel system of any one of embodiments 27-31, wherein the aqueous solution comprises hydronium and has a pH from about 0.01 to about 6.0.

Embodiment 34. The sol-gel system of any one of embodiments 27-33, wherein the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxysilane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, bis[(methyldimethoxysilyl)propyl]-N-methylamine, and tris(3-trimethoxysilylpropyl)isocyanurate.

Embodiment 35. The sol-gel system of any one of embodiments 27-34, further comprising a device for ageing the solution.

Embodiment 36. A silicon-containing compound having a solvent index (W) of greater than about 1.0 and a kinetic index (T) of greater than zero and less than about 1.0, wherein the at least one silicon-containing compound is not a compound selected from the group consisting of 1,1,3,3,5,5-hexaethoxy-1,3,5-trisilacyclohexane, 1,3,5-trimethyl-1,3,5-triethoxy-1,3,5-trisilacyclohexane, methyltriethoxysilane, (3-aminopropyl)triethoxy silane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, bis(triethoxysilyl)methane, 1,2-bis(triethoxysilyl)ethylene, N,N′-bis[(3-trimethoxysilyl)propyl]ethylenediamine, bis[(methyldiethoxysilyl)propyl]amine, bis[(methyldimethoxysilyl)propyl]-N-methylamine, and tris(3-trimethoxysilylpropyl)isocyanurate.

### EXAMPLES

### General Methods

### Nitrogen Porosimetry

The nitrogen adsorption/desorption analyses was performed with different instruments, e.g. TriStar™ 3000, TriStar II™ 3020 and Autosorb™-1. All the samples were pre-treated at ˜120° C. in vacuum for ˜4 hours before collecting the N₂ isotherm. The analysis program calculated the experimental data and report BET surface area (total surface area), microporous surface area (S), total pore volume, pore volume for micropores, average pore diameter (or radius), etc.

### Example 1

### Characterization of the Precursors and the Network at the Rigidity Transition—Theory and Experimental Comparison

### Rigidity Theory

In Table 2, are shown the molecular parameters for the precursors/monomers, tetraethylorthosilicate (TEOS) ((EtO)₄Si), 1,1,3,3,5,5-hexaethoxy-1,3,5-trisilacyclohexane ([(EtO)₂SiCH₂]₃), 1,3,5-trimethyl-1,3,5-triethoxy-1,3,5-trisilacyclohexane ([CH₃EtO₂SiCH₂]₃), methyltriethoxysilane (MTES) ((EtO)₃SiCH₃), and 1,4-bis(triethoxysilyl)benzene ((EtO)₃SiC₆H₄Si(OEt₃) where each precursor molecule is considered as a collection of rigid tetrahedra. TEOS (precursor A) was considered in its hydrolyzed form, as a single tetrahedron with 4 vertexes, all of which are hydrolyzable terminal groups (the —OH). The [(EtO)₂SiCH₂]₃ (precursor B) was taken as 3 tetrahedral central groups joined via 3 non-hydrolyzable bridging groups (—CH₂—) and each tetrahedron also has 2 hydrolyzable terminal —OH groups. ([CH₃EtO₂SiCH₂]₃ (precursor C) was the same, except that each tetrahedron contains one hydrolyzable terminal group (—OH) and one non-hydrolyzable terminal group (—CH₃). MTES (Precursor Y), similar to TEOS, is considered as a single tetrahedron, but with 3 hydrolyzable (OEt) and 1 non-hydrolyzable (CH₃) terminal groups. Precursor Z was considered as 2 rigid tetrahedra bridged by one rigid, non-hydrolyzable bridging group—the phenyl or benzene group.

TABLE 2
Molecular parameters for the monomers and at the rigidity transition
when each is considered as a collection of tetrahedra.

| | Precursor/Monomer | M₀ | V | τ_{c0} | βₕ₀ | τ₀ | β₀ | x₁* | τ* | β* | τ_{c}* | βₕ* | T | W |
|---|---|---|---|---|---|---|---|---|---|---|---|---|---|---|
| A | TEOS | 1 | 4 | 4 | 0 | 4 | 0 | 2/5 | 1 | 3/2 | 1 | 3/2 | 1 | 1 |
| B | [(EtO)₂SiCH₂]₃ | 3 | 4 | 2 | 0 | 2 | 1 | 2/5 | 1 | 3/2 | 1 | 1/2 | 2/3 | 3 |
| C | [CH₃EtO₂SiCH₂]₃ | 3 | 4 | 1 | 0 | 2 | 1 | 2/5 | 1 | 3/2 | 0 | 1/2 | ∞ | 0 |
| Y | (EtO)₃SiCH₃ | 1 | 4 | 3 | 0 | 4 | 0 | 2/5 | 1 | 3/2 | 0 | 3/2 | ∞ | 0 |
| Z | (EtO)₃SiC₆H₄Si(OEt)₃ | 2 | 4 | 3 | 0 | 3 | 1/2 | 6/7 | 1 | 3/2 | 1 | 1 | 8/9 | 3/2 |

To demonstrate the consistency and flexibility of the theory, according to the hardness index definition (equation 14), the precursor B and precursor C are rigid species themselves (h=0 in each case); they do not have to be reduced to rigid tetrahedra in order to apply the theory.

In Table 3 below, they are treated as compound objects consisting of a collection of M=3 rigid subunits. In Table 3 are shown the molecular parameters and indexes when these precursors are considered as rigid, whole, objects (M=1) without internal bridges (their internal structure were still accounted for when defining the τ and β parameters as these were defined with respect to central groups in order to make the indexes consistent on a per-volume basis). Even though V and some of the other parameters change values, the actual state at the transition and the values of the T and W indexes were unchanged. Any consistent formulation of rigid sub-units can be used in order to apply the theory.

TABLE 3
Molecular parameters for precursors/monomers B and C at the rigidity
transition when each is considered as a single rigid object.

| | Precursor/Monomer | M₀ | V | τ_{c0} | βₕ₀ | τ₀ | β₀ | x₁* | τ* | β* | τ_{c}* | βₕ* | T | W |
|---|---|---|---|---|---|---|---|---|---|---|---|---|---|---|
| B | [(EtO)₂SiCH₂]₃ | 1 | 6 | 2 | 0 | 2 | 0 | 2/3 | 1 | 1/2 | 1 | 1/2 | 2/3 | 3 |
| C | [CH₃EtO₂SiCH₂]₃ | 1 | 6 | 1 | 0 | 2 | 0 | 2/3 | 1 | 1/2 | 0 | 1/2 | ∞ | 0 |

The value of the kinetic index for TEOS, T_{TEOS}=1, is as expected, by construction. For the precursor B, T=2/3. This is less than the value for TEOS and indicates that it reaches the rigidity transition more quickly than does TEOS. The reason is evident from equation II and the values of τ_{c0} and τ_{c}* in Table 2: τ_{c0} is lower (β₀ is higher) and so precursor B is already partially connected—it is already on its way to the rigid state. Precursor C requires infinite time (T=∞), since just reaching the rigid state is conditioned upon its initially hydrolyzable terminal groups all condensing.

That is, at any finite time it remains in the floppy state. The rigid state for all of these materials is essentially the same in terms of the terminal and bridging groups; note that x₁*, τ*, β*, are the same for each species. This makes sense since each is a bonded collection of rigid tetrahedra. The T-index is an indication of how long it takes each species to reach this state.

Considering the solvent index (W), W_{TEOS}=1. For precursor B, W=3; a larger number. This indicates that, at equilibrium during drying, precursor B contains much more solvent when sufficient condensation has occurred to reach rigidity. This can lead to higher porosity in the final material. For precursor B, W=0, indicating that, according to the theory, essentially no solvent remains when it reaches rigidity. This is consistent with the kinetic index in that there are few free hydroxyls available to react or to move the system towards rigidity.

### Experimental

The above results from the theory and the indices are in qualitative agreement with experimental results.

### A. Preparation of Organosilica Material from TEOS (Precursor A)

A solution with ˜6.21 g of ˜30% NH₄OH (˜53 mmol NH₄OH) and ˜7.92 g deionized (DI) water was formed. To the solution, ˜0.8 g (˜2 mmol) of [(EtO)₂SiCH₂]₃ and ˜0.63 g (˜3 mmol) of TEOS was added to produce a mixture having the approximate molar composition:

˜2.0 [(EtO)₂SiCH₂]₃:˜3.0 TEOS:˜53 OH:˜680 H₂O

which was stirred for ˜3 days at room temperature (˜20-25° C.). The mixture was then transferred to an autoclave and aged at ˜80° C-90° C. for ˜2 days to produce a gel. The gel was dried in a vacuum at ˜110° C. overnight (˜16-24 hours) and Organosilica Material A was obtained. No structure directing agent or porogen was used.

Nitrogen adsorption/desorption analysis was performed on Organosilica Material A and it was determined to have a BET surface area of ˜270 m²/g.

### B. Preparation of Organosilica Material from [(EtO)₂SiCH₂]₃ (Precursor B)

A solution with ˜18.6 g of ˜30% NH₄OH and ˜23.8 g deionized (DI) water was formed. The pH of the solution was ˜12.6. To the solution, ˜3.0 g of 1,1,3,3,5,5-hexaethoxy-1,3,5-trisilacyclohexane ([(EtO)₂SiCH₂]₃) was added, producing a mixture having the approximate molar composition:

˜1.0 [(EtO)₂SiCH₂]₃:˜21 OH:˜270 H₂O

and stirred for ˜1 day at room temperature (˜20-25° C.). The mixture was then transferred to an autoclave and aged at ˜90° C. for ˜1 day to produce a gel. The gel was dried at ˜120° C. in a vacuum for ˜24 hours. This produced Organosilica Material B as a clear solid, which was ground to form a white powder. No surface directing agent or porogen were used in this preparation.

Nitrogen adsorption/desorption analysis was performed on Organosilica Material B and it was determined to have a BET surface area of ˜1300 m²/g.

### C. Preparation of Organosilica Material from [CH₃EtOSiCH₂]₃ (Precursor C)

A solution with ˜6.21 g of ˜30% NH₄OH (˜53 mmol NH₄OH) and ˜7.92 g deionized (DI) water was formed. To the solution, ˜1.8 g of [(EtO)₂SiCH₂]₃ was added to produce a mixture having the approximate molar composition:

˜1.0 [(EtO)₂SiCH₂]₃:˜8.9 OH:˜114 H₂O

which was stirred for ˜1 day at room temperature (˜20-25° C.). The mixture was then transferred to an autoclave and aged at ˜90° C. for ˜1 day to produce a gel. The gel was dried in a vacuum at ˜120° C. for ˜24 hours. Organosilica Material C was obtained as a yellow solid and was ground into a powder. No structure directing agent or porogen was used.

Nitrogen adsorption/desorption analysis was performed on Organosilica Material C and it was determined to have a BET surface area of ˜36 m²/g.

### D. Preparation of Organosilica Material from (EtO)₃SiCH₃

A solution with ˜6.21 g of ˜30% NH₄OH (˜53 mmol NH₄OH) and ˜7.92 g deionized (DI) water was formed. To the solution, ˜1.6 g of methyltriethoxysilane [(EtO)₃SiCH₃] was added to produce a mixture having the approximate molar composition:

˜1.0 [(EtO)₃SiCH_{3b ]:˜}50 OH:˜650 H₂O

which was stirred for ˜1 day at room temperature (˜20-25° C.). The mixture was then transferred to an autoclave and aged at ˜90° C. for ˜1 day to produce a gel. The gel was dried in a vacuum at ˜120° C. for ˜24 hours. An organosilica solid was obtained as a white solid and was ground into a powder. No structure directing agent or porogen was used.

### E. Preparation of Organosilica Material from (EtO)₃SiC₆H₄Si(EtO)₃

A solution with ˜6.21 g of ˜30% NH₄OH (˜53 mmol NH₄OH) and ˜7.92 g deionized (DI) water was formed. To the solution, ˜1.6 g of 1,4-bis(triethoxylsilyl)-benzene [(EtO)₃SiC₆H₄Si(EtO)₃] was added, producing a mixture having the molar composition:

˜1.0 [(EtO)₃SiC₆H₄Si(EtO)₃]:˜100 OH:˜1300 H₂O

which was stirred for ˜1 day at room temperature (˜20-25° C.). The mixture was then transferred to an autoclave and aged at ˜90° C. for ˜1 day to produce a gel. The gel was dried in a vacuum at ˜120° C. for ˜24 hours. An organosilica solid was obtained as a white solid and was ground into a powder. No structure directing agent or porogen was used.

F. W, T, and Surface Area Analysis

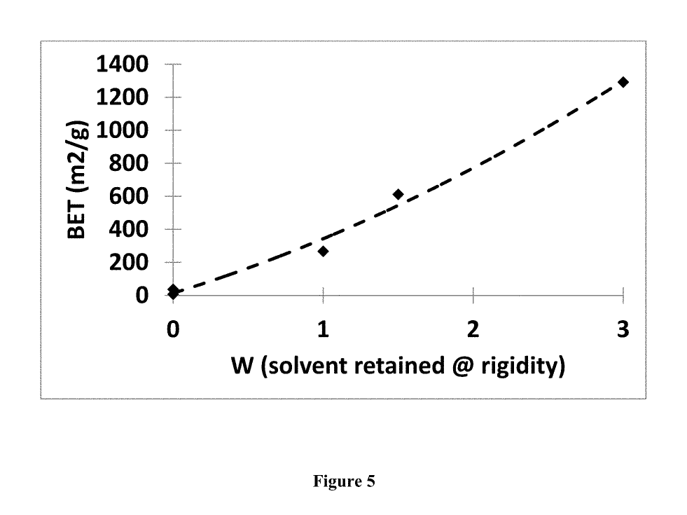

Surface of area of precursors A-C and Y-Z was plotted against W in FIG. 5. As shown in FIG. 5, the surface area appeared to increase as W increased. Without being bound by theory, plausible explanations for this trend suggested by the theory may include that (1) the more connected the precursor initially is, the faster it reaches rigidity, and/or (2) the greater the ratio of hydrolyzable terminal groups to hydrolyzable bridging groups, the greater the amount of solvent remaining in the system when it reaches rigidity during drying due to a rightward shift in the condensation reaction equilibrium.

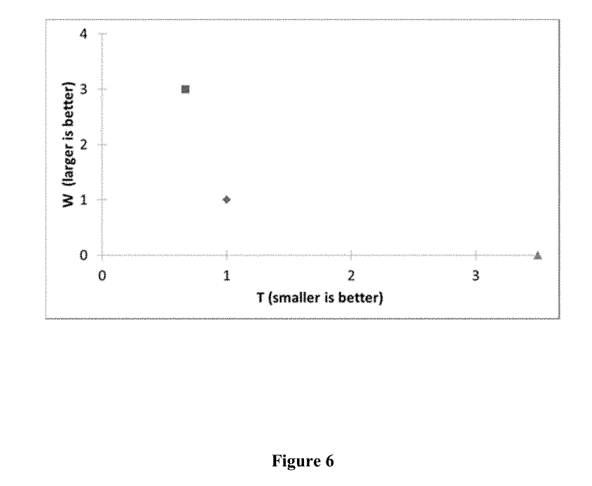

With regard to the kinetic index (T), if the kinetics are too slow, then equilibrium may not have have a chance to be established in the drying phase, and so T may be needed to separate useful from non-useful precursors when they have similar solvent indexes. FIG. 6 provides a plot of W v. T for precursors A-C. FIG. 6 provides a 2D space in which to plot any actual or candidate precursors for high porosity/surface area materials. In determining desirable precursors for forming high porosity and high surface area materials, an approximate space in the upper left region FIG. 6, near precursor B, could house the desirable species. This region can contain species that may condense quickly and may contain large amounts of solvent (porosity) when rigidity is reached. The region near (T=1, W=1) may contain materials like typical TEOS-derived silica, and the region in the lower right-hand region may contain slow-condensing, low-porosity materials.

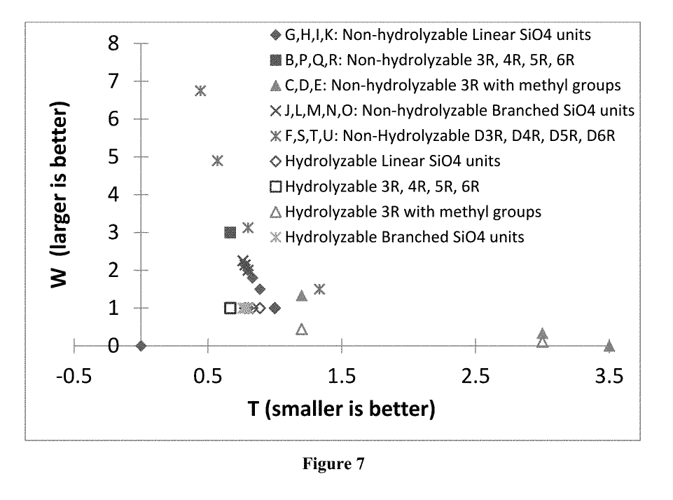

W and T were calculated according to the above equations (I) and (II) for the following additional precursors, assuming all bridging groups are non-hydrolyzable (e.g. —CH₂—), in Table 4. FIG. 7 provides a plot of W v. T for precursors A-U. Also shown in the figure are points corresponding to the D-U structures, except that all bridging groups were treated as being hydrolyzable (e.g. —O—).

TABLE 4

| | Precursor | T | W |
|---|---|---|---|
| D. | [CH₃(RO)SiCH₂]₂[(RO)₂SiCH₂] | 3.00 | 0.33 |
| E. | [CH₃(RO)SiCH₂][(RO)₂SiCH₂]₂ | 1.20 | 1.33 |
| F. | [1,3,5-alkoxysilacyclohexane]₂(μ-CH₂)₃, D3R | 1.33 | 1.50 |
| G. | (RO)₃SiCH₂Si(OR)₃, linear dimer | 0.89 | 1.50 |
| H. | (RO)₃SiCH₂Si[OR]₂CH₂Si(OR)₃, linear trimer | 0.83 | 1.80 |
| I. | (RO)₃SiCH₂Si[OR]₂CH₂Si[OR]₂CH₂Si(OR)₃, linear | 0.80 | 2.00 |
| | tetramer | | |
| J. | (RO)₃SiCH₂Si[OR][CH₂Si(OR)₃]CH₂Si(OR)₃ | 0.80 | 2.00 |
| K. | (RO)₃SiCH₂Si[OR]₂CH₂Si[OR]₂CH₂Si[OR]₂CH₂Si(OR)₃, | 0.78 | 2.14 |
| | linear pentamer | | |
| L. | (RO)₃SiCH₂Si[CH₂Si(OR)₃]₂CH₂Si(OR)₃ | 0.78 | 2.14 |
| M. | (RO)₃SiCH₂Si[OR]₂CH₂Si(OR)(CH₂Si(OR)₃)₂ | 0.78 | 2.14 |
| N. | (RO)₃SiCH₂Si[OR][CH₂Si(OR)₃]CH₂Si[OR][CH₂Si | 0.76 | 2.25 |
| | (OR)₃CH₂Si(OR)₃ | | |
| Q. | (RO)₃SiCH₂Si[CH₂Si(OR)₃]₂CH₂Si[OR]₂CH₂Si(OR)₃ | 0.76 | 2.25 |
| P. | [(RO)₂SiCH₂]₄, 4R | 0.67 | 3.00 |
| Q. | [(RO)₂SiCH₂]₅, 5R | 0.67 | 3.00 |
| R. | [(RO)₂SiCH₂]₆, 6R | 0.67 | 3.00 |
| S. | [1,3,5,7-alkoxysilacyclooctane]₂(μ-CH₂)₄, D4R | 0.80 | 3.13 |
| T. | [1,3,5,7,9-alkoxysilacyclodecane]₂(μ-CH₂)₅, D5R | 0.57 | 4.90 |
| U. | [1,3,5,7,9,11-alkoxysilacyclododecane]₂(μ-CH₂)₆, D6R | 0.44 | 6.75 |

The additional precursors include linear, branched, and cyclic monomers made of corner-sharing SiX₄ units as described herein. The linear species (analogous to normal alkanes, if TEOS is analogous to methane) bridged by CH₂ can form a line in this space that can begin at the point for TEOS and move toward the upper left. The non-hydrolyzable branched species (analogous to iso-alkanes) can lie on the same line (representatives are included for 4, 5, or 6 silicon atoms). It appears that larger precursors from these series would lie within the selected region.

The hydrolyzable versions of the linear and branched molecules all appear to lie along W=1 and are shown as open symbols. They are believed to have the same equilibrium properties as TEOS, since they are composed of the same units and can, in this case, freely undergo hydrolysis and condensation, e.g., to achieve the same equilibrium state. The comparison between the hydrolyzable and non-hydrolyzable versions is consistent with the notion that precursors with non-hydrolyzable bridging groups can be preferable (W is larger), because they maintain rigidity better under equilibrium conditions; they are believed to be more resistant to network-cutting hydrolysis when large amounts of solvent are present. This may be true no matter the geometry of the precursors, but some precursors could actually be partially non-hydrolyzable even when containing oxy bridges because of steric/other effects.

Also included are larger cyclic chains of SiX₄. All of the single-ring species, that contain non-hydrolyzable (—CH₂—) bridging groups, viz., 4R, 5R, 6R, appear to lie at the same point as precursor B (the filled red square). The theory at this level would indicate that they should have similar abilities to precursor B in forming mesoporous solids via the surfactant-free synthesis. The hydrolyzable versions of these molecules have W=1, for the same reasons as for the hydrolyzable linear and branched species.

Non-hydrolyzable precursors similar to precursor B but containing methyl groups in place of some hydroxyls (after initial hydrolysis) are shown as solid green triangles. They are predicted to have both slower kinetics and smaller equilibrium solvent ratios at the transition. They should make poorer mesoporous materials, though the species with one methyl group has a slightly higher W than does TEOS. Precursor C is shown at T=∞, W=0, as discussed previously, and precursor D is shown at at T=3. The hydrolyzable ring structures containing methyl groups (open triangles) seem to have the same T index as their non-hydrolyzable counterparts, but lower W indexes.

From the oligomeric species, size seems to play a role. The larger species (to the left of the linear groups of points) appear to have smaller T and larger W. This is believed to be because they have more hydrolyzable terminal groups, thereby leading to faster kinetics and a larger equilibrium number of bridging bonds; they are pre-built and seem to stay that way if some of the bridges are non-hydrolyzable.

The Figure also contains points for double-ring structures (like the double six-ring, in a zeolite such as Faujasite, i.e., precursor U). The larger such species are predicted to have very good properties (if non-hydrolyzable). They are predicted to have relatively fast kinetics, because they may contain many hydrolyzable terminal groups, and they seem to have high W, because it takes only 3 bridges to other units, on average, to form a rigid network, but they have many more than 3 —OH's available. In fact, they appear to be rigid themselves as monomers.

What is claimed is:

1. A method for preparing an organosilica material, the method comprising:
(a) adding at least one silicon-containing compound into an aqueous mixture that contains essentially no structure directing agent and/or porogen to form a solution, wherein the at least one silicon-containing compound has a solvent index (W) of greater than about 1.0 and the at least one silicon-containing compound is not 1,1,3,3,5,5-hexaethoxy-1,3,5-trisilacyclohexane, bis(triethoxysilyl)methane or 1,2-bis(triethoxysilyl)ethylene;
(b) aging the solution to produce a pre-product; and
(c) drying the pre-product to obtain an organosilica material which is a polymer comprising independent siloxane units.

2. The method of claim 1, wherein the at least one silicon-containing compound has a kinetic index (T) of greater than zero and less than about 1.0.

3. The method of claim 1, wherein the at least one silicon-containing compound has a solvent index (W) of between about 1.0 and about 20.

4. The method of claim 1, wherein the at least one silicon-containing compound comprises independent [SiX₄]ₙ units, wherein each X is independently selected from the group consisting of a hydrolyzable group bonded to a silicon atom of another SiX₄ unit, a non-hydrolyzable group bonded to a silicon atom of another SiX₄ unit, a non-hydrolyzable terminal group, and a hydrolyzable terminal group; with the proviso that at least one X is a hydrolyzable terminal group; and
n is 1 to 1000.

5. The method of claim 4, wherein the hydrolyzable group bonded to a silicon atom of another SiX₄ unit is selected from the group consisting of an oxygen atom, a halogen substituted alkylene, a nitrogen-containing alkylene group, —O—R¹—, and —R²—O—R³—, wherein R¹, R² and R³ are each independently an alkylene group or an arylene group.

6. The method of claim 4, wherein the non-hydrolyzable group bonded to a silicon atom of another SiX₄ unit is selected from the group consisting of an alkylene group, an alkenylene group, an alkynylene group, and an arylene group.

7. The method of claim 4, wherein the non-hydrolyzable terminal group is selected from the group consisting of an alkyl group, an alkenyl group, an alkynyl group, and an aryl group.

8. The method of claim 4, wherein the hydrolyzable terminal group is selected from the group consisting an alkoxy group, an acyloxy group, an arylalkoxy group, a hydroxyl group, a haloalkyl group, a halide, an amino group, and an aminoalkyl group.

9. The method of claim 1, wherein the aqueous mixture comprises a base and has a pH from about 8 to about 14.

10. The method of claim 9, wherein the base is ammonium hydroxide, a metal hydroxide or a basic salt.

11. The method of claim 1, wherein the aqueous mixture comprises an acid and has a pH from about 0.01 to about 6.0.

12. The method of claim 11, wherein the acid is an inorganic acid or an acid salt, wherein the inorganic acid is hydrochloric acid.

13. The method of claim 1, wherein the solution is aged in step (c) for up to about 1000 hours at a temperature of about 0° C. to about 200° C.

14. The method of claim 1, wherein the pre-product is dried at a temperature of about −20° C. to about 200° C.

15. The method of claim 1, wherein the organosilica material has a total surface area of about 200 m²/g to about 7000 m²/g.

16. The method of claim 1, wherein the at least one silicon-containing compound is not a compound selected from the group consisting of 1,3,5-trimethyl-1,3,5-triethoxy-1,3,5-trisilacyclohexane, methyltriethoxysilane, (3-aminopropyl)triethoxysilane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, N,N′-bis[(3-trimethoxysilyl)propyl]ethylenediamine, bis[(methyldiethoxysilyl)propyl]amine, bis[(methyldimethoxysilyl)propyl]-N-methylamine, and tris(3-trimethoxysilylpropyl)isocyanurate.

17. The method of claim 1, further comprising incorporating at least one catalytic metal within the pores of the organosilica material, wherein the catalytic metal is selected from the group consisting of a Group 6 element, a Group 8 element, a Group 9 element, a Group 10 element and a combination thereof.

18. An organosilica material made according to the method of claim 1.

19. A catalyst material comprising the organosilica material of claim 18 and optionally, a binder.

20. An adsorbent material comprising the organosilica material of claim 18 and optionally, a Group 8 metal ion.

21. A method for preparing an organosilica material, the method comprising:
(a) using the following solvent index (W) equation (I):
W=3/2(τ*_{c}²/β*ₕ) (I)
wherein
τ*_{c} represents the number of hydrolyzable terminal groups remaining per silicon atom at a rigidity transition; and
β*ₕ represents the number of hydrolyzable bridging groups per silicon atom at the rigidity transition; and
the following kinetic index (T) equation (II):
$$T = \frac{4}{3} ( \frac{1}{{τ}_{c}^{*}} - \frac{1}{{τ}_{c 0}} ) \qquad ( II )$$
wherein
τ_{c0} represents the initial number of hydrolyzable terminal groups per silicon atom;
to determine at least one silicon-containing compound that satisfies the condition that W is greater than 1.0 and T is greater than zero and less than 1.0, wherein the at least one silicon-containing compound is not 1,1,3,3,5,5-hexaethoxy-1,3,5-trisilacyclohexane, bis(triethoxysilyl)methane or 1,2-bis(triethoxysilyl)ethylene;
(b) adding the at least one silicon containing compound to an aqueous mixture that contains essentially no structure directing agent and/or porogen, to form a solution;
(c) aging the solution to produce a pre-product; and
(d) drying the pre-product to obtain an organosilica material which is a polymer comprising independent siloxane units.

22. A method for identifying precursors for producing an organosilica material, the method comprising:
(a) using the following solvent index (W) equation (I):
W=3/2(τ*_{c}²/β*ₕ) (I)
wherein
τ*_{c} represents the number of hydrolyzable terminal groups remaining per silicon atom at a rigidity transition; and
β*ₕ represents the number of hydrolyzable bridging groups per silicon atom at the rigidity transition; and
the following kinetic index (T) equation (II):
$$T = \frac{4}{3} ( \frac{1}{{τ}_{c}^{*}} - \frac{1}{{τ}_{c 0}} ) \qquad ( II )$$
wherein
τ_{c0} represents the initial number of hydrolyzable terminal groups per silicon atom;
to determine a result where at least one silicon-containing compound satisfies the condition that W is greater than 1.0 and T is greater than zero and less than 1.0, wherein the at least one silicon-containing compound is not 1,1,3,3,5,5-hexaethoxy-1,3,5-trisilacyclohexane, bis(triethoxysilyl)methane or 1,2-bis(triethoxysilyl)ethylene; and
(b) transmitting the result to another party.

23. A sol-gel system comprising:
an aqueous solution comprising at least one silicon-containing compound having a solvent index (W) of greater than about 1.0, wherein the aqueous solution contains essentially no structure directing agent and/or porogen and the at least one silicon-containing compound is not 1,1,3,3,5,5-hexaethoxy-1,3,5-trisilacyclohexane, bis(triethoxysilyl)methane or 1,2-bis(triethoxysilyl)ethylene.

24. A silicon-containing compound having a solvent index (W) of greater than about 1.0 and a kinetic index (T) of greater than zero and less than about 1.0, wherein the at least one silicon-containing compound is not a compound selected from the group consisting of 1,1,3,3,5,5-hexaethoxy-1,3,5-trisilacyclohexane, 1,3,5-trimethyl-1,3,5-triethoxy-1,3,5-trisilacyclohexane, methyltriethoxysilane, (3-aminopropyl)triethoxy silane, (N,N-dimethylaminopropyl)trimethoxysilane, (N-(2-aminoethyl)-3-aminopropyltriethoxysilane ((H₂N(CH₂)₂NH (CH₂)₃)(EtO)₂Si), 4-methyl-1-(3-triethoxysilylpropyl)-piperazine, 4-(2-(triethoxysilyl)ethyl)pyridine, 1-(3-(triethoxysilyl)propyl)-4,5-dihydro-1H-imidazole, 1,2-bis(methyldiethoxysilyl)ethane, bis(triethoxysilyl)methane, 1,2-bis(triethoxysilyl)ethylene, N,N′-bis[(3-trimethoxysilyl)propyl]ethylenediamine, bis[(methyldiethoxysilyl)propyl]amine, bis[(methyldimethoxysilyl)propyl]-N-methylamine, and tris(3-trimethoxysilylpropyl)isocyanurate.
